(19) United States
(12) Patent Application Publication
(10) Pub. No.: US 2026/0362271 A1
(43) Pub. Date: Nov. 12, 2026

(54) MANAGING LOWER LAYER TRIGGERRED MOBILITY CONFIGURATIONS

(71) Applicant: GOOGLE LLC, Mountain View, CA (US)

(72) Inventor: Chih-Hsiang Wu, Taoyuan City (TW)

(21) Appl. No.: 19/157,330

(22) PCT Filed: Feb. 16, 2024
(86) PCT No.: PCT/US24/16317

§ 371 Date: Aug. 15, 2025

Related U.S. Application Data
(60) Provisional application No. 63/485,526, filed on Feb. 16, 2023.

(51) Int. Cl. H04W 36/08; H04W 36/00; H04W 88/08

(52) U.S. Cl. CPC H04W 36/087; H04W 36/0058; H04W 36/0064; H04W 88/085

(57) ABSTRACT

A central unit (CU) of a distributed base station transmits, to a distributed unit (DU) of the distributed base station, a CU-to-DU message related to a lower layer triggered mobility (LTM) of a user equipment (UE) connected to the distributed base station, the CU-to-DU message including a plurality of cell identifiers (IDs) of respective candidate cells (904A); receiving, from the DU in response to the CU-to-DU message, a DU-to-CU message including a plurality of LTM DU configurations for the respective candidate cells (block 906); and transmitting, to the UE, an addition and/or modification list of the LTM DU configurations (908, 910).

### CROSS-REFERENCE TO RELATED APPLICATION

This application claims priority to and the benefit of the filing date of provisional U.S. Patent Application No. 63/485,526, titled “Managing Lower Layer Triggered Mobility Configurations,” filed on Feb. 16, 2023. The entire contents of the provisional application are hereby expressly incorporated herein by reference.

### FIELD OF THE DISCLOSURE

This disclosure relates to wireless communications and, more particularly, to managing a lower layer triggered mobility, i.e., a fast serving cell change, for a user equipment (UE).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE in some scenarios can concurrently utilize resources of multiple radio access network (RAN) nodes (e.g., base stations or components of a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure.

When the UE moves from coverage area of one cell to another cell in a RAN, the UE and the network must at some point perform a serving cell change. To perform the serving cell change, the RAN configures the UE to transmit Layer 3 (L3) measurement results. Based on the L3 measurement results received from the UE, the RAN transmits a RRC reconfiguration message for reconfiguration with synchronization (e.g., the RRC reconfiguration message includes a ReconfigurationWithSync IE) for change of the serving cell (e.g., PCell or PSCell). When the UE operates in carrier aggregation (CA) of at least one secondary cell (SCell) with the PCell or PSCell, the RAN has to release the at least one SCell due to the change of the PCell or PSCell. The serving cell change involves complete L2 (and L1) resets, leading to longer latency, larger overhead and longer interruption time.

To address some of these concerns, 3GPP recently proposed to develop mobility procedures to reduce latency and overhead for fast serving cell change, described in the technical document RP-221799. These procedures provide fast serving cell changes and can be referred to as lower layer triggered mobility (LTM). However, it is not clear how devices should manage a serving cell change using a lower layer signaling, i.e., lower layer mobility (LTM) functionality a base station of the RAN.

### SUMMARY

An example embodiment of these techniques is a method implemented in a central unit (CU) of a distributed base station. The method comprises transmitting, to a distributed unit (DU) of the distributed base station, a CU-to-DU message related to a lower layer triggered mobility (LTM) of a user equipment (UE) connected to the distributed base station, the CU-to-DU message including a plurality of cell identifiers (IDs) of respective candidate cells; receiving, from the DU in response to the CU-to-DU message, a DU-to-CU message including a plurality of LTM DU configurations for the respective candidate cells; and transmitting, to the UE, an addition and/or modification list of the LTM DU configurations.

Another example embodiment of these techniques is a radio access network (RAN) node comprising processing hardware and configured to implement the method above.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station including a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example scenario in which a UE performs an LTM switch from a serving cell of a DU to a candidate cell of the same DU;

FIG. 4 is a messaging diagram of an example scenario in which a UE performs an LTM switch from a serving cell of a source DU to a candidate cell of a target DU;

FIGS. 5A-B are messaging diagrams of example scenarios in which a UE operates in dual connectivity with an MN and an SN, and performs an LTM switch from a serving cell of a DU of the SN to a candidate cell of the same DU of the SN;

FIGS. 6A-B are messaging diagrams of example scenarios in which a UE operates in dual connectivity with an MN and an SN, and performs an LTM switch from a serving cell of a source DU of the SN to a candidate cell of the target DU of the SN;

FIG. 7A-B are messaging diagrams of scenarios similar to those of FIGS. 5A-B, but where the MN and the SN are implemented in different DUs of the same distributed base station;

FIG. 8A-B are messaging diagrams of scenarios similar to those of FIGS. 6A-B, but where the MN and the SN are implemented in different DUs of the same distributed base station;

FIGS. 9A-10B are flow diagrams of example methods in a CU for managing LTM configurations in a UE;

FIGS. 11A-12B are flow diagrams of example methods in a DU for managing LTM configurations in a UE;

FIGS. 13A-B are flow diagram of an example method in a CU for managing LTM configurations in a UE in view of whether there are remaining candidate cells for LTM after a release of one or more candidate LTM cells;

FIG. 14A is a flow diagram of an example method in a RAN node for determining whether to retain or release a reference LTM configuration in view of the previously released LTM configurations; and

FIG. 14B is a flow diagram of an example method in a RAN node for determining whether to retain or release a reference LTM configuration in view of whether a message to the UE includes a release indication.

### DETAILED DESCRIPTION OF THE DRAWINGS

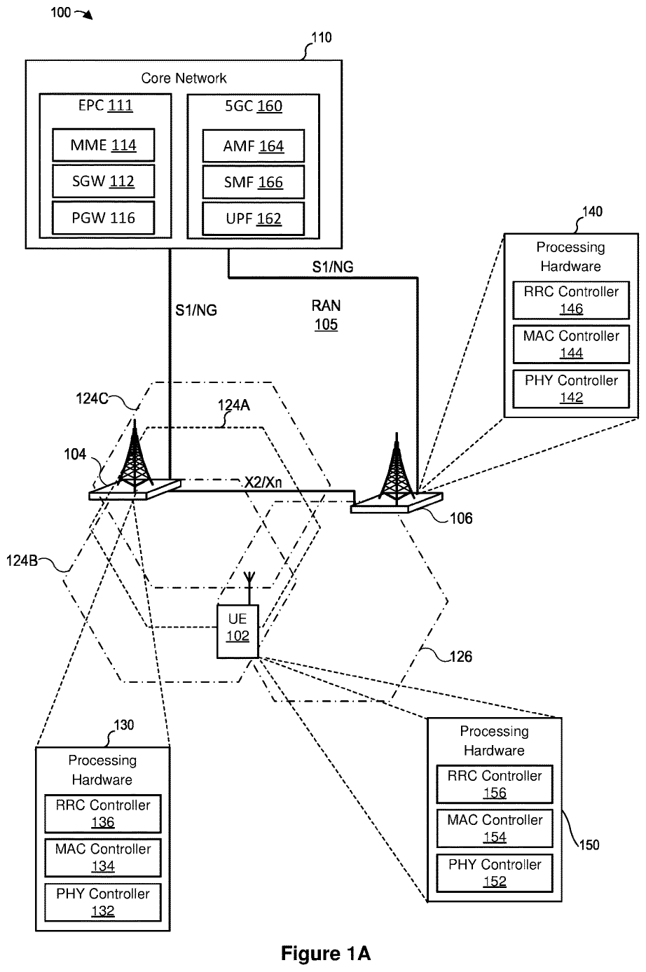

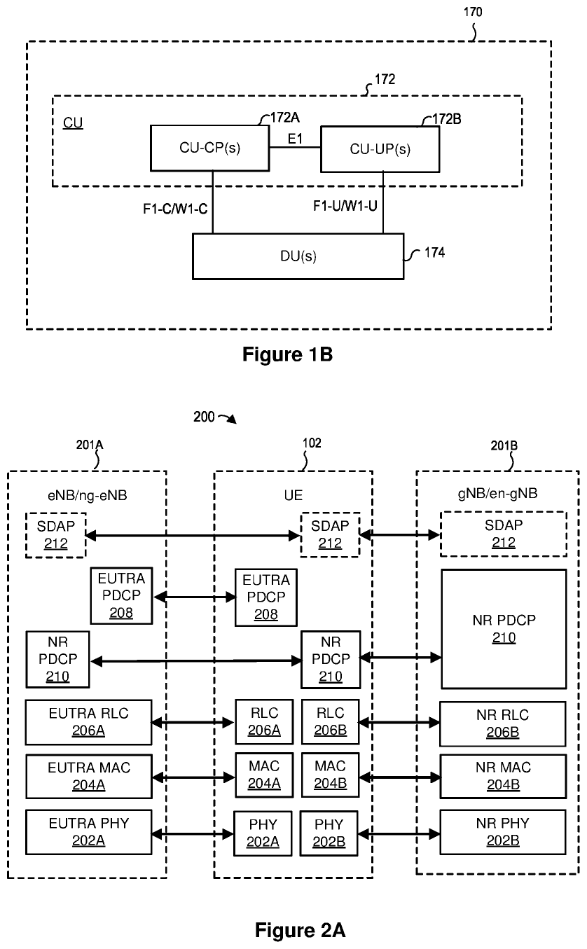

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an SI interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can partially overlap, so that the UE 102 can communicate in DC with the base station 104 and the base station 106, where one of the base stations 104 and 106 is an MN and the other is an SN. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104. The base station 104 can operate the cells 124A, 124B and 124C via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g. UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

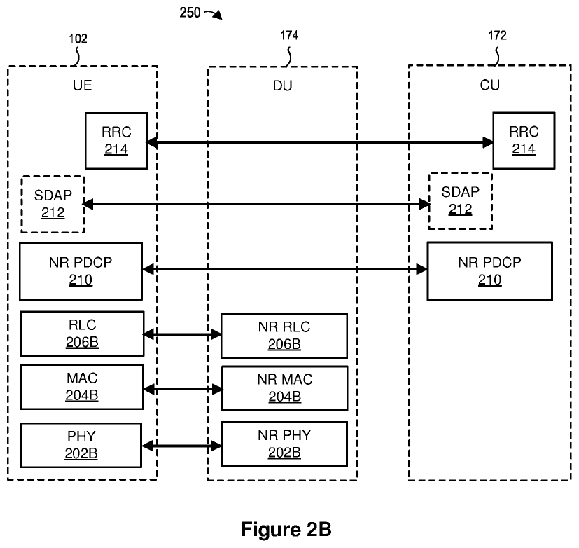

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

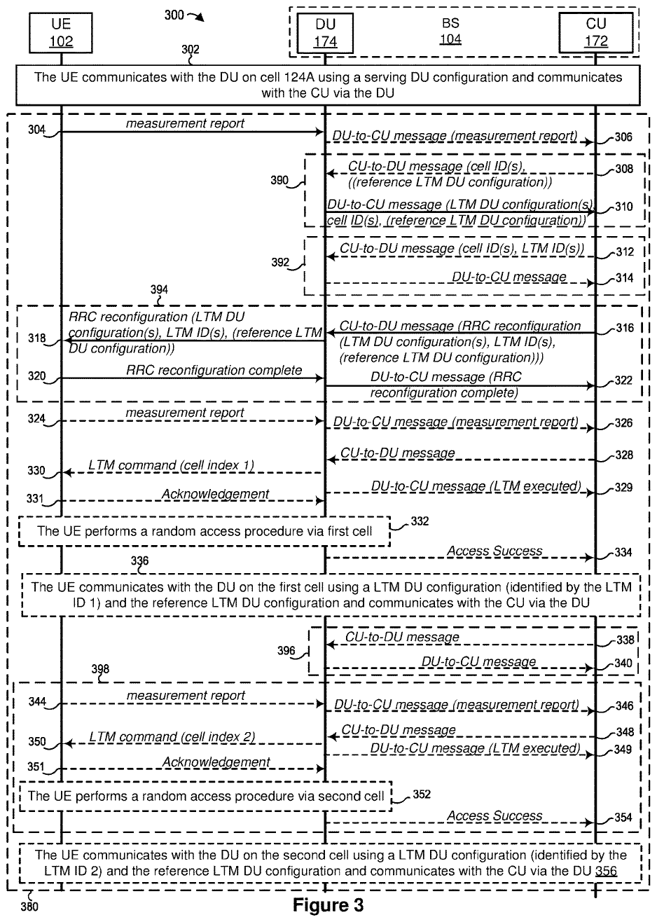

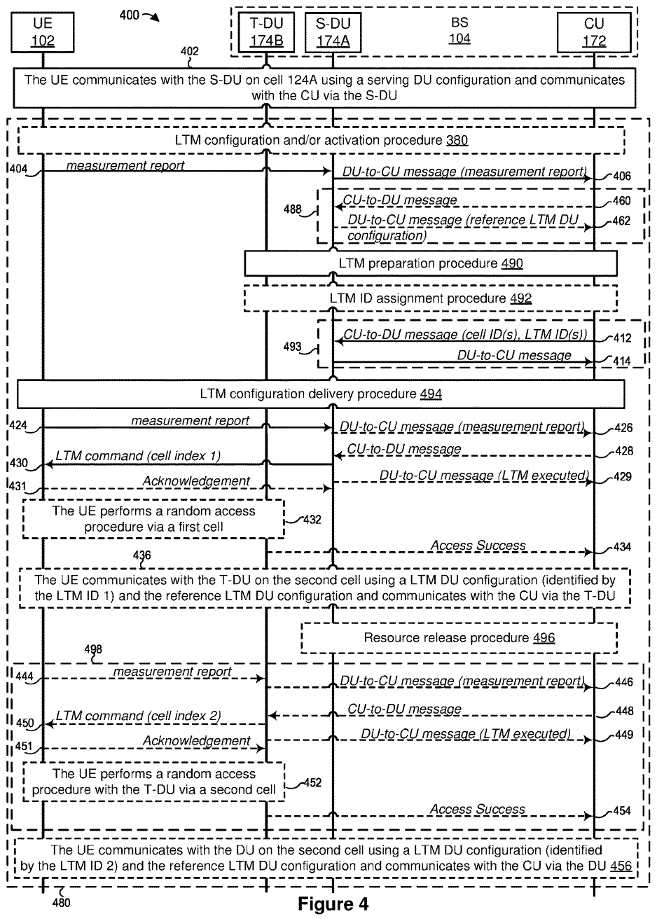

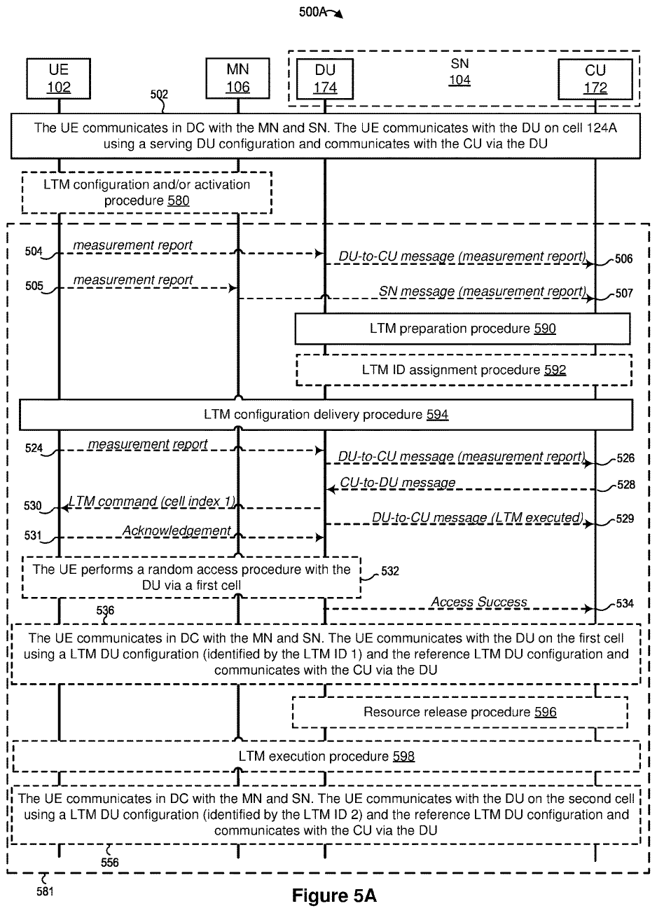

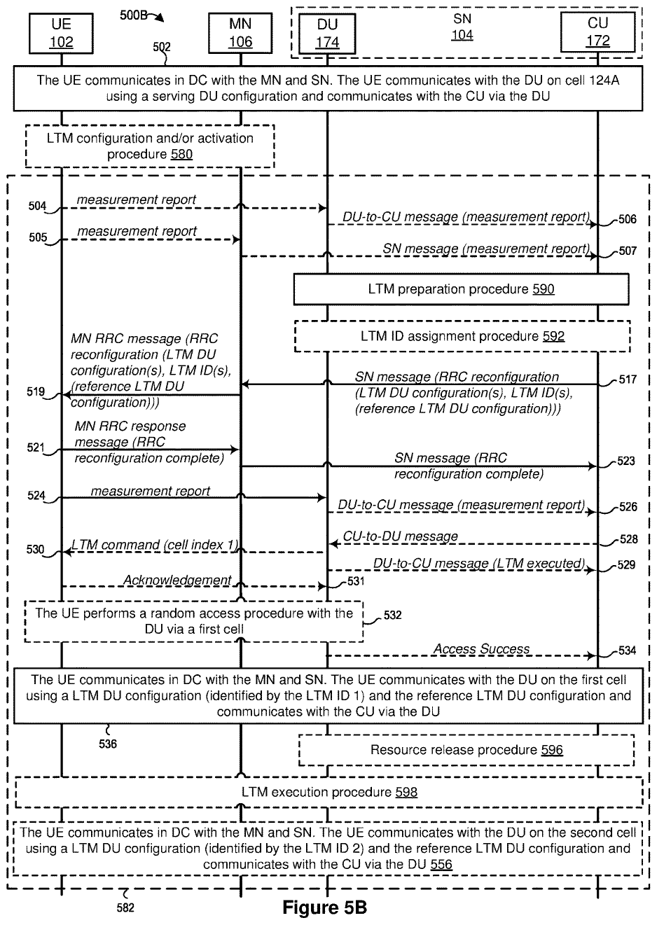

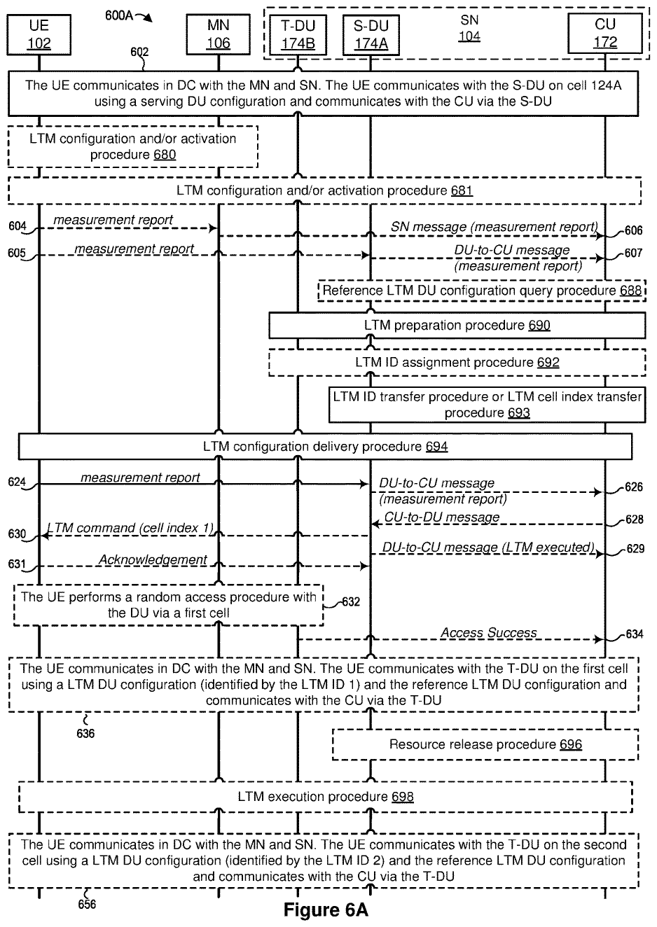

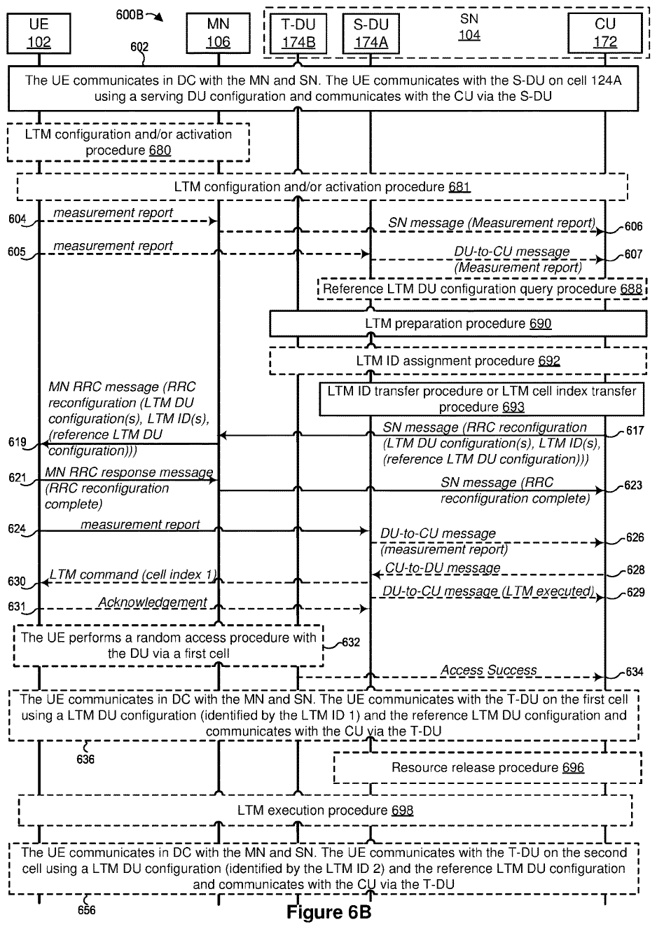

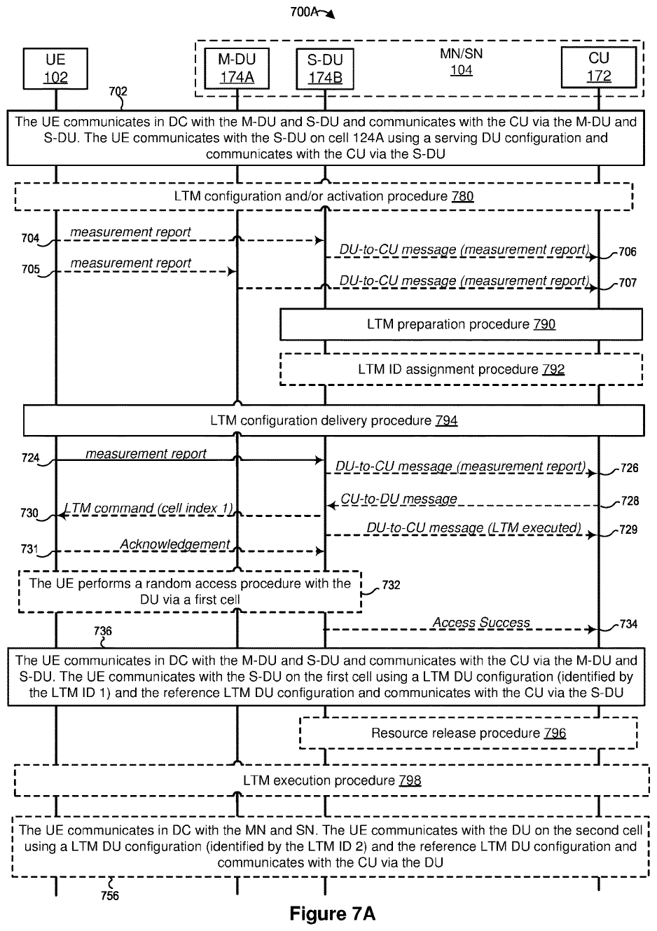

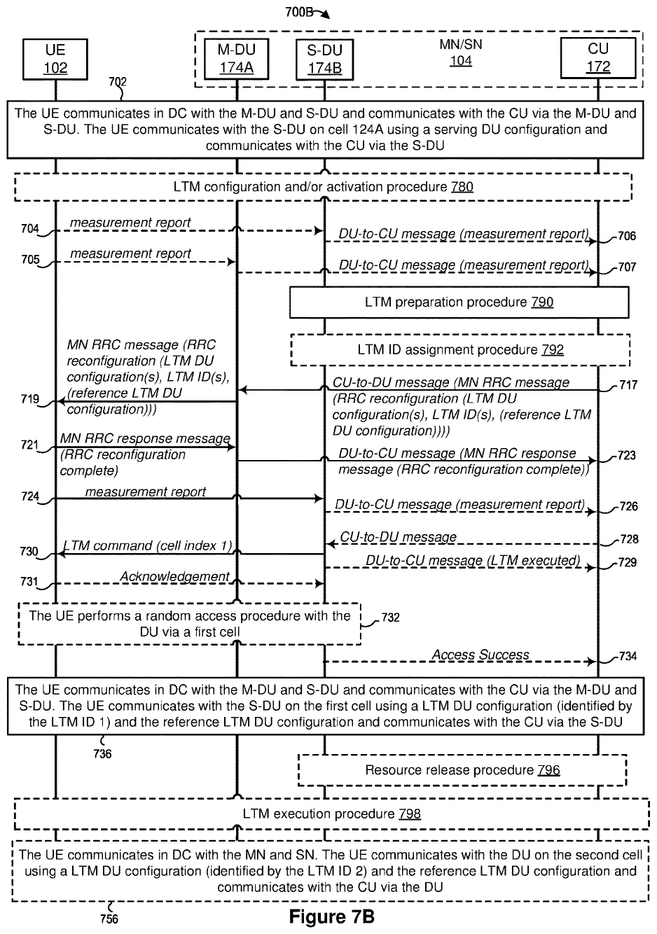

Next, several example scenarios in which the base station operating in the system of FIG. 1A transmits a configuration to the UE 102 and later activates a configuration for communication between the UE 102 and base station. Generally speaking, events in FIGS. 3-7B that are similar are labeled with similar reference numbers (e.g., event 316 is similar to event 416 of FIGS. 4A and 4B, event 516 of FIG. 5A, event 517 of FIG. 5B, event 616 of FIG. 6A, event 617 of FIG. 6B, event 716 of FIG. 7A, and event 717 of FIG. 7B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU 172 and a DU 174 and the DU 174 operates the cell 124A. The UE 102 initially communicates 302 with the DU 174 on the cell 124A using a serving DU configuration, and communicates with the CU 172 via the DU 174, e.g., using a serving CU configuration. In some implementations, the UE 102 in carrier aggregation (CA) communicates with the DU 174 on the cell 124A and other cell(s) (e.g., cell 124D not shown in FIG. 1A) using the serving DU configuration. The DU 174 operates the other cell(s). In other implementations, the UE 102 in communicates with the DU 174 on the cell 124A only. In some implementations, the UE 102 communicates with the DU 174 on the cell 124A and/or other cell(s) via one or multiple TRPs. In some implementations, the cell 124A can be a PCell. In such cases, the other cell(s) include SCell(s) and/or additional cell(s) associated with the PCell or a SCell. In other implementations, the cell 124A can be a SCell, and one of the other cell(s) is a PCell. In such cases, the rest includes SCell(s) and/or additional cell(s) associated with the PCell or a SCell. In the following description, the base station 104 can be the DU 174, the CU 172 or the DU 174 and CU 172.

In the event 302, the UE 102 can transmit UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which can include SRBs and/or DRB(s). The base station 104 can configure the radio bearers to the UE 102. In some implementations, UL control signals include UL control information, channel state information, hybrid automatic repeat request (HARQ) acknowledgements (ACKs), HARQ negative ACKs, scheduling request(s) and/or sounding reference signal(s). Similarly, the UE 102 can receive DL PDUs and/or DL control signals from the base station 104 on the cell 124A and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). The base station 104 can transmit the DCIs on physical downlink control channel(s) (PDCCH(s)) monitored by the UE 102, on the cell 124A and/or other cell(s) via one or multiple TRPs.

In some implementations, the serving DU configuration includes physical layer configuration parameters, MAC configuration parameters, and/or RLC configuration parameters. In some implementations, the DU 174 can transmit these configuration parameters to the CU 172. The CU 172 generates one or more messages (e.g., RRC reconfiguration message(s)) including the configuration parameters and transmits the one or more messages to the UE 102 via the DU 174. In other implementations, the DU 174 transmits the configuration parameters to the UE 102 directly. In some implementations, the serving DU configuration is CellGroupConfig IE defined in 3GPP specification 38.331. In other implementations, the serving DU configuration includes configuration parameters in the CellGroupConfig IE. In some implementations, the serving CU configuration includes PDCP configuration parameters, measurement configuration parameters, and/or radio bearer configuration parameters. In some implementations, the serving CU configuration includes a MeasConfig IE and/or a RadioBearerConfig IE defined in 3GPP specification 38.331 or includes configuration parameters in the MeasConfig IE and/or RadioBearerConfig IE. In some implementations, the serving DU configuration includes a CSI-MeasConfig IE or configuration parameters for channel state information (CSI) measurement and reporting. In other implementations, the serving CU configuration includes a CSI-MeasConfig IE or configuration parameters for channel state information (CSI) measurement and reporting. In some implementations, the UE 102 receives the serving CU configuration or the configuration parameters in the serving CU configuration from the CU 172 via the DU 174. In other implementations, the UE 102 receives a portion of the serving CU configuration and/or a portion of the serving DU configuration from a base station other than the base station 104 and the remaining portion of these configuration parameters from the base station 104.

While communicating with the base station 104, the UE 102 transmits 304 at least one measurement report to the DU 174. In some implementations, the at least one measurement report includes Layer 1 (L1) measurement report(s) and/or Layer 3 (L3) measurement report(s) for at least one serving cell of the UE 102 and/or at least one non-serving cell. For each of the L3 measurement report(s), the DU 174 transmits 306 a DU-to-CU message including the L3 measurement report to the CU 172. In some implementations, the DU-to-CU message(s) of the event 306 is/are F1 application protocol (F1AP) message(s) (e.g., UL RRC Message Transfer message(s)). In some implementations, the DU 174 does not transmit or refrains from transmitting the L1 measurement report(s) to the CU 172. The at least one serving cell includes the cell 124A and/or other cell(s), and the at least one non-serving cell includes the cell 124B and/or cell 124C. In some implementations, the serving DU configuration or the serving CU configuration includes at least one measurement configuration. In some implementations, the UE 102 receives one or more RRC messages (e.g., RRCReconfiguration message(s)) including the at least one measurement configuration from the CU 172 via the DU 174 in the event 302. In accordance with the at least one measurement configuration, the UE 102 performs measurements and transmits 304 the at least one measurement report to the DU 174. In some implementations, the at least one measurement configuration includes L3 measurement configuration(s) (e.g., MeasConfig IE(s)) and/or L1 measurement configuration(s). The L1 measurement configuration(s) (e.g., CSI-MeasConfig IE(s)) can include L1 measurement resource configuration(s) and/or L1 measurement reporting configuration(s). The L1 measurement resource configuration(s) can configure resources of reference signal(s) (e.g., CSI-RS(s)) for the UE 102 to measure and obtain L1 measurement results. For example, the L1 measurement resource configuration(s) is/are CSI-ResourceConfig IE(s). In another example, the L1 measurement reporting configuration(s) configures way(s) the UE 102 uses to transmit L1 measurement results/reports. For example, the L1 measurement report configuration(s) is/are CSI-ReportConfig IE(s). For example, The UE 102 transmits the L3 measurement report(s) to the CU 172 via the DU 174 in accordance with the L3 measurement configuration(s). The UE 102 transmits the L1 measurement report(s) to the DU 174 in accordance with the L1 measurement configuration(s) or L1 measurement reporting configuration(s). In one implementations, the DU 174 does not transmit the L1 measurement report(s) to the CU 172.

In some implementations, the L1 measurement configuration(s) are RRC IE(s) specifically defined for, and dedicated to LTM (e.g., in a relevant 3GPP specification such as TS 38.331), for a lower layer triggered mobility (LTM). In some implementations, the L1measurement resource configuration(s) are RRC IE(s) specifically defined for, and dedicated to LTM (e.g., in a relevant 3GPP specification such as TS 38.331). In some implementations, the L1 measurement reporting configuration(s) are new RRC IE(s) defined in 3GPP specification 38.331 v 18.0.0 and/or later version for the LTM. In some implementations, each of the L1 measurement reporting configuration(s) can include a trigger event configuration configuring a trigger event to trigger the UE 102 to transmit a L1 measurement report. If the UE 102 detects the trigger event, the UE 102 transmits a L1 measurement report to the DU 174.

In some implementations, (each of) the L1 measurement report(s) can include at least one L1 measurement result. In some implementations, the at least L1 measurement result includes at least one L1-reference signal received power (L1-RSRP) value and/or at least one L1-Signal to Interference Noise Ratio (L1-SINR) value. For each of the L1 measurement report(s), the UE 102 transmits a PUCCH transmission including the L1 measurement report to the DU 174, in some implementations. That is, the UE 102 transmits the each of the L1 measurement report(s) on a PUCCH to the DU 174. In other implementations, for each of the L1 measurement report(s), the UE 102 transmits a PUSCH transmission including the L1 measurement report to the DU 174. That is, the UE 102 transmits the each of the L1 measurement report(s) on a PUSCH to the DU 174. In yet other implementations, the UE 102 transmits a portion of the L1 measurement report(s) on PUCCH(s) and the rest of the L1 measurement report(s) on physical UL shared channel(s) (PUSCH(s)) to the DU 174. That is, for each of the portion of the L1 measurement report(s), the UE 102 transmits a PUCCH transmission including the L1 measurement report to the DU 174, and for each of the rest of the L1 measurement report(s), the UE 102 transmits a PUSCH transmission including the L1 measurement report to the DU 174. In some implementations, each of the L1 measurement report(s) is a part of channel state information (CSI) (i.e., a CSI component) or CSI. In some implementations, the UE 102 can include other CSI component(s) in (each of) the PUCCH transmission(s) and/or PUSCH transmission(s) described above. In one implementation, the other CSI component(s) include such as a channel quality indicator (CQI), a Precoding Matrix Indicator (PMI), a CSI-RS Resource Indicator (CRI), a Synchronization Signal (SS)/ Physical Broadcast Channel (PBCH) Resource Block Indicator (SSBRI), a Layer Indicator (LI), and/or a Rank Indicator (RI). In some implementations, the UE 102 does not transmit the L1 measurement report(s) in format of RRC message(s) to the DU 174.

In some implementations, each of the L3 measurement report(s) can include at least one L3 measurement result. In some implementations, the at least one L3 measurement result includes at least one RSRP (value) and/or at least one SINR (value). In one implementation, the UE 102 transmits each of the L3 measurement report(s) on a PUSCH to the CU 172 via the DU 174. In some implementations, each of the L3 measurement report(s) can be a RRC message (e.g., MeasurementReport message). In some implementations, each of the L3 measurement configuration(s) includes a particular measurement identity (e.g., measId) and each of the L3 measurement report(s) includes a particular measurement identity in a particular L3 measurement configuration. When the CU 172 receives a L3 measurement report including a measurement identity and a L3 measurement result from the UE 102 via the DU 174, the CU 172 can determine that the L3 measurement report is associated to a L3 measurement configuration identified by the measurement identity.

In some alternative implementations, for each of the at least one measurement report (e.g., L1 measurement report(s)), the UE 102 transmits a MAC control element (CE) including the measurement report to the DU 174 in the event 304. To transmit the MAC CE(s), the UE 102 generate one or more MAC PDUs each including one or more of the MAC CE(s) to the DU 174 in the event 304.

In some implementations, the UE 102 performs measurements on one or more reference signals in accordance with the at least one measurement configuration. The one or more reference signals can include one or more Synchronization Signal (SS)/ Physical Broadcast Channel (PBCH) Resource Blocks (SSBs) and/or one or more CSI-RSs. The UE 102 obtains the at least one L1 measurement result and/or at least one L3 measurement result from the measurements. The DU 174 transmits the one or more reference signals on the cell 124A and other cell(s) (e.g., the cell 124B, the cell 124C and/or cell(s) not shown in FIG. 1A).

After (e.g., in response to) receiving one or some of the at least one measurement report from the UE 102, the base station 104 (i.e., the CU 172 or DU 174) determines to prepare a first cell (e.g., the cell 124B) for LTM for the UE 102. In some implementations, the base station 104 determines to prepare the first cell for the UE 102 because the at least one measurement report indicates that the first cell could be used by the base station 104 to communicate with the UE 102. In some implementations, the base station 104 determines to prepare the first cell for the UE 102 because the at least one measurement report indicates that the first cell qualifies to be a candidate cell that could be used for communication with the UE 102. In some implementations, if the L3 measurement report(s) indicates that signal strength and/or quality of the first cell is above a first predetermined threshold, is better than strength and/or quality of the cell 124A, and/or is better than strength and/or quality of the cell 124A by a first predetermined threshold, the CU 172 determines to prepare the first cell for the UE 102. In other implementations, if the L1 measurement report(s) indicates that signal strength and/or quality of the first cell is above a first predetermined threshold, is better than signal strength and/or quality of the cell 124A, and/or is better than signal strength and/or quality of the cell 124A by a first predetermined threshold, the DU 174 determines to prepare the first cell for the UE 102. Alternatively, the base station 104 determines to prepare the first cell for the UE 102 regardless of whether a measure report is received from the UE 102 or not.

In the case that the CU 172 determines to prepare the first cell for LTM, the CU 172 transmits 308 a first CU-to-DU message to the DU 174 to prepare the first cell for the UE 102. In some implementations, the CU 172 includes a cell identity (ID) of the first cell in the first CU-to-DU message to request the DU 174 to prepare the first cell for LTM for the UE 102. For example, the cell ID is cell global identity (CGI). In another example, the cell ID is a portion of the CGI. In yet another example, the cell ID is a physical cell ID (PCI). In response to the first CU-to-DU message, the DU 174 generates a first LTM DU configuration (referred to herein after as LTM DU configuration 1) for the UE 102, which configures the first cell for LTM. The DU 174 then transmits 310 a first DU-to-CU message including the LTM DU configuration 1 to the CU 172 in response to the first CU-to-DU message. In some implementations, the DU 174 can include the cell ID 1 together with the LTM DU configuration 1 in an IE of the first DU-to-CU message to indicate that the LTM DU configuration 1 is associated with the first cell (i.e., the cell ID 1). In the case that the DU 174 determines to prepare the first cell, the DU 174 initiates transmission of the first DU-to-CU message to the CU 172 instead of in response to a CU-to-DU message received from the CU 172.

In some implementations, the DU 174 includes, in the first DU-to-CU message, the cell ID of the first cell associated with the LTM DU configuration 1 to indicate that the LTM DU configuration 1 is configured for or associated with the first cell. The CU 172 identifies the LTM DU configuration 1 is configured for or associated with the first cell. In some scenarios and implementations, the CU 172 can include additional cell ID(s) (e.g., cell ID(s) 2, . . . , N) in the first CU-to-DU message to prepare additional cell(s) (e.g., cell(s) 2, . . . , N) for LTM for the UE 102, and the DU 174 includes additional LTM DU configuration(s) (e.g., LTM DU configuration(s) 2, . . . , N) each configuring a particular cell of the additional cell(s), as described below. In such cases, the DU 174 includes, in the first DU-to-CU message, the additional cell ID(s) respectively associated with the additional LTM DU configuration(s) to indicate that which LTM DU configuration is associated to which cell (ID). The cell(s) 1 and/or 2, . . . , N are candidate cell(s).

In some implementations, the CU 172 does not include a (reference) LTM DU configuration in the first CU-to-DU message. In such cases, the DU 174 generates a reference LTM DU configuration, generates the LTM DU configuration(s) 1 and/or 2, . . . , N (i.e., non-reference LTM DU configuration(s)) based on the reference LTM DU configuration, and includes the reference LTM DU configuration in the first DU-to-CU message. In other implementations, the CU 172 includes a reference LTM DU configuration in the first CU-to-DU message. In such cases, the DU 174 generates the LTM DU configuration(s) 1, and/or 2, . . . , N which are delta configuration(s) to augment the reference LTM DU configuration. In yet other implementations, the CU 172 includes a reference LTM DU configuration (e.g., a first reference LTM DU configuration) in the first CU-to-DU message. In such cases, the DU 174 generates a reference LTM DU configuration (e.g., a second reference LTM DU configuration) replacing the first reference LTM DU configuration, generates the LTM DU configuration(s) 1 and/or 2, . . . , N based on the second reference LTM DU configuration, and includes the second reference LTM DU configuration in the first DU-to-CU message.

In some implementations, the reference LTM DU configuration includes physical layer configuration parameters, MAC configuration parameters, and/or RLC configuration parameters. In some implementations, the reference LTM DU configuration is CellGroupConfig IE defined in 3GPP specification 38.331. In other implementations, the reference LTM DU configuration includes configuration parameters in the CellGroupConfig IE. In some implementations, the reference LTM DU configuration includes a CSI-MeasConfig IE or configuration parameters for channel state information (CSI) measurement and/or reporting.

In some implementations, the reference LTM DU configuration is different from the serving DU configuration. In some implementations, a portion of the reference LTM DU configuration is the same as a portion of the serving DU configuration and the rest of the reference LTM DU configuration is different from the rest of the serving DU configuration. In other implementations, the reference LTM DU configuration is the same as the serving DU configuration.

After receiving the first DU-to-CU message, the CU 172 generates a RRC reconfiguration message (e.g., an RRCReconfiguration message) including the LTM DU configuration 1 and transmits 316 a second CU-to-DU message including the RRC reconfiguration message to the DU 174. In some implementations, the CU 172 includes the reference LTM DU configuration in the RRC reconfiguration message 316. In other implementations, the CU 172 does not include a/the reference LTM DU configuration in the RRC reconfiguration message 316. In some implementations, if the CU 172 transmits the reference LTM DU configuration to the UE 102 during the event 302, the CU 172 does not include the reference LTM DU configuration in the RRC reconfiguration message 316. In other implementations, if the CU 172 receives the reference LTM DU configuration from the DU 174, the CU 172 includes the LTM DU configuration in the RRC reconfiguration message 316. Otherwise, if the CU 172 does not receive a reference LTM DU configuration from the DU 174, the CU 172 does not include the reference LTM DU configuration in the RRC reconfiguration message 316.

In some implementations, the CU 172 includes the LTM DU configuration 1 and/or the LTM CU configuration 1 in a first container (e.g., a field/IE) and includes the first container (e.g., LTM configuration 1) in the RRC reconfiguration message of the events 316 and 318. In such cases, the CU 172 generates the first container. The first container is to indicate the UE 102 not to apply the LTM DU configuration 1 and/or the LTM CU configuration 1 immediately. In some scenarios or implementations, the UE 102 receives a RRC reconfiguration message (e.g., the RRC reconfiguration message of the event 318) including a configuration (e.g., the LTM DU configuration 1). If the configuration is included in the first container, the UE 102 refrains from immediately applying the configuration. Otherwise, if the configuration is not included in the first container, the UE 102 can apply the configuration immediately. In some implementations, the first container can be a first addition or modification list (e.g., Itm-ConfigToAddModList field, LTM-ConfigToAddModList IE, Itm-CandidateConfigToAddModList field, or LTM-CandidateConfigToAddModList IE). The CU 172 includes the LTM DU configuration 1 and/or the LTM CU configuration 1 in a first element (referred to herein after as element 1) of the first addition or modification list. For example, the element 1 can be an addition or modification IE (Itm-ConfigToAddMod field, LTM-ConfigToAddMod IE, Itm-CandidateConfigToAddMod field, or LTM-CandidateConfigToAddMod IE). When the UE 102 receives the first addition or modification list, the UE 102 can store the first addition or modification list, e.g., in a variable in its random access memory (RAM). In other alternative implementations, the DU 174 generates the first container and includes the first container in the first DU-to-CU message. In yet other alternative implementations, the DU 174 generates the element 1 and includes the element 1 in the first DU-to-CU message.

In some implementations, the CU 172 includes a LTM CU configuration 1 in the RRC reconfiguration message 316, the first container or the element 1, where the LTM CU configuration 1 associated with the LTM DU configuration 1. To associate the LTM CU configuration 1 with the LTM DU configuration 1, the CU 172 can include the LTM CU configuration 1 and the LTM DU configuration in the element 1. In some implementations, the CU 172 includes LTM CU configuration(s) 2, . . . , N in the RRC reconfiguration message 316 or the second container, where the LTM CU configuration(s) 2, . . . , N associated with the LTM DU configuration(s) 2, . . . , N, respectively. To associate the LTM CU configuration(s) 2, . . . , N with the LTM DU configuration(s) 2, . . . , N, the CU 172 can include the LTM CU configuration(s) 2, . . . , N and the LTM DU configuration(s) in the element(s) 2, . . . , N, respectively. In other implementations, the CU 172 includes, in the element(s) 2, . . . , N, the LTM CU configuration(s) 2, . . . , N associated with the LTM DU configuration(s) 2, . . . , N, respectively. Alternatively, the CU 172 does not include, in the RRC reconfiguration message 316, LTM CU configuration(s) for some or all of the LTM DU configuration 1 and/or LTM DU configuration(s) 2, . . . , N.

After receiving the RRC reconfiguration message 316, the DU 174 transmits 318 the RRC reconfiguration message to the UE 102. In response, the UE 102 transmits 320 a RRC reconfiguration complete message (e.g., an RRCReconfigurationComplete message) to the DU 174, which in turn transmits 322 a second DU-to-CU message including the RRC reconfiguration complete message to the CU 172. In some implementations, the CU 172 performs security protection (e.g., integrity protection and/or encryption) on the RRC reconfiguration message. For example, the CU 172 generates a message authentication code for integrity (MAC-I) for the RRC reconfiguration message, encrypts the RRC reconfiguration message and the MAC-I to obtain an encrypted RRC reconfiguration message and an encrypted MAC-I, and transmits a PDCP PDU including the encrypted RRC reconfiguration message and encrypted MAC-I to the UE 102 via the DU 174 in the events 316 and 318. When the UE 102 receives the PDCP PDU from the CU 172 via the DU 174 (i.e., events 316 and 318), the UE 102 decrypts the encrypted RRC reconfiguration and encrypted MAC-I to obtain the RRC reconfiguration message and MAC-I and verifies whether the MAC-I is valid. If the UE 102 verifies the MAC-I is invalid, the UE 102 discards or ignores the RRC reconfiguration message. In some implementations, the UE 102 can perform a RRC connection reestablishment procedure in response to the invalid MAC-I. Otherwise, if the UE 102 verifies the MAC-I is valid, the UE 102 can process the RRC reconfiguration. The UE 102 refrains from applying (i.e., executing) the LTM DU configuration 1 until receiving a configuration activation command activating the LTM DU configuration 1 (e.g., the event 330).

The events 308 (optional) and 310 are collectively referred to in FIG. 3 as a LTM preparation procedure 390. The events 316, 318, 320, 322 are collectively referred to in FIG. 3 as a LTM configuration delivery procedure 394.

In some implementations, the first CU-to-DU message is a UE Context Modification Request message, and the first DU-to-CU message is a UE Context Modification Response message or UE Context Modification Required message. In the case of the UE Context Modification Required message, the CU 172 can transmit a UE Context Modification Confirm message to the DU 174 in response to UE Context Modification Required message. In some implementations, the second CU-to-DU message is a DL RRC Message Transfer message. In other implementations, the second CU-to-DU message is a UE Context Modification Request message and the DU 174 can transmit a second DU-to-CU message (e.g., UE Context Modification Response message) to the CU 172 in response to the second CU-to-DU message.

In some implementations, the CU 172 can include a reference LTM CU configuration in the RRC reconfiguration message 316 or the first container. In some implementations, the CU 172 might generate the LTM CU configuration 1 (i.e., non-reference LTM CU configuration) as a delta configuration to augment the reference LTM CU configuration. Similarly, the CU 172 might generate some or all of the LTM CU configuration(s) 2, . . . , N as delta configuration(s) to augment the reference LTM CU configuration. Alternatively, in the RRC reconfiguration message 316 or the first container, the CU 172 includes the reference LTM CU configuration and does not include a non-reference LTM CU configuration. In some implementations, the CU 172 includes the reference LTM CU configuration and/or the reference LTM DU configuration in an additional container (e.g., reference LTM configuration) and include the additional container in the RRC reconfiguration message 316.

In some implementations, the reference LTM CU configuration is different from the serving CU configuration. In some implementations, a portion of the reference LTM CU configuration is the same as a portion of the serving CU configuration and the rest of the reference LTM CU configuration is different from the rest of the serving CU configuration. In yet other implementations, the reference LTM CU configuration is the same as the serving LTM CU configuration.

### 1) CU Assigns an ID for the LTM DU Configuration 1

In some implementations, the CU 172 includes, in the RRC reconfiguration message, a first LTM ID (referred to herein after as ID 1) for identifying the LTM DU configuration 1 or the element 1. In some implementations, the CU 172 includes the ID 1 in the first container or element 1. In some implementations, the CU 172 assigns the ID 1. In other implementations, the CU 172 receives the ID 1 from the DU 174 in the first DU-to-CU message, as described below.

In the case that the CU 172 assigns or generates the ID 1, the CU 172 can transmit the ID 1 to the DU 174, and the DU 174 associates the ID 1 with the LTM DU configuration 1. In some implementations, in the first CU-to-DU message, the CU 172 includes the ID 1 and indicates the ID 1 is associated with the LTM DU configuration 1. In other implementations, after receiving the first DU-to-CU message, the CU 172 transmits 312 a third CU-to-DU message including the ID 1 to the DU 174 instead of including the ID 1 in the first CU-to-DU message. In some implementations, in the third CU-to-DU message, the CU 172 can include the LTM DU configuration 1 and the ID 1 and indicate the association between the ID 1 and LTM DU configuration 1. Thus, the DU 174 can directly associate the ID 1 with the LTM DU configuration 1. In other implementations, in the third CU-to-DU message, the CU 172 can include the cell ID 1 and the ID 1 (i.e., the first LTM ID) and indicate the association between the cell ID 1 and the ID 1. Thus, the DU 174 can associate the ID 1 with the LTM DU configuration 1, based on the association between the cell ID 1 and the ID 1 and the association between the cell ID 1 and the LTM DU configuration 1. In yet other implementations, in the third CU-to-DU message, the CU 172 can include the LTM DU configuration 1, the cell ID 1 and the ID 1 and indicate the association between the ID 1, LTM DU configuration 1 and the cell ID 1. In some implementations, the DU 174 can transmit 314 a third DU-to-CU message to the CU 172 in response to the third CU-to-DU message. In some implementations, the third CU-to-DU message and third DU-to-CU message are UE Context Modification Request message and UE Context Modification Response message. The events 312 (optional) and 314 (optional) are collectively referred to in FIG. 3 as a LTM ID assignment procedure 392. In other implementations, the CU 172 can include the ID 1, the cell ID 1 and/or the LTM DU configuration 1 in the second CU-to-DU message as described above. Thus, the third CU-to-DU message can be omitted.

In the case that the CU 172 includes the ID 1 in the first CU-to-DU message, the DU 174 can include the ID 1 in the LTM DU configuration 1, first container or element 1. Alternatively, the DU 174 does not include the ID 1 in the LTM DU configuration 1, first container and/or element 1.

### 2) DU Assigns an ID for the LTM DU Configuration 1

In some alternative implementations, the DU 174 assigns the ID 1 identifying the LTM DU configuration 1. In some implementations, the DU 174 includes the ID 1 in the first DU-to-CU message. The CU 172 can include the ID 1 in the RRC reconfiguration message as described above. In other implementations, the DU 174 includes the ID 1 in the LTM DU configuration 1, first container or element 1. Thus, the CU 172 does not include an ID identifying the LTM DU configuration 1 in the RRC reconfiguration message, first container and/or element 1.

In some implementations, the CU 172 includes the reference LTM DU configuration in the first container. For example, the CU 172 includes the reference LTM DU configuration in a field of the first container, different from a field of the first container including the LTM DU configuration 1. In other implementations, the CU 172 includes the reference LTM DU configuration in the RRC reconfiguration message 316 and outside the first container. For example, the CU 172 generates a third container (e.g., a field/IE) to include the first container and the reference LTM DU configuration and includes the third container in the RRC reconfiguration message 316. In yet other implementations, the DU 174 includes the reference LTM DU configuration in the first container. For example, the DU 174 includes the reference LTM DU configuration in a field of the first container, different from a field of the first container including the LTM DU configuration 1. In yet other implementations, the DU 174 generates a fourth container (e.g., a field/IE) to include the first container and the reference LTM DU configuration and includes the fourth container in the first DU-to-CU message 310. In such cases, the CU 172 includes the fourth container in the RRC reconfiguration message 316. Alternatively, the CU 172 retrieves the reference LTM DU configuration and the LTM DU configuration 1 from the fourth container and includes the reference LTM DU configuration and the LTM DU configuration 1 as described above.

In some implementations, neither the CU 172 nor the DU 174 assign an ID to identify the reference LTM DU configuration. In some implementations, neither the CU 172 nor the DU 174 assign an ID to identify the reference LTM CU configuration.

In some implementations, the LTM DU configuration 1 includes a plurality of configuration parameters for the UE 102 to communicate with the DU 174 on the first cell.

In some implementations, the plurality of configuration parameters include physical layer configuration parameters (e.g., PhysicalCellGroupConfig IE), MAC layer configuration parameters (e.g., MAC-CellGroupConfig IE) and/or RLC configuration parameters (e.g., RLC-BearerConfig IE(s)). In some further implementations, the plurality of configuration parameters include a special cell configuration (e.g., SpCellConfig IE) and/or one or more SCell configurations (e.g., SCellConfig IE(s)). In some implementations, the LTM DU configuration 1 is CellGroupConfig IE defined in 3GPP specification 38.331. In other implementations, the LTM DU configuration 1 includes configuration parameters in the CellGroupConfig IE.

In some implementations, the LTM CU configuration 1 includes PDCP configuration parameters, measurement configuration parameters, and/or radio bearer configuration parameters. In some implementations, the LTM CU configuration 1 includes a MeasConfig IE and/or a RadioBearerConfig IE defined in 3GPP specification 38.331 or includes configuration parameters in the MeasConfig IE and/or RadioBearerConfig IE. In some implementations, the LTM DU configuration 1 includes a CSI-MeasConfig IE or configuration parameters for channel state information (CSI) measurement and reporting. In other implementations, the LTM CU configuration 1 includes a CSI-MeasConfig IE or configuration parameters for channel state information (CSI) measurement and reporting.

In some implementations, the DU 174 includes a random access configuration in the LTM DU configuration 1. In other implementations, the DU 174 does not include a random access configuration in the LTM DU configuration 1. In some implementations, if the cell 124A and first cell are not synchronized, the DU 174 determines to include the random access configuration in the LTM DU configuration 1. Otherwise, if the cell 124A and first cell are synchronized, the DU 174 determines to not include the random access configuration in the LTM DU configuration 1. In other implementations, if the DU 174 determines that the UE 102 has not synchronized in UL with the first cell, the DU 174 determines to include the random access configuration in the LTM DU configuration 1. Otherwise, if the DU 174 determines that the UE 102 has synchronized in UL with the first cell, the DU 174 determines to not include the random access configuration in the LTM DU configuration 1. If the LTM DU configuration 1 includes the random access configuration, the UE 102 performs the random access procedure in the event 332 in accordance with the random access configuration, as described below. Otherwise, if the LTM DU configuration 1 does not include the random access configuration, the UE 102 skips or refrains from performing the random access procedure of the event 332 in response to the LTM DU configuration 1 excluding the random access configuration.

In some implementations, the DU 174 includes random access configuration parameters in the LTM DU configuration 1 and/or the reference LTM DU configuration regardless of whether the cell 124A and first cell are synchronized or not. The UE 102 performs the random access procedure in the event 332 in accordance with the random access configuration parameters, as described below.

In some implementations, if the cell 124A and first cell are synchronized, the DU 174 determines to include, in the LTM DU configuration 1, a first indication configuring the UE 102 not to perform a random access procedure on the first cell. Otherwise, if the cell 124A and first cell are not synchronized, the DU 174 determines to not include the first indication in the LTM DU configuration 1. In other implementations, if the DU 174 determines that the UE 102 has synchronized in UL with the first cell, the DU 174 determines to include the first indication in the LTM DU configuration 1. Otherwise, if the DU 174 determines that the UE 102 has not synchronized in UL with the first cell, the DU 174 determines to not include the first indication in the LTM DU configuration 1. If the LTM DU configuration 1 includes the first indication, the UE 102 skips or refrains from performing the random access procedure of the event 332 in accordance with or in response to the first indication. Otherwise, if the LTM DU configuration 1 does not include the first indication, the UE 102 performs the random access procedure in accordance with the random access configuration in the event 332, in response to the LTM DU configuration 1 excluding the first indication, as described below.

In some implementations, the DU 174 includes a reconfiguration with sync configuration (e.g., ReconfigurationWithSync IE) in the LTM DU configuration 1 or special cell configuration. In other implementations, the DU 174 does not include a reconfiguration with sync configuration (e.g., ReconfigurationWithSync IE) in the LTM DU configuration 1 or special cell configuration. In some implementations, if the cell 124A and first cell are not synchronized, the DU 174 determines to include the reconfiguration with sync configuration in the LTM DU configuration 1. Otherwise, if the cell 124A and first cell are synchronized, the DU 174 determines to not include the reconfiguration with sync configuration in the LTM DU configuration 1. In other implementations, if the DU 174 determines that the UE 102 has not synchronized in UL with the first cell, the DU 174 determines to include the reconfiguration with sync configuration in the LTM DU configuration 1. Otherwise, if the DU 174 determines that the UE 102 has synchronized in UL with the first cell, the DU 174 determines to not include the reconfiguration with sync configuration in the LTM DU configuration 1. In some implementations, if the LTM DU configuration 1 includes the reconfiguration with sync configuration, the UE 102 performs the random access procedure in the event 332 as described below, in response to or in accordance with the reconfiguration with sync configuration. Otherwise, if the LTM DU configuration 1 does not include the reconfiguration with sync configuration, the UE 102 skips or refrains from performing the random access procedure of the event 332. In some implementations, the DU 174 includes a cell ID (i.e., cell ID 1) of cell 1 (i.e., the first cell) in the LTM DU configuration 1. In one implementation, the cell ID 1 can be a PCI. In another implementation, the cell ID 1 is a CGI. In some implementations, the cell ID 1 included in the LTM DU configuration 1 is a PCI, while the cell ID 1 included in the first CU-to-DU message is a CGI. In some further implementations, the LTM DU configuration 1 includes a cell index 1 indexing the cell ID 1 or the first cell. The cell index 1 is not a cell ID. The cell index takes fewer bits than the cell ID. In some implementations, the CU 172 sets the cell index 1 to a value and includes the cell index 1 in the first CU-to-DU message of the event 308.

In some implementations, after (e.g., in response to) receiving one or some of the at least one measurement report of the event 304, the base station 104 (i.e., the CU 172 or DU 174) determines to prepare additional cell(s) (i.e., cell(s) 2, . . . , N) of the base station 104 for LTM for the UE 102. In one implementation, the base station 104 determines to prepare the additional cell(s) for LTM for the UE 102 because the at least one measurement report indicates that the additional cell(s) could be used by the base station 104 to communicate with the UE 102. The additional cell(s) can include the cell 124C and/or cell(s) other than the cells 124A, 124B and 124C. In some implementations, if the L3 measurement report(s) indicates that signal strength and/or quality of a particular cell of the additional cell(s) is above a respective predetermined threshold and/or is better than the cell 124A, the CU 172 determines to prepare the particular cell for LTM for the UE 102. In other implementations, if the L1 measurement report(s) indicates that signal strength and/or quality of a particular cell of the additional cell(s) is above a first predetermined threshold and/or is better than the cell 124A, the DU 174 determines to prepare the particular cell for LTM for the UE 102. In one implementation, the respective predetermined threshold(s) for the additional cells can be different from the first predetermined threshold. In another implementation, the respective predetermined threshold(s) for the additional cell(s) can be the same as the first predetermined threshold. In some implementations, the respective predetermined thresholds for the additional cells can be the same or different. Alternatively, the base station 104 determines to prepare the additional cell(s) for the UE 102 regardless of whether a measurement report is received from the UE 102 or not.

In the case that the CU 172 determines to prepare the additional cell(s), the CU 172 initiates and performs at least one additional LTM preparation procedure (LTM preparation procedure(s)) with the DU 174 to prepare the additional cell(s) for LTM, where each of the LTM preparation procedure(s) is similar to the procedure 390. In the case that the DU 174 determines to prepare the additional cell(s), the DU 174 initiates and performs at least one additional LTM preparation procedure (LTM preparation procedure(s)) with the CU 172 to prepare the additional cell(s) for LTM, where each of the LTM preparation procedure(s) is similar to the procedure 390.

In some implementations, the CU 172 and DU 174 perform LTM preparation procedure(s) 2, . . . , N to prepare the cell(s) 2, . . . , N, respectively, similar to the procedure 390. The CU 172 can include the cell ID(s) 2, . . . , N in CU-to-DU message(s) 2, . . . , N in the LTM preparation procedure(s) 2, . . . , N, respectively, similar to the first CU-to-DU message. In the LTM preparation procedure(s) 2, . . . , N, the DU 174 generates LTM DU configuration(s) 2, . . . , N configuring the cell(s) 2, . . . , N and includes the LTM DU configuration(s) 2, . . . , Nin DU-to-CU message(s) 2, . . . , N, respectively, as described for the LTM DU configuration 1. In the case that the DU 174 receives the CU-to-DU message(s) 2, . . . , N, the DU-to-CU message(s) 2, . . . , N responds to the CU-to-DU message(s) 2, . . . , N, respectively. “N” is an integer and larger than one. For example, “N” is 2, 3, 4, 5, 6, 7, 8, 9, 10, 11, 12, 13 14, 15 or 16. In another example, the maximum number of “N” is 4, 8, 16 or 32. Examples and implementations of the LTM DU configuration 1 can apply to the LTM DU configuration(s) 2, . . . , N.

In other implementations, the CU 172 and DU 174 performs a single LTM preparation procedure (i.e., the LTM preparation procedure 390) to prepare the cell(s) 1, 2, . . . , N. In such cases, the DU 174 includes the LTM DU configuration(s) 1, 2, . . . , N for the cell(s) 1, 2, . . . , N, respectively in the first DU-to-CU message. In the first DU-to-CU message, the DU 174 can include the cell ID(s) 1, 2, . . . , N respectively associated with the LTM DU configuration(s) 1, 2, . . . , N to indicate that the LTM DU configuration(s) 1, 2, . . . , N are configured for the cell ID(s) 1, 2, . . . , N, respectively. In the case that the CU 172 determines to perform the LTM preparation procedure 390, the CU 172 includes the cell ID(s) 1, 2, . . . , N in the first CU-to-DU message to request the DU 174 to prepare the cell(s) 1, 2, . . . , N, respectively, for LTM.

After receiving the LTM DU configuration(s) 2, . . . , N from the DU 174, the CU 172 can include the LTM DU configuration(s) 2, . . . , N in the first container. In some implementations, the CU 172 can include the LTM DU configuration(s) 2, . . . , N in element(s) 2, . . . , N, respectively, and includes the element(s) 2, . . . , N in the first container. In some implementations, the CU 172 includes, in the RRC reconfiguration message, LTM ID(s) (i.e., ID(s) 2, . . . , N) for identifying the LTM DU configuration(s) 2, . . . , N, respectively. In some implementations, the CU 172 includes the ID(s) 2, . . . , N in the first container. For example, the CU 172 can include the ID(s) 2, . . . , N and LTM DU configuration(s) 2, . . . , N in the element(s) 2, . . . , N in the first addition or modification list.

In some implementations, the CU 172 assigns the ID(s) 2, . . . , N for the LTM DU configuration(s) 2, . . . , N, respectively. In other implementations, the CU 172 receives the ID(s) 2, . . . , N from the DU 174 in the first DU-to-CU message of the procedure 390. In yet other implementations, the CU 172 receives from the DU 174 the ID(s) 2, . . . , N in the DU-to-CU message(s) 2, . . . , N of the LTM preparation procedure(s) 2, . . . , N, respectively.

In some implementations, the CU 172 can perform a LTM ID assignment procedure with the DU 174 for each of the LTM DU configuration(s) 2, . . . , N, similar to the procedure 392. In other implementations, the CU 172 can include the ID(s) 2, . . . , N and the LTM DU configuration(s) 2, . . . , N in the third CU-to-DU message and indicate the association between the ID(s) 2, . . . , N and the LTM DU configuration(s) 2, . . . , N, respectively. Thus, the DU 174 can associate the LTM DU configuration(s) 2, . . . , N with the ID(s) 2, . . . , N, respectively. In yet other implementations, the CU 172 can include the cell ID(s) 2, . . . , N and the ID(s) 2, . . . , N in the third CU-to-DU message and indicate the association between the cell ID(s) 2, . . . , N and the ID(s) 2, . . . , N, respectively. Thus, the DU 174 can associate the LTM DU configuration(s) 2, . . . , N with the ID(s) 2, . . . , N, respectively, based on the association between the cell ID(s) 2, . . . , N and the ID(s) 2, . . . , N and the association between the cell ID(s) 2, . . . , N and the LTM DU configuration(s) 2, . . . , N, respectively. In other implementations, the CU 172 can include the ID(s) 2, . . . , N, the cell ID(s) 2, . . . , N and/or the LTM DU configuration(s) 2, . . . , N in the second CU-to-DU message as described above. Thus, the third CU-to-DU message can be omitted. In yet other implementations, the CU 172 can include the ID(s) 2, . . . , N in the first CU-to-DU message and indicate the ID(s) 2, . . . , N is/are respectively associated with the cell ID(s) 2, . . . , N. In one implementation, the DU 174 includes the ID(s) 2, . . . , N in the LTM DU configuration(s) 2, . . . , N. Thus, the CU 172 does not include the ID(s) 2, . . . , N in the RRC reconfiguration message, first container and/or element(s) 2, . . . , N.

In some alternative implementations, the DU 174 assigns the ID(s) 2, . . . , N. In some implementations, the DU 174 includes the ID(s) 2, . . . , N in the first DU-to-CU message of the procedure 390. In yet other implementations, the DU 174 includes the ID(s) 2, . . . , N in the DU-to-CU message(s) 2, . . . , N of the LTM preparation procedure(s) 2, . . . , N. The CU 172 can include the ID(s) 2, . . . , N in the RRC reconfiguration message. In other implementations, the DU 174 includes the ID(s) 2, . . . , N in the LTM DU configuration(s) 2, . . . , N. Thus, the CU 172 does not include an ID (e.g., LTM ID) identifying each of the LTM DU configuration(s) 2, . . . , N in the RRC reconfiguration message, first container and/or element 1.

In some alternative implementations, the CU 172 can generate a second container including the LTM DU configuration(s) 2, . . . , N or element(s) 2, . . . , N instead of using the first container. The CU 172 then transmits an additional RRC reconfiguration message including the second container to the UE 102 via the DU 174, similar to the events 316 and 318. In response, the UE 102 transmits an additional RRC reconfiguration complete message to the CU 172 via the DU 174, similar to the events 320 and 322. In some implementations, the second container can be a second addition or modification list (e.g., Itm-ConfigToAddModList field, LTM-ConfigToAddModList IE, Itm-CandidateConfigToAddModList field, or LTM-CandidateConfigToAddModList IE), and each of the element(s) 2, . . . , N can be an addition or modification IE (e.g., Itm-ConfigToAddMod field, LTM-ConfigToAddMod IE, Itm-CandidateConfigToAddMod field, or LTM-CandidateConfigToAddMod IE). When the UE 102 receives the second addition or modification list, the UE 102 can store the second addition or modification list together with the first addition or modification list, e.g., in a variable in its random access memory (RAM).

In some implementations, the DU 174 includes cell ID(s) 2, . . . , N in the LTM DU configuration(s) 2, . . . , N to identify the cell(s) 2, . . . , N, respectively. In one implementation, each of the cell ID(s) 2, . . . , N is a PCI. In some further implementations, the LTM DU configuration(s) 2, . . . , N includes cell index(es) 2, . . . , N indexing the cell ID(s) 2, . . . , Nor the cell(s) 2, . . . , N, respectively. In the case that the CU 172 prepares the cell(s) 2, . . . , N for LTM in the procedure 390, the CU 172 can set the cell index(es) 2, . . . , N to different value(s) and include the cell index(es) 2, . . . , N in the first CU-to CU-to-DU message of the event 308. In the case that the CU 172 prepares the cell(s) 2, . . . , N in the additional LTM preparation procedure(s), the CU 172 can set the cell index(es) 2, . . . , N to different values and include the cell index(es) 2, . . . , N in CU-to-DU message(s) of the additional LTM preparation procedure(s). The CU 172 sets the cell index(es) 1, . . . , N to different values. In some implementations, the cell ID(s) 1, . . . , N in the LTM DU configuration(s) 1, . . . , N are different from the cell ID(s) 1, . . . , N in the CU-to-DU message(s) described above.

In some implementations, each of the LTM DU configuration(s) 1, . . . , N includes physical configuration parameters, MAC configuration parameters, RLC configuration parameters and/or L1 measurement configuration(s). In some implementations, each of the LTM DU configuration(s) 1, . . . , N can be a CellGroupConfig IE as defined in 3GPP specification 38.331. In other implementations, each of the LTM DU configuration(s) 1, . . . , N include configuration parameters included in a CellGroupConfig IE as defined in 3GPP specification 38.331. In some further implementations, the plurality of configuration parameters in each of the LTM DU configuration(s) include a particular special cell configuration (e.g., SpCellConfig IE) and/or one or more SCell configurations (e.g., SCellConfig IE(s)). In some implementations, the LTM DU configuration(s) 1, . . . , N are CellGroupConfig IE(s) defined in 3GPP specification 38.331. In other implementations, the LTM DU configuration(s) 1, . . . , N include configuration parameters in the CellGroupConfig IE.

In some implementations, the CU 172 can include one or more additional LTM CU configurations in at least one of the element(s) 2, . . . , N, the first container or the second container. Each of the additional LTM CU configurations are associated with a particular LTM DU configuration of the LTM DU configuration(s) 2, . . . , N. Examples and implementations of the additional LTM CU configurations are similar to the LTM CU configuration 1.

In some implementations, the CU 172 determines to release the LTM DU configuration M of the LTM DU configuration(s) 1, . . . , N (or the element M of the element(s) 1, . . . , M). 1≤M≤N. In response to the determination, the CU 172 transmits a RRC reconfiguration message to the UE 102 via the DU 174 to indicate the UE 102 to release the LTM DU configuration M or element M. In one implementation, the CU 172 generates a release list including the ID (i.e., LTM ID) M for releasing the LTM DU configuration M or element M and includes the release list in the RRC reconfiguration message. In response to the RRC reconfiguration message, the UE 102 releases the LTM DU configuration M or element M and transmits a RRC reconfiguration complete message to the CU 172 via the DU 174. In response to the determination, the CU 172 transmits a CU-to-DU message to the DU 174 to indicate the DU 174 to release the LTM DU configuration M. To indicate the DU 174 to release the LTM DU configuration M, the CU 172 can include the cell ID M or the ID (i.e., LTM ID) M in a release indication (e.g., a field or IE) in the CU-to-DU message. In response, the DU 174 releases the LTM DU configuration M and transmits a DU-to-CU message to the CU 172. In some implementations, the CU-to-DU message and DU-to-CU message are a UE Context Modification Request message and a UE Context Modification Response message, respectively.

In other implementations, the DU 174 determines to release the LTM DU configuration K. In response to the determination, the DU 174 transmits a DU-to-CU message to the CU 172 to release the LTM DU configuration K. To indicate the LTM DU configuration K is released, the DU 174 can include the cell ID K or the ID (i.e., LTM ID) K in a release indication (e.g., a field or IE) in the DU-to-CU message. 1≤K≤N. After (e.g., in response to) receiving the DU-to-CU message, the CU 172 generates a release list including the ID (i.e., LTM ID) K to release the LTM DU configuration K or element K and transmits a RRC reconfiguration message including the release list to the UE 102 via the DU 174. In response, the UE 102 releases the LTM DU configuration K or element K and transmits a RRC reconfiguration complete message to the UE 102 via the DU 174. The CU 172 can transmit a CU-to-DU message to the DU 174 in response to the DU-to-CU message. In some implementations, the DU-to-CU message and CU-to-DU message are a UE Context Modification Required message and a UE Context Modification Confirm message, respectively.

After receiving the RRC reconfiguration in the event 318 or transmitting the RRC reconfiguration complete message in the event 320, the UE 102 transmits 324 at least one measurement report to the DU 174, similar to the event 304. In some implementations, the DU 174 may transmit 326 a DU-to-CU message including the at least one measurement report to the CU 172, similar to the event 306. In other implementations, the DU 174 does not transmit the at least one measurement report to the CU 172. In some implementations, the at least one measurement report of the event 324 include L1 measurement report(s) or L3 measurement repot(s), as described for the event 304. In some implementations, the UE 102 transmits 324 the at least one measurement report on PUCCH(s) and/or PUSCH(s) to the DU 174, similar to the event 304. In other implementations, the UE 102 transmits 324 at least one MAC CE including the at least one measurement report to the DU 174, similar to the event 304. In some implementations, the UE 102 does not transmit the L1 measurement report(s) in format of RRC message(s) to the DU 174.

In some implementations, the UE 102 transmits 324 the at least one measurement report to the DU 174 in accordance with at least one measurement configuration. The at least one measurement configuration configures the UE 102 to perform measurements and report measurement results. The CU 172 transmits the at least one measurement configuration to the UE 102 via the DU 174. For example, the CU 172 can transmit one or more RRC messages (e.g., RRCReconfiguration message(s)) including the at least one measurement configuration to the UE 102 via the DU 174 in the event 302 and/or 316 and/or after the event 306 or 316. The one or more RRC messages may or may not include the RRC reconfiguration message of the event 316. In accordance with the at least one measurement configuration, the UE 102 performs measurements on one or more reference signals. The one or more reference signals can include one or more SSBs and/or one or more CSI-RSs. The UE 102 obtains the at least one L1 measurement result and/or at least one L3 measurement result from the measurements and includes the at least one L1 measurement result and/or at least one L3 measurement result in the at least measurement report of the event 324. The DU 174 transmits the one or more reference signals on the cell 124A, the cell 1 and/or the cell(s) 2, . . . , N. The one or more reference signals can be CSI-RS(s) or SSB(s).

In some implementations, the at least one measurement configuration includes L3 measurement configuration(s) (e.g., MeasConfig IE(s)), as described for the event 304. In other implementations, the at least one measurement configuration includes L1 measurement configuration(s), as described for the event 304. For example, the L1 measurement configuration(s) can be CSI-MeasConfig IE(s) defined in 3GPP specification 38.331 v 18.0.0 and/or later versions. The L1 measurement configuration(s) can include measurement report configuration(s). The UE 102 transmits the L1 measurement report(s) on PUCCH(s) or MAC CE(s) to the DU 174 in accordance with the measurement report configuration(s). The DU 174 receives the L1 measurement report(s) on PUCCH(s) or MAC CE(s) in accordance with the measurement report configuration(s). In some implementations, the measurement report configuration(s) are CSI-ReportConfig IE(s). In other implementations, each of the measurement report configuration(s) is an RRC IE specifically defined for, and dedicated to LTM (e.g., in a relevant 3GPP specification such as TS 38.331). In some implementations, (each of) the measurement report configuration(s) configures periodically reporting and/or event-triggered reporting of the L1 measurement result(s).

In yet other implementations, the at least one measurement configuration includes “LTM-dedicated-type” measurement configuration(s) specifically defined for and dedicated to LTM (e.g., LTM measurement configuration(s)). The LTM-dedicated-type of a measurement configuration can be defined in a relevant 3GPP specification. In some implementations, the LTM-dedicated-type measurement configuration(s) includes reference signal resource configuration(s) configuring resources where the DU 174 transmits reference signal(s). For example, the reference signal resource configuration(s) include CSI-RS(s) and/or SSB(s). In one implementation, the reference signal resource configuration(s) is/are CSI-ResourceConfig IE(s). In another implementation, the LTM-dedicated-type measurement configuration(s) include measurement report configuration(s), as described above. The UE 102 transmits the measurement report(s) on PUCCH(s) or MAC CE(s) to the DU 174 in accordance with the measurement report configuration(s). The DU 174 receives the measurement report(s) on PUCCH(s) or MAC CE(s) in accordance with the measurement report configuration(s). In such cases, the measurement report(s) can be L1 measurement report(s) or LTM-dedicated-type measurement report(s) (e.g., LTM measurement report(s)). In some implementations, the LTM-dedicated-type measurement configuration includes configuration parameters defined specifically for the purposes of these procedures in a relevant 3GPP specification.

After (e.g., in response to) receiving the at least one measurement report in the event 324, the DU 174 generates a first LTM command to activate the LTM DU configuration 1 (i.e., the first LTM command commands the UE 102 to apply the LTM DU configuration 1 or to perform a serving cell change to the cell 1). The DU 174 then transmits 330 the first LTM command to the UE 102. In some implementations, the DU 174 transmits the first LTM command on the cell 124A to the UE 102. In other implementations, the DU 174 transmits the first LTM command on the cell 124D to the UE 102. In some implementations, the DU 174 can include the ID 1 in the first LTM command to indicate the LTM DU configuration 1, and the UE 102 determines (e.g., identifies) the LTM DU configuration 1 or element 1 in accordance with the ID 1. In other implementations, the DU 174 can include the cell index 1 indexing the cell ID 1 in the first LTM command. The UE 102 determines (e.g., identifies) the LTM DU configuration 1 or element 1 based on the cell index 1. After determining the LTM DU configuration 1 or element 1, the UE 102 then applies the LTM DU configuration 1 and/or LTM CU configuration 1, in response to receiving the first LTM command.

In yet other implementations, the DU 174 can include a bit map in the first LTM command to activate the LTM DU configuration 1, instead of the ID 1 or cell index 1. The number of bits in the bit map is larger than or equal to “N”. In one implementation, bit 1, . . . , N corresponds to the cell index(es) 1, . . . , N, the ID(s) 1, . . . , N, the LTM DU configuration(s) 1, . . . , N or the element(s) 1, . . . , N, respectively, and the DU 174 sets a corresponding bit (e.g., bit 1) in the bit map to a first value to indicate the cell index 1, the ID 1, the LTM DU configuration 1 or the element 1. Thus, the UE 102 can determine the cell index 1, the ID 1, LTM DU configuration 1, or element 1 in accordance with the bit 1 set to the first value in the bit map. In another implementation, bit 0, . . . , N-1 corresponds to the cell index(es) 1, . . . , N, the ID(s) 1, . . . , N, the LTM DU configuration(s) 1, . . . , N or the element(s) 1, . . . , N, respectively, and the DU 174 sets a corresponding bit (e.g., bit 0) in the bit map to a first value to indicate the cell index 1, the ID 1 the LTM DU configuration 1 or the element 1. Thus, the UE 102 can determine the cell index 1, the ID 1 LTM DU configuration 1 or element 1 in accordance with the bit O set to the first value in the bit map. In such implementations, the DU 174 sets the remaining bits in the bit map to a second value to indicate that the rest of the LTM DU configuration(s) 1, . . . , N is/are not activated. In some implementations, the first value is one and the second value is zero. In other implementations, the first value is zero and the second value is one. Generally, if the DU 174 determines to activate the LTM DU configuration L or change a serving cell to the cell L, the DU 174 can set the corresponding bit (e.g., bit L or bit L-1) in the bit map to the first value and set the remaining bits to the second value, where 1≤L≤N. In some implementations, the DU 174 sets at most one bit in the bit map to the first value.

In some implementations, the at least one measurement report (e.g., L1 measurement report(s) or LTM-dedicated-type measurement report(s)) of the event 324 includes at least one measurement result for the first cell, TRP(s) of the first cell or reference signal(s) transmitted on the first cell. The reference signal(s) can be CSI-RS(s) or SSB(s).

The DU 174 determines to activate the LTM DU configuration 1 or transmit the first LTM command, based on the at least one measurement result. In some implementations, the DU 174 determines to activate the LTM DU configuration 1 because, when or if the at least one measurement result is above a second predetermined threshold. In some implementations, the at least one measurement result includes L1-RSRP value(s), L1-RSRQ value(s) and/or L1-SINR value(s). In other implementations, the at least one measurement result includes RSRP value(s), RSRQ value(s) and/or SINR value(s) for the LTM-dedicated-type measurement report(s). In some implementations, the second predetermined threshold is different from the first predetermined threshold. In one implementation, the second predetermined threshold is larger than the first predetermined threshold. In this case, the at least one measurement result indicates that the first cell is suitable for communication with the UE 102. In another implementation, the second predetermined threshold is equal to the first predetermined threshold. In this case, the at least one measurement result indicates that the first cell has been continuously above the second predetermined threshold or the first predetermined threshold. This indicates that the first cell is suitable for communication with the UE 102. Thus, the DU 174 determines to activate the LTM DU configuration 1 in response to that signal strength or quality of the first cell is above the second predetermined threshold for the UE 102.

In some implementations, the at least one measurement report (e.g., L3 measurement report(s)) of the events 324 and 326 includes at least one measurement result for the first cell. The CU 172 determines to activate the LTM DU configuration 1 or transmit the first LTM command, because the at least one measurement result indicates that signal strength or quality of the first cell is above a second predetermined threshold. The second predetermined threshold is different from the first predetermined threshold. In one implementation, the second predetermined threshold is larger than the first predetermined threshold. In such an implementation, the at least one measurement report of the event 326 indicates that signal strength or quality of the first cell is suitable for communication with the UE 102. In another implementation, the second predetermined threshold is equal to the first predetermined threshold. In such an implementation, the at least one measurement report of the event 326 indicates that signal strength or quality of the first cell has been continuously above the second predetermined threshold or the first predetermined threshold. This also indicates that the first cell is suitable for communication with the UE 102. Thus, the CU 172 determines to activate the LTM DU configuration 1 in response to that signal strength or quality of the first cell is above the second predetermined threshold. In response to the determination, the CU 172 transmits 328 a fourth CU-to-DU message to the DU 174 to activate the LTM DU configuration 1 or trigger a serving cell change to the cell 1 for the UE 102. In some implementations, the CU 172 includes the ID 1 in the fourth CU-to-DU message. In other implementations, the CU 172 includes the cell index 1 in the fourth CU-to-DU message. In response to the fourth CU-to-DU message, the DU 174 transmits 330 the first LTM command to the UE 102 and optionally transmits a fourth DU-to-CU message to the CU 172. In some implementations, the CU 172 includes the cell index 1 in the fourth CU-to-DU message. Thus, the DU 174 can determine to activate the LTM DU configuration 1 in accordance with the cell index 1. In other implementations, the CU 172 can include the cell ID 1 in the fourth CU-to-DU message. Thus, the DU 174 determines to activate the LTM DU configuration 1 in accordance with the cell ID 1. In yet other implementations, the CU 172 can include the ID 1 in the fourth CU-to-DU message. Thus, the DU 174 can determine to activate the LTM DU configuration 1 in accordance with the ID 1. In some implementations, the fourth CU-to-DU message and fourth DU-to-CU message are a UE Context Modification Request message and a UE Context Modification Response message, respectively. In other implementations, the fourth CU-to-DU message and/or fourth DU-to-CU message are dedicated interface messages, e.g., F1 application protocol (F1AP) messages, defined specifically in connection with LTM procedures in a relevant 3GPP specification such as TS 38.473.

When or in response to determining to activate the LTM DU configuration 1 or transmit the first LTM command 330, the DU 174 might transmit 329 to the CU 172 a DU-to-CU message indicating LTM (being) executed. In some implementations, the DU 174 includes the cell ID 1 or the ID 1 (i.e., LTM ID) in the DU-to-CU message 329 to indicate that the DU 174 is to activate the LTM DU configuration 1 or trigger a fast serving cell change. The DU can transmit the DU-to-CU message 329 to the CU 172 before or after transmitting the LTM command 330.

In some implementations, the first LTM command is a MAC CE included in a MAC PDU that the UE 102 receives from the DU 174 in the event 330. The MAC CE can be a dedicated MAC CE defined specifically for LTM in a relevant 3GPP specification such as TS 38.321. In one implementation, the DU 174 includes a subheader identifying the dedicated MAC CE in the MAC PDU and the UE 102 identifies the dedicated MAC CE in the MAC PDU in accordance with the subheader. The subheader can include a logical channel ID or extended logical channel ID defined in a 3GPP specification to identify the dedicated MAC CE. For example, the logical channel ID or extended logical channel ID are newly defined in 3GPP specification 38.321 for example specifically for LTM. In other implementations, the first LTM command is a DCI that the UE 102 receives on a PDCCH from the DU 174 in the event 330. The DU 174 generates a CRC for the DCI, scrambles the CRC with a first C-RNTI of the UE 102, and transmits the DCI and scrambled CRC on the PDCCH in the event 330. In one implementation, a format of the DCI can be an existing DCI format defined in a 3GPP specification (e.g., 38.212). In another implementation, the format of the DCI can be a new DCI format defined in a 3GPP specification (e.g., 38.212 v 18.0.0 or later versions).

In some implementations, the DU 174 does not perform security protection (e.g., integrity protection and/or encryption) on the first LTM command. This speeds up processing the first LTM command in the UE 102 because the UE 102 does not perform security check (e.g., decryption and/or integrity check) on the first LTM command.

In some implementations, after receiving the first LTM command, the UE 102 may transmit 331 an acknowledgement to the DU 174 on the cell 124A or cell 124D to indicate that the UE 102 receives the first LTM command. In some implementations, the acknowledgement is a HARQ ACK. In other implementations, the acknowledgement is a MAC CE. For example, the MAC CE is an existing MAC CE defined in 3GPP specification 38.321 v 17.2.0 and/or later versions. In another example, the MAC CE is a new MAC CE defined in 3GPP specification 38.321 v 18.0.0 and/or later versions. In yet other implementations, the acknowledgement is a PUCCH transmission.

In some implementations, the CU 172 transmits 316 the RRC reconfiguration message in response to the L3 measurement report 306 for the first cell. To configure the UE 102 to transmit the L3 measurement report 306, the CU 172 can transmit a first RRC reconfiguration message including the L3 measurement configuration (e.g., a MeasConfig IE) to the UE 102 before the event 306. In some implementations, the DU 174 transmits 330 the first LTM command in response to the L1 measurement report(s) 324 for the first cell. To configure the UE 102 to transmit the L1 or LTM-type measurement report(s) 324, the CU 172 can transmit a second RRC reconfiguration message including the L1 or LTM-type measurement configuration(s) to the UE 102. In some implementations, the first and second RRC reconfiguration messages can be the same message (i.e., the same instance). In other implementations, the first and second RRC reconfiguration messages are different messages. In some implementations, the second RRC reconfiguration message is the RRC reconfiguration message of the event 316. In other implementations, the second RRC reconfiguration message is different from the RRC reconfiguration message of the event 316.

After (e.g., in response to) receiving the first LTM command, the UE 102 identifies the LTM DU configuration 1 in accordance with the ID 1 and applies the LTM DU configuration 1. In some implementations, the UE 102 can perform 332 a random access procedure on the first cell with the DU 174 in response to applying the LTM DU configuration 1 or receiving the first LTM command. In some implementations, the UE 102 disconnects from the cell 124A after (e.g., in response to) receiving the first LTM command or after transmitting the acknowledgement. In other words, the UE 102 stops communicating on the cell 124A after (e.g., in response to) receiving 330 the first LTM command or transmitting 331 the acknowledgement. In such cases, the UE 102 performs 332 the random access procedure after disconnecting from the cell 124A. The UE 102 can determine whether to perform the random access procedure in accordance with the LTM DU configuration 1. In one implementation, if the LTM DU configuration 1 configures the UE 102 to perform a random access procedure, the UE 102 performs the random access procedure in the event 332. For example, the LTM DU configuration 1 includes a reconfiguration with sync configuration (e.g., ReconfigurationWithSync IE) to configure the UE 102 to perform a random access procedure. Otherwise, if the LTM DU configuration 1 does not configure the UE 102 to perform a random access procedure or configures the UE 102 to skip a random access procedure, the UE 102 refrains from performing a random access procedure with the DU 174 upon receiving the first LTM command. In such a cases, the UE 102 skips the event 316. For example, if the LTM DU configuration 1 excludes a reconfiguration with sync configuration, the LTM DU configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In the case that the UE 102 performs 332 the random access procedure, the UE 102 communicates 336 with the DU 174 on the first cell using the LTM DU configuration 1 and/or reference LTM DU configuration and communicates with the CU 172 via the DU 174, after successfully completing the random access procedure. In such cases, the DU 174 communicates with the UE 102 on the first cell using the LTM DU configuration 1 in the event 332 and/or event 336. In some scenarios or implementations, the UE 102 communicates UL PDUs, DL PDUs, and/or physical layer signals (e.g., PUCCH transmissions and PDCCH transmissions) with the base station 104 in the event 336. In some implementations, the UE 102 determines that the UE 102 successfully completes the random access procedure when the UE 102 receives a contention resolution from the DU 174. In cases where the random access procedure is a four-step random access procedure, the UE 102 transmits a Message 3 including a UE identity to the DU 174 via the first cell in the random access procedure. In cases where the random access procedure is a two-step random access procedure, the UE 102 transmits a Message A including the UE identity to the DU 174 via the first cell in the random access procedure. In some implementations, if the LTM DU configuration 1 includes a second C-RNTI, the UE identity is the second C-RNTI of the UE 102. Otherwise, if the LTM DU configuration 1 does not include a C-RNTI, the UE identity is the first C-RNTI. In cases where the random access procedure is a contention free random access procedure, the UE 102 transmits the dedicated random access preamble to the DU 174 via the first cell. In such cases, the LTM DU configuration 1 includes the dedicated random access preamble.

The DU 174 identifies or determines that the UE 102 connects to the first cell upon receiving the UE identity or the dedicated preamble from the UE 102 in the random access procedure 332.

In the case that the UE 102 skips the random access procedure, the UE 102 directly communicates 336 with the DU 174 on the first cell in accordance with the LTM DU configuration 1 and communicates with the CU 172 via the DU 174, after (e.g., in response to) receiving the first LTM command. For example, the UE 102 directly communicates UL PDUs, DL PDUs, and/or physical layer signals (e.g., PUCCH transmissions and PDCCH transmissions) with the base station 104 in the event 336. In some implementations, the DU 174 can include, in the LTM DU configuration 1, configuration parameters configuring resources for the UE 102 to transmit the at least one PUCCH or PUSCH transmission, and the UE 102 transmits the at least one PUCCH or PUSCH transmission on the resources, using the configuration parameters, to indicate that the UE 102 connects to the first cell. In other implementations, the DU 174 can transmit to the UE 102 at least one DCI on a PDCCH on the first cell to command the UE 102 to transmit the at least one PUCCH or PUSCH transmission, after transmitting the first LTM command. The at least one DCI configures resources for the UE 102 to transmit the at least one PUCCH or PUSCH transmission, and the UE 102 transmits the at least one PUCCH or PUSCH transmission on the resources. The DU 174 identifies or determines that the UE 102 connects to the first cell upon receiving the PUCCH or PUSCH transmission. The DU 174 identifies or determines that the UE 102 connects to the first cell upon receiving the PUCCH or PUSCH transmission on the resources configured in the LTM DU configuration 1 or the at least one DCI.

In the case that the UE 102 receives the reference LTM DU configuration as described above, the UE 102 communicates 336 with and the DU 174 on the first cell in accordance with the LTM DU configuration 1 and at least a portion of the reference LTM DU configuration. In other words, the UE 102 communicates 336 with the DU 174 in accordance with configuration parameters in the LTM DU configuration 1 and the reference LTM DU configuration. Similarly, the DU 174 communicates 336 with the UE 102 on the first cell in accordance with the LTM DU configuration 1 and at least a portion of the reference LTM DU configuration. In other words, the DU 174 communicates 336 with the UE 102 in accordance with configuration parameters in the LTM DU configuration 1 and the reference LTM DU configuration.

In the case that the UE 102 receives neither the LTM CU configuration 1 nor a/the reference LTM CU configuration, the UE 102 communicates 336 with the CU 172 via the DU 174 using the serving CU configuration. Correspondingly, if the CU 172 neither transmits the LTM CU configuration 1 nor a/the reference CU configuration to the UE 102, the CU 172 communicates 336 with the UE 102 via the DU 174 using the serving CU configuration. In the case that the UE 102 receives the LTM CU configuration 1 and the reference LTM CU configuration from the CU 172, the UE 102 communicates 336 with the CU 172 via the DU 174 using the LTM CU configuration 1 and (at least a portion of) the reference LTM CU configuration not augmented by the LTM CU configuration 1. In this case, the CU 172 communicates 336 with the UE 102 via the DU 174 using the LTM CU configuration 1 and (at least a portion of) the reference LTM CU configuration not augmented by the LTM CU configuration 1.

In the case that the UE 102 receives the LTM CU configuration 1 and does not receive the reference LTM CU configuration from the CU 172, the UE 102 communicates 336 with the CU 172 via the DU 174 using the LTM CU configuration 1. In this case, the CU 172 communicates 336 with the UE 102 via the DU 174 using the LTM CU configuration 1. If the LTM CU configuration 1 is a full configuration, the UE 102 and CU 172 communicates 336 with each other via the DU 174 using the LTM CU configuration 1 instead of the serving CU configuration. In some implementations, if the UE 102 does not receive a/the reference LTM CU configuration from the base station 104, the UE 102 determines that the LTM CU configuration 1 is a full configuration. Correspondingly, if the CU 172 determines to configure or configures the LTM CU configuration 1 as a full configuration, the CU 172 does not transmit a/the reference LTM CU configuration to the UE 102. In other implementations, the CU 172 includes a first indication (e.g., a field or IE) in the LTM CU configuration 1, the first container, the element 1 or the RRC reconfiguration message 316 to indicate that the LTM CU configuration 1 is a full configuration. If the LTM CU configuration 1 is a delta configuration to augment the serving CU configuration, the UE 102 and CU 172 communicates 336 with each other via the DU 174 using the LTM CU configuration 1 and at least a portion of the serving CU configuration not augmented by the LTM CU configuration 1. In some implementations, if the UE 102 does not receive a/the reference LTM CU configuration from the base station 104, the UE 102 determines that the LTM CU configuration 1 is a delta configuration to augment the serving CU configuration. Correspondingly, if the CU 172 determines to configure or configures the LTM CU configuration 1 as a delta configuration to augment the serving CU configuration, the CU 172 does not transmit a/the reference LTM CU configuration to the UE 102. In some implementations, the CU 172 indicates that the LTM CU configuration 1 is a delta configuration to augment to the serving CU configuration, by excluding the first indication in the LTM CU configuration 1, the first container, the element 1 and/or the RRC reconfiguration message 316. Alternatively, the CU 172 includes a second indication (e.g., a field or IE) in the LTM CU configuration 1, the first container, the element 1 or the RRC reconfiguration message 316 to indicate that the LTM CU configuration 1 is a delta configuration to augment the serving CU configuration. In some implementations, the CU 172 indicates that the LTM CU configuration 1 is a full configuration, by excluding the second indication in the LTM CU configuration 1, the first container, the element 1 and/or the RRC reconfiguration message 316.

In the case that the UE 102 receives the reference LTM CU configuration and does not receive the LTM CU configuration 1 from the CU 172, the UE 102 communicates 336 with the CU 172 via the DU 174 using the reference LTM CU configuration. In this case, the CU 172 communicates 336 with the UE 102 via the DU 174 using the reference LTM CU configuration. If the reference LTM CU configuration is a full configuration, the UE 102 and CU 172 communicates 336 with each other via the DU 174 using the reference LTM CU configuration instead of the serving CU configuration. In some implementations, the UE 102 and CU 172 determine that the reference LTM CU configuration 1 is a full configuration as specified in a 3GPP specification (e.g., 3GPP specification 38.331 v 18.0.0 or later version). In other implementations, the CU 172 includes a first indication (e.g., a field or IE) in the reference LTM CU configuration, the first container or the RRC reconfiguration message 316 to indicate that the reference LTM CU configuration is a full configuration. If the reference LTM CU configuration is a delta configuration to augment the serving CU configuration, the UE 102 and CU 172 communicates 336 with each other via the DU 174 using the reference LTM CU configuration and at least a portion of the serving CU configuration not augmented by the reference LTM CU configuration. In some implementations, the CU 172 indicates that the reference LTM CU configuration is a delta configuration to augment to the serving CU configuration, by excluding the first indication in the reference LTM CU configuration, the first container, the element 1 and/or the RRC reconfiguration message 316. Alternatively, the CU 172 includes a second indication (e.g., a field or IE) in the reference LTM CU configuration, the first container, the element 1 or the RRC reconfiguration message 316 to indicate that the reference LTM CU configuration is a delta configuration to augment the serving CU configuration. In some implementations, the CU 172 indicates that the reference LTM CU configuration is a full configuration, by excluding the second indication in the reference LTM CU configuration, the first container, the element 1 and/or the RRC reconfiguration message 316.

In the case that the UE 102 neither receives the reference LTM CU configuration and nor the LTM CU configuration 1 from the CU 172, the UE 102 communicates 336 with the CU 172 via the DU 174 using the serving LTM CU configuration. In this case, the CU 172 communicates 336 with the UE 102 via the DU 174 using the serving LTM CU configuration.

In some implementations, the UE 102 transmits a RRC message (e.g., RRC reconfiguration complete message) to the CU 172 via the DU 174 and the first cell to indicate that the UE 102 applies the LTM DU configuration 1. In the case that the UE 102 performs the random access procedure 332, the UE 102 can include the RRC message in the Message 3 or Message A. Alternatively, the UE 102 transmits the RRC message after completing the random access procedure. In the case that the UE 102 skip the random access procedure 332, the UE 102 includes the RRC message in a PUSCH transmission of the at least one PUSCH transmission. In some implementations, if the UE 102 maintains communication on the cell 124A with the base station 104 (i.e., the UE 102 does not disconnect from the cell 124A), the UE 102 can transmit the RRC message to the base station 104 via the cell 124A. When the DU 174 receives the RRC message, the DU 174 transmits the RRC message to the CU 172.

In other implementations, the UE 102 refrains from transmitting the RRC message to the base station 104 in response to applying the LTM DU configuration 1 or receiving the first LTM command. In such cases, the UE 102 can include or transmit data in the Message 3, Message A or PUSCH transmission as described above. The UE 102 can generate a MAC PDU and/or a RLC PDU including the data and transmits or includes the MAC PDU and/or RLC PDU in the PUSCH transmission. For example, the data can be a PDCP PDU, a SDAP PDU, a LTE Positioning Protocol (LPP) PDU, a RRC PDU and/or a NAS PDU. The RRC PDU includes a UL-DCCH-Message excluding a RRC reconfiguration complete message. The NAS PDU includes a Mobility Management (MM) message or a Session Management (SM) message. The MM message can be a 5G MM message or a 6G MM message, and the SM message can be a 5G SM message or a 6G SM message. When the DU 174 receives the data, the DU 174 transmits the data to the CU 172.

When the DU 174 determines that the UE 102 successfully connects to the first cell in the event 332 or 336, the DU 174 can transmit 334 a DU-to-CU message (e.g., Access Success message) to the CU 172 (e.g., a CP of the CU 172). In some implementations, the DU 174 can include the cell ID 1 of the first cell in the DU-to-CU message of the event 334. The cell ID can be a PCI or a CGI. Thus, the CU 172 determines that the UE 102 connects to the first cell upon receiving the DU-to-CU message of the event 334. When the DU 174 determines that the UE 102 successfully connect to the first cell in the event 332 or 336, the DU 174 can transmit a DL Data Delivery Status message or frame to the CU 172 (e.g., a UP of the CU 172). In some implementations, when or after the CU 172 receives the DU-to-CU message 329, the CU 172 might stop or suspend transmitting DL data for the UE 102 to the DU 174 until receiving the DU-to-CU message 334. The CU 172 might do so because the DU 174 cannot buffer DL data for the UE 102 during the LTM execution in the events 330 and/or 332. After receiving the DU-to-CU message 334, the CU 172 continues or resumes transmitting DL data for the UE 102 to the DU 174. In other implementations, when the CU 172 receives the DU-to-CU message 329, the CU 172 might continue transmitting DL data for the UE 102 to the DU 174. The CU 172 might do so because the DU 174 can buffer DL data for the UE 102 during the LTM execution in the events 330 and/or 332. When or after the DU 174 detects that UE 102 accesses the cell 1, the DU 174 transmits the DL data to the UE 102 via the cell 1.

In some implementations, when determining that the UE 102 connects to the first cell, transmitting 330 the first LTM command, or receiving 331 the acknowledgement, the DU 174 can stop communicating with the UE 102 on the cell 124A and/or release resources of the cell 124A configured for the UE 102.

In some implementations, the DU 174 can generate some or all of the LTM DU configuration 1 and/or LTM DU configuration(s) 2, . . . , N as full configuration(s) to replace the serving DU configuration. If the LTM DU configuration 1 is a full configuration, the UE 102 and DU 174 communicate 336 with each other in accordance with the LTM DU configuration 1 instead of the serving DU configuration. In some implementations, the DU 174 includes an indication indicating that the LTM DU configuration 1 is a full configuration in the LTM DU configuration 1. In each of the LTM DU configuration(s) 2, . . . , N, the DU 174 can include an indication to indicate that the corresponding DU configuration is a full configuration. Each of the indication(s) in the LTM DU configuration(s) 1, . . . , N can be a field or IE (i.e., the same field or IE). In other implementations, the CU 172 can include, in the RRC reconfiguration message of the events 316, 318, a single indication indicating that the LTM DU configuration(s) 1 and/or 2, . . . , N is/are full configuration(s). In the case of the second container, the CU 172 can include, in the additional RRC reconfiguration message, a single indication indicating that the LTM DU configuration(s) 2, . . . , N is/are full configuration(s). In yet other implementations, the CU 172 can include, in the first container, a single indication indicating that the LTM DU configuration(s) 1 and/or 2, . . . , N is/are full configuration(s). In yet other implementations, for each of the LTM DU configuration(s) 2, . . . , N, the CU 172 can include, in the first container, a particular indication indicating the corresponding LTM DU configuration is a full configuration. In the case of the second container, the CU 172 can include, in the second container, a single indication indicating that the LTM DU configuration(s) 2, . . . , N is/are full configuration(s). In yet other implementations, the CU 172 can include, in the element 1, includes an indication indicating that the LTM DU configuration 1 is a full configuration. In each of the element(s) 2, . . . , N, the CU 172 can include an indication indicating that the corresponding LTM DU configuration is a full configuration. The UE 102 can determine that the LTM DU configuration 1 and/or LTM DU configuration(s) 2, . . . , N is/are full configuration(s) based on the indication(s) above. In some implementations, each of the indication(s) above is different from a fullConfig field defined in the current 3GPP specification. In some implementations, each of the indication(s) above is a fullConfig field defined in the current 3GPP specification. In the case that the LTM DU configuration 1 is a full configuration, the UE 102 in the event 336 does not apply the reference LTM DU configuration if received from the base station 104, e.g., in the RRC reconfiguration message 318. In such cases, the DU 174 might not include a/the reference LTM DU configuration in the first DU-to-CU message 310.

In other implementations, the DU 174 can generate the LTM DU configuration 1 and/or LTM DU configuration(s) 2, . . . , N as delta configuration(s) that augment (a portion of) the reference LTM DU configuration. In other words, the DU 174 generates the LTM DU configuration(s) 1, . . . N based on the reference LTM DU configuration. For example, if the LTM DU configuration 1 is a delta configuration, the UE 102 and DU 174 augment (the portion of) the reference LTM DU configuration with the LTM DU configuration 1. Thus, the UE 102 and DU 174 communicate 336 with each other in accordance with the LTM DU configuration 1 and unaugment portion of the reference LTM DU configuration. In some implementations, the LTM DU configuration(s) 1, and/or 2 . . . , N, first container, second container or element(s) 1, . . . , N exclude indication(s) indicating that the LTM DU configuration(s) 1, and/or 2 . . . , N is/are full configuration(s) to indicate that the LTM DU configuration(s) 1 and/or 2, . . . , N is/are delta configuration(s). The UE 102 can determine that each of the LTM DU configuration(s) 1 and/or 2, . . . , N is a delta configuration based on that the indication is excluded in the LTM DU configuration(s) 1 and/or 2, . . . , N, first container, second container or element(s) 1 and/or 2, . . . , N.

In some implementations, if the UE 102 does not receive a reference LTM DU configuration for the LTM DU configuration 1 and/or the LTM DU configuration(s) 2, . . . , N, the UE 102 determines that the LTM DU configuration 1, and/or the LTM DU configuration(s) 2, . . . , N are full configuration(s). Correspondingly, if the DU 174 does not obtain a reference LTM DU configuration for the UE 102 (i.e., the DU 174 does not generate a reference LTM DU configuration for the UE 102 and/or receive a reference LTM DU configuration for the UE 102 from the CU 172), the DU 174 generates the LTM DU configuration 1, and/or the LTM DU configuration(s) 2, . . . , N as full configuration(s).

In other implementations, if the UE 102 does not receive a reference LTM DU configuration for the LTM DU configuration 1 and/or the LTM DU configuration(s) 2, . . . , N, the UE 102 determines that the LTM DU configuration 1, and/or the LTM DU configuration(s) 2, . . . , N are delta configuration(s) to augment the serving DU configuration. In such cases, the UE 102 communicates 336 with the DU 174 in accordance with the LTM DU configuration 1 and at least a portion of the serving DU configuration not augmented by LTM DU configuration 1. Correspondingly, if the DU 174 does not obtain a reference LTM DU configuration for the UE 102 (i.e., the DU 174 does not generate a reference LTM DU configuration for the UE 102 and/or receive a reference LTM DU configuration for the UE 102 from the CU 172), the DU 174 generates the LTM DU configuration 1, and/or the LTM DU configuration(s) 2, . . . , N as delta configuration(s) to augment the serving DU configuration. In such cases, the DU 174 communicates 336 with the UE 102 in accordance with the LTM DU configuration 1 and the at least a portion of the serving DU configuration.

In some implementations, the UE 102 uses a UE MAC entity (e.g., MAC 204B) to communicate with a DU MAC entity (e.g., MAC 204B) of the DU 174 (e.g., the events 302, 304, 318, 320, 324, 330 and/or 331). In some implementations, the UE 102 resets the UE MAC entity, after or in response to receiving the first LTM command and before performing the random access procedure or communicating 336 with the DU 174 via the first cell.

In some implementations, the DU 174 resets the DU MAC entity after (e.g., in response to) transmitting the first LTM command, receiving the acknowledgement 331 or determining that the UE 102 connects to the first cell.

In some implementations, when the UE 102 resets the UE MAC entity, the UE 102 performs at least one of the following actions for the UE MAC entity (i.e., UE MAC reset or full UE MAC reset):
initialize Bj for configured logical channel(s) to zero;
stop one or more timers;
timeAlignmentTimer(s) as expired, if the UE 102 is configured to perform the random access procedure (e.g., the event 332) in the configuration (e.g., the configuration 1);
SET NEW DATA INDICATOR(s) (NDI(s)) for UL HARQ process(es) to value 0;
set NDI(s) for HARQ process ID(s) to value 0 for monitoring PDCCH in Sidelink resource allocation mode 1;
flush Msg3 buffer;
flush MSGA Buffer;
cancel, if any, triggered Scheduling Request procedure;
cancel, if any, triggered Buffer Status Reporting procedure;
cancel, if any, triggered Power Headroom Reporting procedure;
cancel, if any, triggered consistent LBT failure;
cancel, if any, triggered BFR;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;
flush soft buffers for DL HARQ process(es);
for each of the DL HARQ process(es), consider the next received transmission for a TB as the very first transmission;
release, if any, Temporary C-RNTI;
reset one or more counters (e.g., BFI_COUNTERs and/or LBT_COUNTERs).

In some implementations, when the DU 174 resets the DU MAC entity, the DU 174 performs at least one of the following actions for the DU MAC entity (i.e., DU MAC reset or full DU MAC reset):
stop one or more timers;
consider timeAlignmentTimer(s), that the DU 174 starts and/or maintains for the UE 102, as expired, if the UE 102 is configured to perform the random access procedure (e.g., the event 332) in the configuration (e.g., the configuration 1);
Set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERS and/or LBT_COUNTERS)

Depending on implementations, the UE 102 can determine to partially or fully reset the UE MAC entity. In some implementations, when the UE 102 resets the UE MAC entity as described above, the UE 102 fully resets the UE MAC entity (i.e., a full UE MAC reset).

In the full UE MAC reset, the UE 102 performs some or all of the actions described above.

In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions:
consider timeAlignmentTimer(s) of the UE 102 as expired, if the UE 102 is configured to perform the random access procedure (e.g., the event 332) in the configuration (e.g., the configuration 1);
flush Msg3 buffer;
flush MSGA buffer;
release, if any, Temporary C-RNTI;
reset one or more counters (e.g., BFI_COUNTERs and/or LBT_COUNTERs).

In some implementations, the partial UE MAC reset further includes at least one of the following actions:
cancel, if any, triggered Scheduling Request procedure;
cancel, if any, triggered Buffer Status Reporting procedure;
cancel, if any, triggered Power Headroom Reporting procedure;
cancel, if any, triggered consistent LBT failure;
cancel, if any, triggered BFR;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;

In some implementations, the partial UE MAC reset further includes at least one of the following actions:
stop a first portion of the one or more timers and retain the rest of the one or more timers;
set new data indicator(s) (NDI(s)) for UL HARQ process(es) to value 0;
set NDI(s) for HARQ process ID(s) to value 0 for monitoring PDCCH in Sidelink resource allocation mode 1;
flush soft buffers for DL HARQ process(es);
for each of the DL HARQ process(es), consider the next received transmission for a TB as the very first transmission;

Depending on implementations, the DU 174 can determine to partially or fully reset the DU MAC entity. In some implementations, when the DU 174 resets the DU MAC entity as described above, the DU 174 fully resets the DU MAC entity (i.e., a full DU MAC reset). In the full DU MAC reset, the DU 174 performs some or all of the actions described above. In other implementations, when the DU 174 resets the DU MAC entity as described above, the DU 174 partially resets the DU MAC entity (i.e., a partial DU MAC reset). In the partial DU MAC reset, the DU 174 performs a subset or portion of the some or all of the actions in the full DU MAC reset.

In some implementations, the partial DU MAC reset includes at least one of the following actions in the partial MAC reset:
consider timeAlignmentTimer(s), that the DU 174 starts and/or maintains for the UE 102, as expired, if the UE 102 is configured to perform the random access procedure (e.g., the event 332) in the configuration (e.g., the configuration 1);
reset one or more counters (e.g., BFI_COUNTERs and/or LBT_COUNTERs)

In some implementations, when the partial DU MAC reset includes at least one of the following actions for the MAC entity (i.e., DU MAC reset):
stop a first portion of the one or more timers and retain the rest of the one or more timers;
set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERs And/or LBT_COUNTERs)

In other implementations, the UE 102 refrains from resetting the UE MAC entity in response to receiving the first LTM command. Similarly, the DU 174 refrains from resetting the DU MAC entity after (e.g., in response to) transmitting the first LTM command, receiving the acknowledgement 331 or determining that the UE 102 connects to the first cell. In other words, the UE 102 communicates with the DU 174 on the first cell using the UE MAC entity (not reset). Similarly, the DU 174 communicates with the UE 102 using the DU MAC entity (not reset) on the first cell during or after the random access procedure 332 or after determining that the UE 102 connects to the first cell.

In some implementations, the UE 102 uses at least one UE RLC entity (e.g., RLC 206B) to communicate RLC PDUs with at least one DU RLC entity (e.g., RLC 206B) of the DU 174 (e.g., the events 302, 304, 318, 320, 324, 330 and/or 331). In some implementations, the UE 102 reestablishes some or all of the at least one UE RLC entity, after or in response to receiving the first LTM command and before performing 332 the random access procedure or communicating 336 with the DU 174 via the first cell. In some implementations, the DU 174 reestablishes some or all of the at least one DU RLC entity after (e.g., in response to) transmitting the first LTM command, receiving the acknowledgement 331 or determining that the UE 102 connects to the first cell.

In some implementations, the LTM DU configuration 1 may or may not include one or more RLC reestablishment indications (e.g., reestablishRLC field(s)) configuring the UE 102 to reestablish some or all of the at least one UE RLC entity. If the LTM DU configuration 1 includes the a RLC reestablishment indication configuring the UE 102 to reestablish a first UE RLC entity, of the at least one UE RLC entity, that the UE 102 uses to communicate RLC PDU(s) with the DU 174, the UE 102 reestablishes the first UE RLC entity in response to the RLC reestablishment indication and the first LTM command. In some implementations, the UE 102 can reestablish the first UE RLC entity before performing 332 the random access procedure or communicating 336 with the DU 174 via the first cell.

In other implementations, the UE 102 can reestablish the first UE RLC entity while or after performing 332 the random access procedure. Otherwise if the LTM DU configuration 1 does not include the RLC reestablishment indication, the UE 102 refrains from reestablishing the first UE RLC entity in response to the first LTM command.

In some implementations, when the UE 102 reestablishes the first UE RLC entity, the UE 102 performs at least one of the following actions for the first UE RLC entity:
Discard RLC SDU(s), RLC SDU Segment(s), and RLC PDU(s), if any;
stop and reset timer(s), if running;
reset state variables to initial values.

In some implementations, the state variables and timer(s) are defined in 3GPP specification 38.322.

Otherwise, if the LTM DU configuration 1 does not include the RLC reestablishment indication for the first UE RLC entity, the UE 102 refrains from reestablishing the first UE RLC entity upon or when receiving the first LTM command. In other words, the UE 102 refrains from preforming the actions for reestablishing the first UE RLC entity of the UE 102 upon or when receiving the first LTM command. In some implementations, if the LTM DU configuration 1 or element 1 does not include the RLC reestablishment indication and includes an indication indicating that the configuration 1 is a full configuration, the UE 102 can reestablish the first UE RLC entity of the UE 102 upon or when receiving the first LTM command. Otherwise, if the LTM DU configuration 1 or element 1 does not include the RLC reestablishment indication and the indication indicating that the configuration 1 is a full configuration, the UE 102 refrains from reestablishing the first UE RLC entity upon or when receiving the first LTM command.

Similarly, the DU 174 reestablishes some or all of at least one DU RLC entity (e.g., NR RLC 206B) that the DU 174 uses to communicate with the at least one UE RLC entity of the UE 102 (e.g., the events 302, 304, 318, 320, 324, 330 and/or 331) in response to the RLC reestablishment indication. In some implementations, the DU 174 reestablishes a first DU RLC entity of the at least one DU RLC entity after transmitting the first LTM command, receiving an acknowledgement for the first LTM command from the UE 102, or determining that the UE 102 connects to the first cell. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the first DU RLC entity, the DU 174 performs at least one of the following actions for the first DU RLC entity:
Discard RLC SDU(s), RLC SDU Segment(s), and RLC PDU(s), if any;
stop and reset timer(s), if running;
reset state variables to initial values.
   In some implementations, the state variables and timer(s) are defined in 3GPP specification 38.322.

In other implementations, the UE 102 refrains from reestablishing some or all of the at least one UE RLC entity in response to receiving the first LTM command. Similarly, the DU 174 refrains from reestablishing some or more of the at least one DU RLC entity after (e.g., in response to) transmitting the first LTM command, receiving the acknowledgement 331 or determining that the UE 102 connects to the first cell. In other words, the UE 102 communicates with the DU 174 on the first cell using the some or all of the at least one UE RLC entity (not reestablished). For example, the some or all of the at least one UE RLC entity includes the first UE RLC entity and/or a second UE RLC entity. Similarly, the DU 174 communicates with the UE 102 using the some or all of the at least one DU RLC entity (not reestablished) on the first cell during or after the random access procedure 332 or after determining that the UE 102 connects to the first cell. For example, the some or all of the at least one DU RLC entity includes the first DU RLC entity and/or a second DU RLC entity.

In some implementations, the UE 102 uses at least one UE PDCP entity (e.g., PDCP 210) to communicate UL PDCP PDUs and/or DL PDCP PDUs with at least one CU PDCP entity (e.g., PDCP 210) of the CU 172 in the event 302. In some implementations, the UE 102 performs a PDCP recovery procedure for some or all of the at least one UE PDCP entity, after or in response to receiving the first LTM command. For example, the UE 102 performs a PDCP recovery procedure for a first UE PDCP entity of the at least one UE PDCP entity, after or in response to receiving the first LTM command. In the PDCP recovery procedure, the UE 102 may or may not reestablish the first UE PDCP entity. After or in response to performing the PDCP recovery procedure, the UE 102 can retransmit at least a portion of the UL PDCP PDUs to the CU 172 via the DU 174 and the first cell in the event 336. Similarly, the CU 172 performs a PDCP recovery procedure for some or all of the at least one CU PDCP entity after or in response to transmitting the first LTM command. For example, the CU 172 performs a PDCP recovery procedure for a first CU PDCP entity of the at least one CU PDCP entity, after or in response to transmitting the first LTM command. In some implementations, the CU 172 performs the PDCP recovery procedure for the first CU PDCP entity in response to receiving the DU-to-CU message 329 or 334. In other implementations, the CU 172 performs the PDCP recovery procedure for the first CU PDCP entity in response to receiving the DL Data Delivery Status message. In the PDCP recovery procedure, the CU 172 may or may not reestablish the first CU PDCP entity. After or in response to performing the PDCP recovery procedure, the CU 172 can retransmit at least a portion of the DL PDCP PDUs to the UE 102 via the DU 174 and the first cell in the event 336.

In other implementations, the UE 102 refrains from reestablishing some or all of the at least one UE PDCP entity in response to receiving the first LTM command. For example, the some or all of the at least one UE PDCP entity includes the first UE PDCP entity and/or a second UE PDCP entity. Similarly, the CU 172 refrains from reestablishing some or more of the at least one CU PDCP entity, after (e.g., in response to) receiving the DU-to-CU message 329 or 340 or after (e.g., in response to) receiving the DL Data Delivery Status message. In other words, the UE 102 communicates with the CU 172 via the DU 174 and the first cell using the some or all of the at least one UE PDCP entity (not reestablished). For example, the some or all of the at least one UE PDCP entity includes the first UE PDCP entity and/or a second UE PDCP entity. Similarly, the CU 172 communicates with the UE 102 using the some or all of the at least one CU PDCP entity (not reestablished) via the DU 174 and the first cell. For example, the some or all of the at least one CU PDCP entity includes the first CU PDCP entity and/or a second CU PDCP entity.

In some implementations, after determining that the UE 102 connects to the first cell, the CU 172 can transmit 338 a CU-to-DU message (e.g., a UE Context Modification Request message) to the DU 174 to indicate the DU 174 to stop communicating with the UE 102 and/or to release or suspend resources, of the cell 124A, configured for the UE 102. In response, the DU 174 can stop communicating on the cell 124A with the UE 102 and/or release or suspend resources, of the cell 124A, configured for the UE 102, and transmit 340 a DU-to-CU message (e.g., a UE Context Modification Response message) to the CU-172. The events 338 (optional) and 340 (optional) are collectively referred to in FIG. 3 as a resource release procedure 396.

After or while communicating with the DU 174 on the first cell, events 344, 346, 348, 350, 351, 352, 354 and/or 356 might occur, similar to the events 324, 326, 328, 330, 331, 332, 334 and/or 336, respectively. The UE 102 transmits 344 at least one measurement report to the DU 174. The at least one measurement report includes at least one measurement result for a second cell (i.e., the cell 2). The at least one measurement result indicates that the second cell is suitable for communication with UE 102 and/or the first cell is not suitable for communication with the UE 102. After (e.g., in response to) receiving the at least one measurement report, the DU 174 determines to activate the LTM DU configuration 2 and generates a second LTM command to activate the LTM DU configuration 2 (i.e., the second LTM command commands the UE 102 to apply the LTM DU configuration 2). The DU 174 then transmits 350 the second LTM command to the UE on the first cell to the UE 102.

When or in response to determining to activate the LTM DU configuration 2 or transmit the second LTM command, the DU 174 might transmit 349 to the CU 172 a DU-to-CU message indicating LTM (being) executed. In some implementations, the DU 174 includes the cell ID 2 or the ID 2 (i.e., LTM ID) in the DU-to-CU message 349 to indicate that the DU 174 is to activate the LTM DU configuration 2. The DU can transmit the DU-to-CU message 349 to the CU 172 before or after transmitting the LTM command 350.

The descriptions for the events 324, 326, 328, 330, 331, 332, 334 and/or 336 can be applied to the events 344, 346, 348, 350, 351, 352, 354 and/or 356 with simple changes. For example, “cell 124A” , “first LTM command”, “first cell”, “ID 1 ”, “LTM DU configuration 1” and/or “LTM CU configuration 1” are replaced with “first cell”, “second LTM command” and “second cell”, “ID 2”, “LTM DU configuration 2” and/or “LTM CU configuration 2”, respectively.

The events 344, 346, 348, 350, 351, 352, 354 are collectively referred to in FIG. 3 as a LTM execution procedure 398. The events 304, 306, 390, 392, 394, 324, 326, 328, 329, 330, 331, 332, 334, 336, 396, 398, 356 are collectively referred to in FIG. 3 as a LTM DU configuration and/or activation procedure 380.

Referring next to FIG. 4, in a scenario 400, the base station 104 includes a CU 172, a source DU (S-DU) 174A and a target DU (T-DU) 174B. The S-DU 174A operates the cell 124A and optionally additional cell(s), while the T-DU 174B operates a first cell (e.g., cell 124C). The scenario 400 is similar to the scenario 300. Thus, the descriptions for the scenario 300 can generally apply to the scenario 400. The differences between the scenarios 300 and 400 are described below.

Initially, the UE 102 communicates 402 with the S-DU 174A on cell 124A using a serving DU configuration and communicates with the CU 172 via the S-DU 174A. During the communication 402, the UE 102 transmits 404, 406 at least one measurement report (e.g., L3 measurement report(s)) to the CU 172 via the S-DU 174A. Based on the at least one measurement report, the CU 172 determines to prepare cell(s) 1, . . . , N (operated by the T-DU 174B) for LTM for the UE 102, where N is a positive integer larger than 0 or 1. The cell(s) 1, . . . , N are identified by cell ID(s) 1, . . . , N, respectively. In response to the determination, the CU 172 performs 490 a LTM preparation procedure with the T-DU 174B to (request the T-DU 174B to) prepare cell(s) 1, . . . , N for LTM for the UE 102. N can be a positive integer larger than zero or 1. In the LTM preparation procedure 490, the CU 172 transmits a CU-to-DU message including the cell ID(s) 1, . . . , N to the T-DU 174B to request the T-DU 174B to prepare the cell(s) 1, . . . , N for LTM for the UE 102, similar to the event 308. In response, the T-DU 174B transmits a DU-to-DU message including the LTM DU configuration(s) 1, . . . , N to the CU 172, similar to the event 310. The LTM DU configuration(s) 1, . . . , N configures the cell(s) 1, . . . , N for LTM, respectively. In details, the LTM DU configuration(s) 1, . . . , N include configuration parameters for communication on the cell(s) 1, . . . , N, respectively. In some implementations, the CU-to-DU message and DU-to-CU message in the procedure 490 are UE Context Setup Request message and UE Context Setup Response message, respectively. The CU 172 then transmits the LTM DU configuration(s) 1, . . . , N in a RRC reconfiguration message in a LTM configuration delivery procedure 494, similar to the LTM configuration delivery procedure 394. In some implementations, the T-DU 174B can include cell index(es) 1, . . . , N in the LTM DU configuration(s) 1, . . . , N, respectively. In some implementations, the CU 172 can set the cell index(es) 1, . . . , N to different values and include the cell index(es) 1, . . . , N in the CU-to-DU message of the procedure 490.

After performing the LTM preparation procedure 490, the CU 172 might perform an additional LTM preparation procedure(s) with the T-DU 174B to prepare cell(s) N+1, . . . , N+M for LTM for the UE 102. M is a positive integer larger than zero. The CU 172 might determine to do so based on one or more measurement reports received from the UE 102 via the S-DU 174A, similar to the events 404, 406. In the additional LTM preparation procedure, the CU 172 transmits a CU-to-DU message including cell ID(s) N+1, . . . , N+M to the T-DU 174B to request the T-DU 174B to prepare the cell(s) N+1, . . . , N+M for LTM for the UE 102. The cell ID(s) N+1, . . . , N+M identifies the cell ID(s) N+1, . . . , N+M, respectively. In response to the CU-to-DU message, the T-DU 174B transmits a DU-to-DU message including the LTM DU configuration(s) N+1, . . . , N+M to the CU 172. The LTM DU configuration(s) N+1, . . . , N+M configures the cell(s) N+1, . . . , N+M for LTM, respectively. In details, the LTM DU configuration(s) N+1, . . . , N+M include configuration parameters for communication on the cell(s) N+1, . . . , N+M, respectively. The CU 172 then transmits the LTM DU configuration(s) N+1, . . . , N+M in a RRC reconfiguration message in an additional LTM configuration delivery procedure, similar to the LTM configuration delivery procedure 394 or 494.

In some implementations, the LTM preparation procedure 490 is a UE Context Setup procedure and the additional LTM preparation procedure is a UE Context Modification procedure.

In some implementations, the CU 172 and S-DU 174A might perform the procedure 380 with the UE 102, as described for FIG. 3. In the procedure 380, the CU 172 and S-DU 174A performs the procedure(s) 390 and/or 392 to prepare cell(s) of the S-DU 174A for LTM for the UE 102. Note, the value N in the procedure 380 or described for FIG. 3 can be the same as or different from the value N described for FIG. 4. In the procedure 390, the CU 172 might receive the first DU-to-CU message including the reference LTM DU configuration from the S-DU 174A in the event 310. In other implementations, the CU 172 and S-DU 174A does not perform the procedure 380 with the UE 102. In such cases, the CU 172 can perform 488 a reference LTM DU configuration query procedure with the S-DU 174A to obtain a reference LTM DU configuration. In the procedure 488, the CU 172 transmits 460 a CU-to-DU message to the S-DU 174A to request or query a reference LTM DU configuration. In some implementations, the CU 172 can include an indication in the CU-to-DU message to request or query a reference LTM DU configuration. In response to the indication or CU-to-DU message 460, the S-DU 174A transmits 462 a DU-to-CU message including a reference LTM DU configuration to the CU 172. In some implementations, the indication is a reference LTM DU configuration query indication. In other implementations, the indication is a LTM indication, and the CU 172 might include a query indication (e.g., GNB-DU Configuration Query IE) in the CU-to-DU message. After receiving the reference LTM DU configuration (i.e., either in the procedure 390 or in the procedure 488), the CU 172 includes the reference LTM DU configuration (received from the S-DU 174A) in the CU-to-DU message in the LTM preparation procedure 490. The T-DU 174B generates the LTM DU configuration(s) 1, . . . , N based on the reference LTM DU configuration received from the CU 172. In such cases, the T-DU 174B does not include a reference LTM DU configuration in the DU-to-CU message in the procedure 490. In the case of the additional LTM preparation procedure, the T-DU 174B does not include a reference LTM DU configuration in the DU-to-CU message in the additional LTM preparation procedure. The CU 172 might not include the reference LTM DU configuration in CU-to-DU message in the additional LTM preparation procedure with the T-DU 174B. In the case of the additional LTM preparation procedure, the T-DU 174B generates the LTM DU configuration(s) N+1, . . . , N+M based on the reference LTM DU configuration received from the CU 172.

In some implementations, the CU 172 does not provide a reference LTM DU configuration to the T-DU 174B in the LTM preparation procedure 490. In such cases, the T-DU 174B generates a reference LTM DU configuration and generates the LTM DU configuration(s) 1, . . . , N based on the reference LTM DU configuration. In such cases, the T-DU 174B includes the reference LTM DU configuration in the DU-to-CU message in the procedure 490. The CU 172 transmits the reference LTM DU configuration in the RRC reconfiguration message in the procedure 490. In the case of the additional LTM preparation procedure, the T-DU 174B generates the LTM DU configuration(s) N+1, . . . , N+M based on the reference LTM DU configuration. In this case, the T-DU 174B might not include the reference LTM DU configuration in the DU-to-CU message in the additional LTM preparation procedure. In some implementations, the reference LTM DU configuration generated by the T-DU 174B is different from the reference LTM DU configuration generated by the S-DU 174A. In other implementations, the reference LTM DU configuration generated by the T-DU 174B is the same as the reference LTM DU configuration generated by the S-DU 174A.

In some implementations, the CU 172 assigns ID(s) 1, . . . , N identifying the LTM DU configuration(s) 1, . . . , N (received from the T-DU 174B), respectively, and performs the procedure 492 with the T-DU 174B to provide the ID(s) 1, . . . , N and/or cell ID(s) 1, . . . , N to the T-DU 174B, similar to the procedure 392. Thus, the T-DU 174B associates the ID(s) 1, . . . , N with the LTM DU configuration(s) 1, . . . , N and/or the cell ID(s) 1, . . . , N, respectively. In other implementations, the T-DU 174B assigns ID(s) 1, . . . , N identifying the LTM DU configuration(s) 1, . . . , N (generated by the T-DU 174B), respectively and includes the ID(s) 1, . . . , N in the DU-to-CU message of the procedure 490, similar to the event 310. In some implementations, the CU 172 assigns ID(s) N+1, . . . , N+M identifying the LTM DU configuration(s) N+1, . . . , N+M, respectively, and performs a procedure (similar to the procedure 492) with the T-DU 174B to provide the ID(s) N+1, . . . , N+M and/or cell ID(s) N+1, . . . , N+M to the T-DU 174B, similar to the procedure 392. Thus, the T-DU 174B associates the ID(s) N+1, . . . , N+M with the LTM DU configuration(s) N+1, . . . , N+M and/or the cell ID(s) N+1, . . . , N+M, respectively. In other implementations, the T-DU 174B assigns ID(s) N+1, . . . , N+M identifying the LTM DU configuration(s) N+1, . . . , N+M, respectively and includes the ID(s) 1, . . . , N in the DU-to-CU message of the additional LTM preparation procedure, similar to the event 310.

In some implementations, the CU 172 transmits 412 a CU-to-DU message including the ID(s) 1, . . . , N to the S-DU 174A and receives 414 a DU-to-CU message from the S-DU 174A in response. The CU-to-DU message 412 and DU-to-CU message 414 are collectively referred to in FIG. 4 as a LTM ID transfer procedure 493 or a LTM cell index transfer procedure 493. In some implementations, the message 412 and message 414 can be UE Context Modification Request message and UE Context Modification Response message, respectively. In some implementations, the CU 172 includes the LTM DU configuration(s) 1, . . . , N and/or cell ID(s) 1, . . . , N in the CU-to-DU message 412. In one implementation, the CU 172 includes the ID(s) 1, . . . , N in the CU-to-DU message 412. In another implementation, the CU 172 includes the cell index(es) 1, . . . , N in the CU-to-DU message 412. In some alternative implementations, the CU 172 can perform multiple LTM ID transfer procedures to transmit the ID(s) 1, . . . , N, cell ID(s) 1, . . . , N and/or LTM DU configuration(s) 1, . . . , N to the S-DU 174A. In each of the procedures, the CU 172 includes particular portion of the ID(s) 1, . . . , N, cell ID(s) 1, . . . , N and/or LTM DU configuration(s) 1, . . . , N in a CU-to-DU message similar to the message 412. Thus, the S-DU 174A associates the ID(s) 1, . . . , N with the LTM DU configuration(s) 1, . . . , N and/or the cell ID(s) 1, . . . , N, respectively. In other alternative implementations, the CU 172 can perform multiple LTM cell index transfer procedures to transmit the cell index(es) 1, . . . , N, cell ID(s) 1, . . . , N and/or LTM DU configuration(s) 1, . . . , N to the S-DU 174A. In each of the procedures, the CU 172 includes particular portion of the cell index(es) 1, . . . , N, cell ID(s) 1, . . . , N and/or LTM DU configuration(s) 1, . . . , N in a CU-to-DU message similar to the message 412. Thus, the S-DU 174A associates the cell index(es) 1, . . . , N with the LTM DU configuration(s) 1, . . . , N and/or the cell ID(s) 1, . . . , N, respectively.

In some implementations, the CU 172 transmits a CU-to-DU message including the ID(s) N+1, . . . , N+M to the S-DU 174A and receives a DU-to-CU message from the S-DU 174A in response, similar to the CU-to-DU message 412 and the DU-to-CU message 414, respectively. In some implementations, the CU 172 includes the LTM DU configuration(s) N+1, . . . , N+M and/or cell ID(s) N+1, . . . , N+M in the CU-to-DU message. In some alternative implementations, the CU 172 can perform multiple LTM ID transfer procedures to transmit the ID(s) N+1, . . . , N+M, cell ID(s) N+1, . . . , N+M and/or LTM DU configuration(s) N+1, . . . , N+M to the S-DU 174A. In each of the procedures, the CU 172 includes particular portion of the ID(s) N+1, . . . , N+M, cell ID(s) N+1, . . . , N+M and/or LTM DU configuration(s) 1, . . . , N in a CU-to-DU message similar to the message 412. Thus, the S-DU 174A associates the ID(s) N+1, . . . , N+M with the LTM DU configuration(s) N+1, . . . , N+M and/or the cell ID(s) N+1, . . . , N+M, respectively.

In some implementations, in the case that the CU 172 and S-DU 174A perform the procedure 380 with the UE 102, value(s) of the ID(s) 1, . . . , N of the procedure 380 are different from value(s) of the ID(s) 1, . . . , N, and the ID(s) N+1, . . . , N+M described for the scenario 400. In some implementations, in the case that the CU 172 and S-DU 174A perform the procedure 380 with the UE 102, value(s) of the cell ID(s) 1, . . . , N of the procedure 380 are different from value(s) of the cell ID(s) 1, . . . , N, and the cell ID(s) N+1, . . . , N+M described for the scenario 400. In some implementations, in the case that the CU 172 and S-DU 174A perform the procedure 380 with the UE 102, value(s) of the cell index(es) 1, . . . , N of the procedure 380 are different from value(s) of the cell index(es) 1, . . . , N, and the cell index(es) N+1, . . . , N+M described for the scenario 400.

At a later time, the UE 102 might transmit 424 at least one measurement report to the S-DU 174A, similar to the event 324. The at least one measurement report (e.g., L1 measurement report(s)) includes an event ID, first measurement result(s) for the cell 1 of the T-DU 174B, and/or includes second measurement result(s) for the cell 124A. In some implementations, the first measurement result(s) can be or include RSRP, RSRQ and/or SINR that the UE 102 obtains from reference signal(s) transmitted on the cell 1. Likewise, the second measurement result(s) can be or include RSRP, RSRQ and/or SINR that the UE 102 obtains from reference signal(s) transmitted on the cell 124A. In some implementations, the event ID, RSRP, RSRQ and/or SINR are L1-event ID, L1-RSRP, L1-RSRQ and/or L1-SINR, respectively. Based on the first measurement result(s) and/or second measurement result(s), the S-DU 174A might transmit 430 a first LTM command (i.e., LTM command 1) including the ID 1 to the UE 102 to order the UE 102 to perform a serving cell change to the cell 1 of the T-DU 174B. In some implementations, the first LTM command includes the ID 1. In other implementations, the first LTM command includes the cell index 1. When the UE 102 receives the first LTM command, the UE 102 performs a serving cell change to the cell 1 from a serving cell in accordance with the LTM DU configuration 1. After (e.g., in response to) receiving the first LTM command, the UE 102 might or might not perform 432 a random access procedure with the T-DU 174B, similar to the event 332. After (e.g., in response to) receiving the first LTM command or completing the random access procedure 432, the UE 102 might communicates 436 with the T-DU 174B on the first cell using the LTM DU configuration 1 and/or reference LTM DU configuration and communicates with the CU 172 via the T-DU 174B, similar to the event 336. If a serving cell change occurs in the procedure 380, the serving cell can be the cell 1 or cell 2 of the S-DU 174A. Otherwise, if no serving cell change occurs in the procedure 380 or the procedure 380 is not performed, the serving cell is the cell 124A. If the first LTM command includes the ID 1, the UE 102 identifies the LTM DU configuration 1 and/or cell ID 1 (i.e., the cell 1), based the ID 1, as described for FIG. 3. If the first LTM command includes the cell index 1, the UE 102 identifies the LTM DU configuration 1, cell ID 1 (i.e., the cell 1) and/or LTM ID 1, based the cell index 1, as described for FIG. 3. The UE 102 applies the LTM DU configuration 1 to communicate with the T-DU 174B, after (e.g., in response to) receiving the first LTM command or successfully accessing the cell 1.

When or in response to determining to activate the LTM DU configuration 1 or transmit the first LTM command 430, the S-DU 174A might transmit 429 to the CU 172 a DU-to-CU message indicating LTM (being) executed. In some implementations, the S-DU 174A includes the cell ID 1 or the ID 1 (i.e., LTM ID) in the DU-to-CU message 429 to indicate that the S-DU 174A is to activate the LTM DU configuration 1 or trigger a fast serving cell change. The S-DU 174A can transmit the DU-to-CU message 429 to the CU 172 before or after transmitting the LTM command 430. In some implementations, when or after the CU 172 receives the DU-to-CU message 429, the CU 172 might stop or suspend transmitting DL data for the UE 102 to the S-DU 174A until receiving the DU-to-CU message 434. After receiving the DU-to-CU message 434, the CU 172 starts, continues or resumes transmitting DL data for the UE 102 to the T-DU 174B. When or after the T-DU 174B detects that UE 102 accesses the cell 1, the T-DU 174B transmits the DL data to the UE 102 via the cell 1.

The resource release procedure 496 can be similar to the procedure 396. Alternatively, in the resource release procedure 496, the CU 172 can transmit a CU-to-DU message (e.g., a UE Context Release Command message) to the S-DU 174A to release a UE context of the UE 102. In response, the S-DU 174A releases a UE context of the UE 102 and transmits 440 a DU-to-CU message (e.g., a UE Context Release Complete message) to the CU-172.

The events 380, 404, 406, 490, 492, 494, 494, 424, 426, 428, 429, 430, 431, 432, 434, 436, 496, 498, 456 are collectively referred to in FIG. 4 as a LTM configuration and/or activation procedure 480.

Referring next to FIG. 5A, in a scenario 500A, the base station 106 operates as an MN, and the base station 104 operates as an SN. The SN 104 includes a CU 172 and a DU 174. The scenario 500A is similar to the scenario 300, except that the scenario 500A is a DC scenario and the scenario 300 is a single connectivity (SC) scenario. The MN 106 can include a CU and a DU similar to the base station 104 of FIG. 3.

Initially, the UE 102 in DC communicates with the MN 106 and with SN 104. In the event 502, the UE 102 communicates with the DU 174 on cell 124A using a serving DU configuration and communicates with the CU 172 via the DU 174 using a serving CU configuration, similar to the event 302. In some alternative implementations, the UE 102 does not communicate with the CU 172 via the DU 174 in the event 302. In some implementations, the UE 102 in DC can communicate 502 UL PDUs and/or DL PDUs with the MN 106 and/or SN 104 via radio bearers which can include SRBs and/or DRB(s). The MN 106 and/or the SN 104 can configure the radio bearers to the UE 102. The UE 102 in DC communicates 502 UL PDUs and/or DL PDUs with the SN 104 on an SCG (i.e., SCG radio resources) that the SN 104 configures for communication with the UE 102. The UE 102 in DC communicates UL PDUs and/or DL PDUs with the MN 106 on an MCG (i.e., MCG radio resources) in accordance with a MN configuration (i.e., MCG configuration). In some implementations, the serving DU configuration is a SN configuration (i.e., SCG configuration). In the MN configuration, the MN 106 configures the MCG which includes at least one serving cell (e.g., the cell 126 and/or other cell(s)) operated by the MN 106. In the serving DU configuration, the SN 106A configures the SCG which includes at least one serving cell (e.g., the cell 124A and/or other cell(s)) operated by the SN 104. In some implementations, the MN configuration includes multiple configuration parameters and the UE 102 receives the configuration parameters in one or more RRC messages from the MN 106. As described for FIG. 3, the serving DU configuration includes multiple configuration parameters. In some implementations, the UE 102 receives these configuration parameters in one or more RRC messages from the SN 104, e.g., via the MN 106 and/or on an SRB (e.g., SRB3) that the MN 106 or SN 104 configures to exchange RRC messages between the UE 102 and the SN 104.

While the UE 102 communicates in DC with the MN 106 and SN 104, the MN 106 can perform 580 a LTM DU configuration and/or activation procedure with the UE 102, similar to the procedures 380 and/or 480. In some implementations, while communicating in DC with the MN 106 and SN 104, the UE 102 can transmit the at least one measurement report to the CU 172 via the DU 174 and cell 124A in the events 504 and 506, similar to the events 304 and 306, respectively. In other implementations, while communicating in DC with the MN 106 and SN 104, the UE 102 can transmit 505 at least one measurement report to the MN 106 via the cell 126. The MN 106 in turn transmits 507 the at least one measurement report to the CU 172. In some implementations, the MN 106 generates at least one SN message including the at least one measurement report and transmits the at least one SN message to the CU 172 in the event 507. In one implementation, the at least one SN message include RRC Transfer message(s) and/or SN Modification Request message(s).

After (e.g., in response to) receiving the at least one measurement report or while the SN 104 communicates with the UE 102, the SN 104 determines to prepare the first cell for the UE 102, as described for FIG. 3. The events 590, 592, 594, 524, 526, 528, 529, 530, 531, 532, 534, 536, 596, 598, and 556 are similar to the events 390, 392, 394, 324, 326, 328, 329, 330, 331, 332, 334, 336, 396, 398, and 356, respectively. After receiving the first LTM command 530, transmitting the acknowledgement 531, or determining that the UE 102 successfully connects to the first cell 532 or 536, the UE 102 operating in DC with the MN 106 and SN 104 communicates 536 with the DU 174 on the first cell in accordance with the LTM DU configuration 1 and communicates 536 with the CU 172 via the DU 174, similar to the event 336. Later in time, the DU 174 and/or CU 172 can perform the LTM execution procedure 598 with the UE 102 to command the UE 102 to perform a cell change from the first cell to the second cell, similar to the procedure 398 or 498. As a result of the procedure 598, the UE 102 operating in DC with the MN 106 and SN 104 communicates 556 with the DU 174 on the second cell in accordance with the LTM DU configuration 2 and communicates 556 with the CU 172 via the DU 174, similar to the event 356.

The events 504, 506, 505, 507, 590, 592, 594, 524, 526, 528, 529, 530, 531, 532, 534, 536, 596, 598, 556 are collectively referred to in FIG. 5A as a LTM DU configuration and/or activation procedure 581.

Referring next to FIG. 5B, a scenario 500B is generally similar to the scenario 500A, except that the SN 104 transmits 517, 519 the RRC reconfiguration message to the UE 102 via the MN 106 and receives 521, 523 the RRC reconfiguration complete message from the UE 102 via the MN 106. The RRC reconfiguration message 517, 519 is similar to the RRC reconfiguration message 316, 318. The RRC reconfiguration complete message 521, 523 is similar to the RRC reconfiguration message 320, 322. In some implementations, the SN 104 generates a first SN message (e.g., SN Modification Required message, SN Modification Required message, or RRC Transfer message) including the RRC reconfiguration message and transmits the first SN message to the MN 106 in the event 517. The MN 106 generates a MN RRC message including the RRC reconfiguration message and transmits 519 the MN RRC message to the UE 102. In response, the UE 102 generates a MN RRC response message including the RRC reconfiguration complete message and transmits 521 the MN RRC response message to the MN 106. In some implementations, the MN 106 generates a second SN message (e.g., SN Reconfiguration Complete message or RRC Transfer message) including the RRC reconfiguration complete message and transmits the second SN message to the SN 104 in the event 523. In some implementations, the MN RRC message and MN RRC response message can be a RRC reconfiguration message and a RRC reconfiguration complete message, respectively.

The events 504, 506, 505, 507, 590, 592, 594, 517, 519, 521, 523, 524, 526, 528, 529, 530, 531, 532, 534, 536, 596, 598, 556 are collectively referred to in FIG. 5B as a LTM DU configuration and/or activation procedure 582.

Referring next to FIG. 6A, in a scenario 600A, the base station 106 operates as an MN, and the base station 104 operates as an SN, similar to the scenarios 300-500B. The SN 104 includes a CU 172, an S-DU 174A and a T-DU 174B, similar to the base station 104 in the scenario 400. While the UE 102 communicates in DC with the MN 106 and SN 104, the MN 106 can perform 680 a LTM DU configuration and/or activation procedure with the UE 102, similar to the procedures 380 and/or 480. While the UE 102 communicates in DC with the M-DU 174A and S-DU 174B, the CU 172 can perform 681 a LTM DU configuration and/or activation procedure with the UE 102 via the M-DU 174A or S-DU 174B, similar to the procedure 581 or 582.

Referring next to FIG. 6B, a scenario 600B similar to the scenarios 300-500B and 600A, except that that the SN 104 transmits 617, 619 the RRC reconfiguration message to the UE 102 via the MN 106 and receives 621, 623 the RRC reconfiguration complete message from the UE 102 via the MN 106.

Referring next to FIG. 7A, in a scenario 700A, the base station 104 operates as an MN and an SN, similar to the scenarios 300-600B. The base station 104 includes a CU 172, a master DU (M-DU) 174A and a secondary DU (S-DU) 174B. The CU 172 operates with the M-DU 174A as a MN, similar to the base station 104 in the FIG. 3 or the MN 106 in FIGS. 5A-6B, and the CU 172 operates with the S-DU 174B as a SN, similar to the SN 104 in FIGS. 5A-6B.

In the scenario 700A, the UE 102 initially communicates 702 in DC with the M-DU 174A and S-DU 174B and communicates 702 with the CU 172 via the M-DU 174A and S-DU 174B. In the event 702, the UE 102 communicates with the S-DU 174B on cell 124A using a serving DU configuration and communicates with the CU 172 via the S-DU 174B using a serving CU configuration, similar to the event 302. Events 704 and 706 are similar to the events 304 and 306. In some implementations, the UE 102 can transmit 705 at least one measurement report to the M-DU 174A, similar to the event 304. The M-DU 174A in turn transmits 707 at least one DU-to-CU message including the at les tone measurement report to the CU 172, similar to the event 306. While the UE 102 communicates in DC with the M-DU 174A and S-DU 174B, the CU 172 can perform 780 a LTM DU configuration and/or activation procedure with the UE 102 via the M-DU 174A, similar to the procedure 380.

The events 704, 706, 705, 707, 790, 792, 794, 724, 726, 728, 729, 730, 731, 732, 734, 736, 796, 798, 756 are collectively referred to in FIG. 7A as a LTM configuration and/or activation procedure 781.

Referring next to FIG. 7B, a scenario 700B similar to the scenarios 300-600B and 700A, except that that the CU 172 transmits 717, 719 the RRC reconfiguration message to the UE 102 via the M-DU 174A and receives 721, 723 the RRC reconfiguration complete message from the UE 102 via the M-DU 174A.

The events 704, 706, 705, 707, 790, 792, 794, 717, 719, 721, 723, 724, 726, 728, 729, 730, 731, 732, 734, 736, 796, 798, 756 are collectively referred to in FIG. 7B as a LTM DU configuration and/or activation procedure 782.

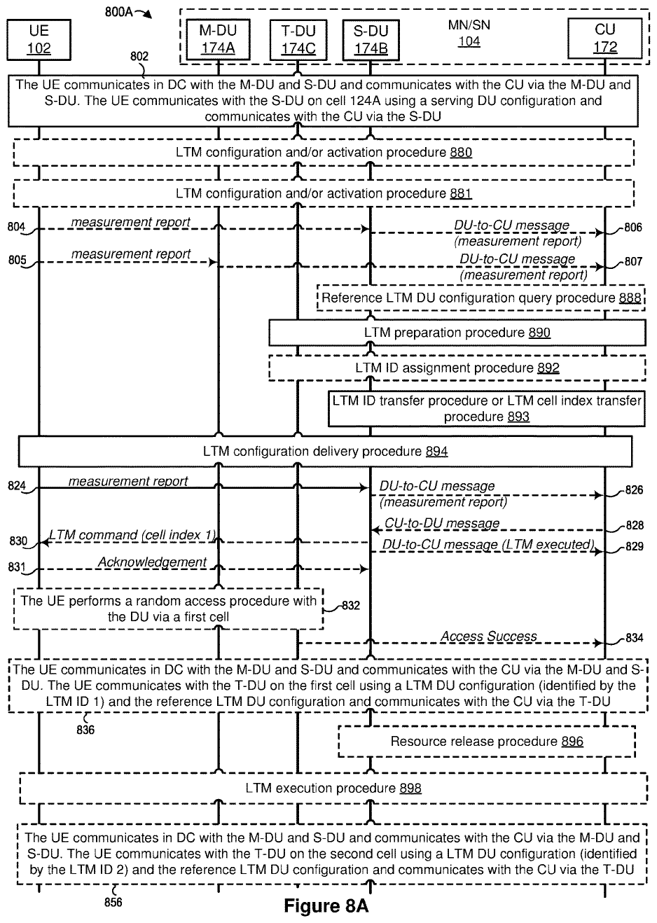

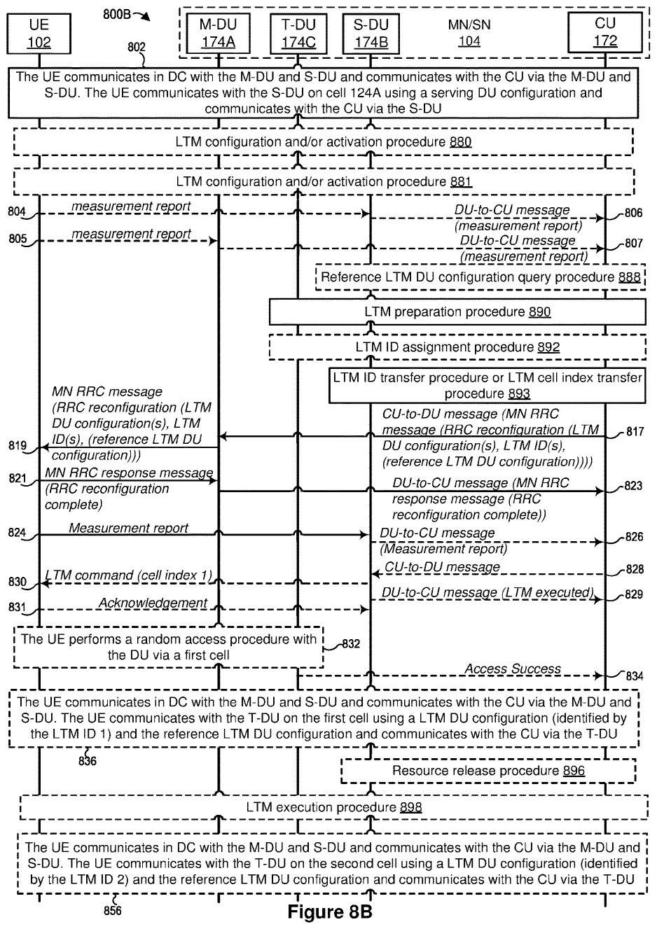

Referring next to FIG. 8A, in a scenario 800A, the base station 104 operates as an MN and an SN, similar to the scenarios 300-700B. The base station 104 includes a CU 172, a master DU (M-DU) 174A, a secondary DU (S-DU) 174B and a target secondary DU (T-DU) 174C. The CU 172 operates with the M-DU 174A as a MN and operates with the S-DU 174B as a SN. While the UE 102 communicates in DC with the M-DU 174A and S-DU 174B, the CU 172 can perform 880 a LTM DU configuration and/or activation procedure with the UE 102 via the M-DU 174A, similar to the procedure 380. While the UE 102 communicates in DC with the M-DU 174A and S-DU 174B, the CU 172 can perform 881 a LTM DU configuration and/or activation procedure with the UE 102 via the S-DU 174A, similar to the procedure 581 or 582.

Referring next to FIG. 8B, a scenario 800B similar to the scenarios 300-700B and 800A, except that that the CU 172 transmits 817, 819 the RRC reconfiguration message to the UE 102 via the M-DU 174A and receives 821, 823 the RRC reconfiguration complete message from the UE 102 via the M-DU 174A.

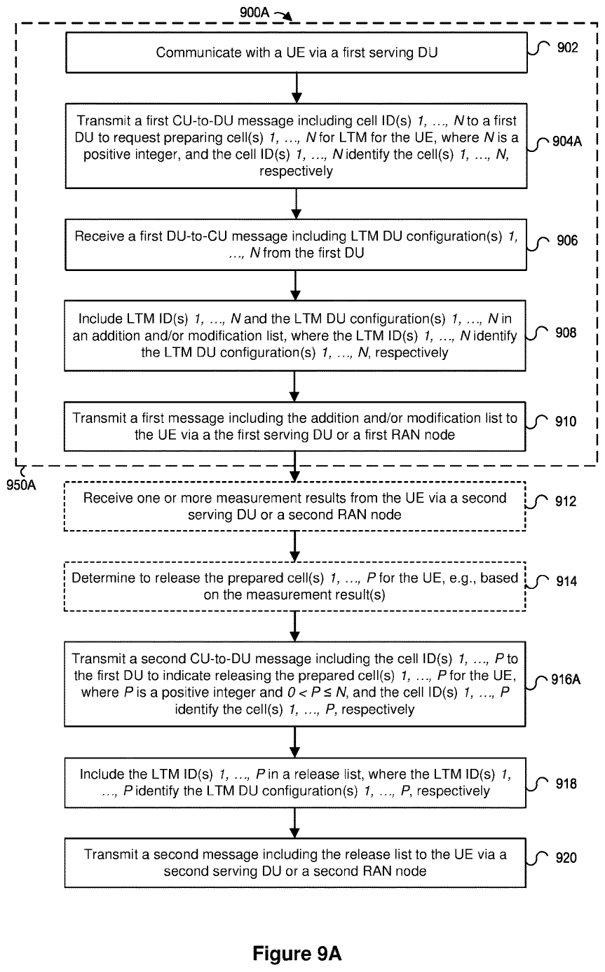

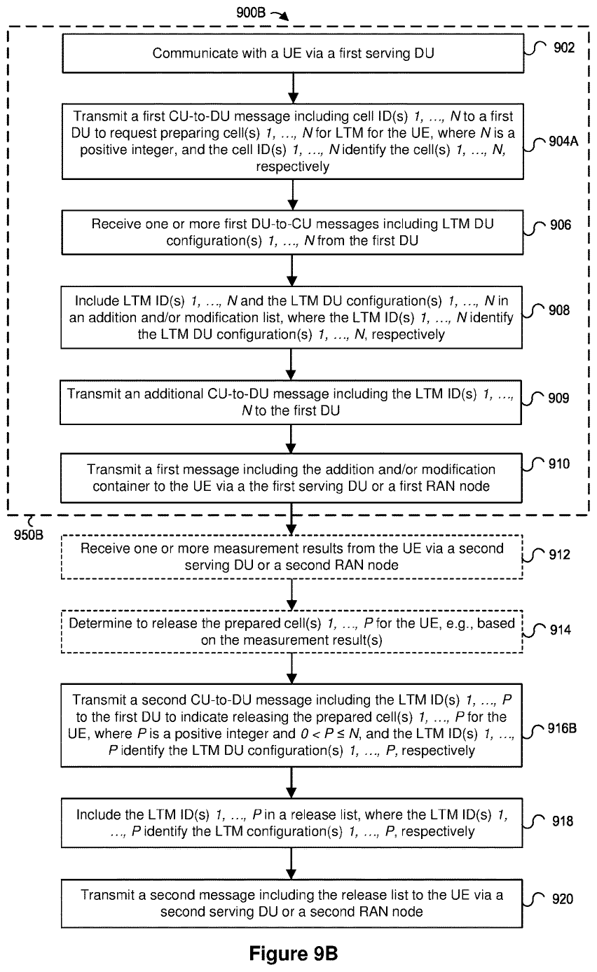

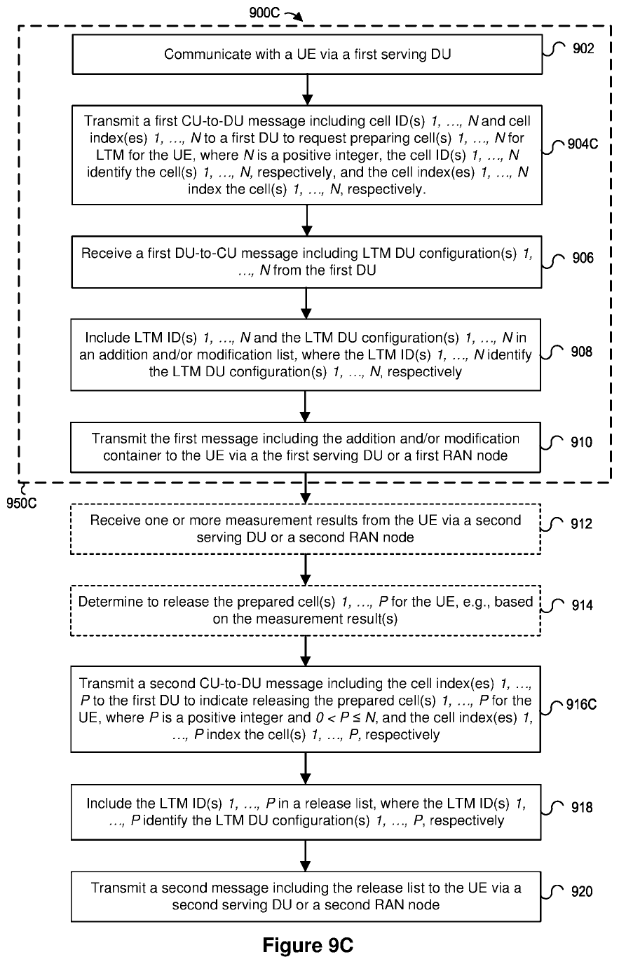

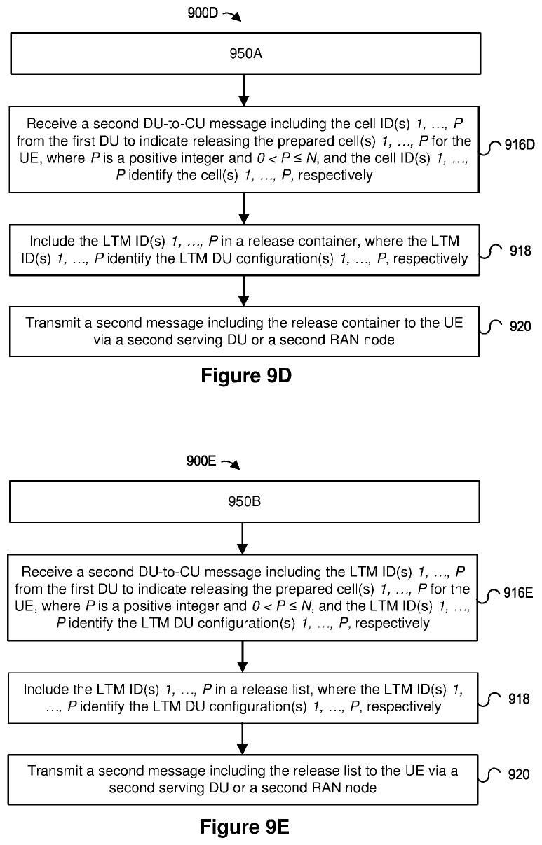

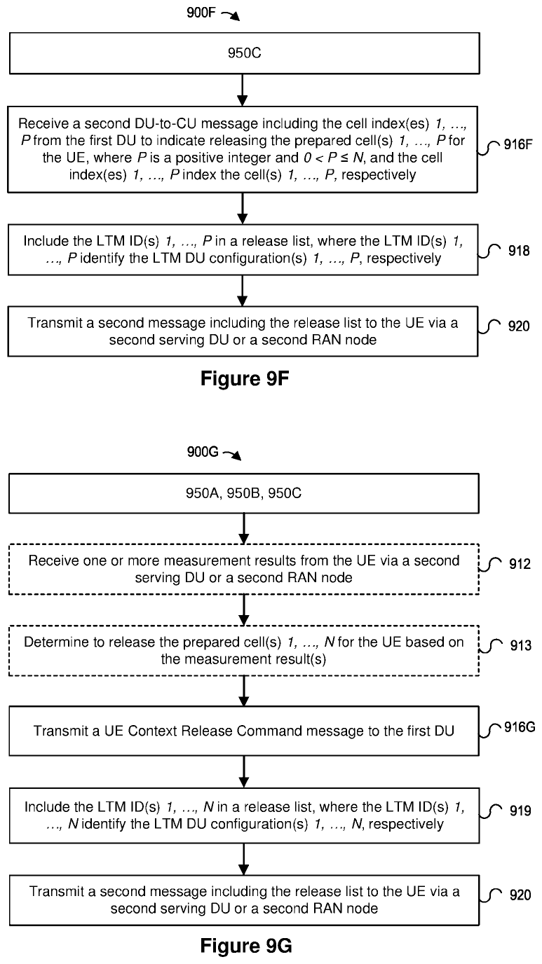

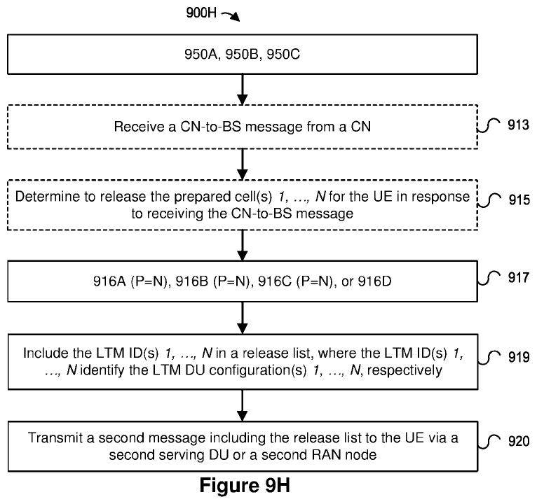

Next, several example methods, that can be implemented in a RAN node such as a DU or a CU to support configuring a configuration for LTM, are discussed next with reference to FIGS. 9-14B. Examples and implementations described for FIGS. 3-8B can apply to FIGS. 9-14B.

FIG. 9A illustrates an example method 900A, which can be implemented by a CU (e.g., the CU 172 of the base station 104 or 106), for managing LTM configurations for a UE (e.g., the UE 102).

The method 900A begins at block 902, where the CU communicates with a UE via a first serving DU (e.g., events 302, 402, 502, 602, 702, 802, 380, 480, 580, 680, 780, 880, 581, 582, 681, 682, 781, 782, 881, 882). At block 904A, the CU transmits a first CU-to-DU message including cell ID(s) 1, . . . , N to a first DU to request preparing cell(s) 1, . . . , N for LTM for the UE, where N is a positive integer, and the cell ID(s) 1, . . . , N identify the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 906, the CU receives a first DU-to-CU message including LTM DU configuration(s) 1, . . . , N from the first DU (e.g., events 310, 390, 380, 490, 480, 580, 590, 581, 582, 680, 690, 681, 682, 780, 790, 781, 782, 880, 890, 881, 882). At block 908, the CU includes LTM ID(s) 1, . . . , N and the LTM DU configuration(s) 1, . . . , N in an addition and/or modification list, where the LTM ID(s) 1, . . . , N identify the LTM DU configuration(s) 1, . . . , N, respectively. At block 910, the CU transmits a first message including the addition and/or modification list to the UE via a the first serving DU or a first RAN node (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882).

At block 912, the CU receives one or more measurement results from the UE via a second serving DU or a second RAN node (e.g., events 324, 344, 398, 380, 424, 444, 498, 480, 580, 524, 598, 581, 582, 680, 624, 698, 681, 682, 780, 724, 798, 781, 782, 880, 824, 898, 881, 882). At block 914, the CU determines to release the prepared cell(s) 1, . . . , P for the UE, e.g., based on the measurement result(s). For example, the CU might determine signal strength and/or quality of some or all of the cell(s) 1, . . . , P is worse than a threshold, based on the measurement result(s). The CU then determine to release the prepared cell(s) 1, . . . , P in response to that signal strength and/or quality of some or all of the cell(s) 1, . . . , P is worse than a threshold. The CU might preconfigure or predetermine the threshold. At block 916A, the CU transmits a second CU-to-DU message including the cell ID(s) 1, . . . , P to the first DU to indicate releasing the prepared cell(s) 1, . . . , P for the UE, where P is a positive integer and 0<P≤N, and the cell ID(s) 1, . . . , P identify the cell(s) 1, . . . , P, respectively. At block 918, the CU includes the LTM ID(s) 1, . . . , P in a release list, where the LTM ID(s) 1, . . . , P identify the LTM DU configuration(s) 1, . . . , P, respectively. At block 920, the CU transmits a second message including the release list to the UE via a second serving DU or a second RAN node. For example, the second message is a RRC reconfiguration message.

In some implementations, the CU generates the release list based on the second CU-to-DU message or in response to receiving the second CU-to-DU message. When the CU receives a LTM DU configuration (e.g., non-reference LTM DU configuration) configuring a cell for LTM from the DU, the CU assigns a LTM ID to identify the LTM DU configuration and associates the LTM ID with a cell ID of the cell. For such an association, the CU can use a mapping table to store the association of the LTM ID and the cell ID. For example, when the CU assigns the LTM ID(s) 1, . . . , N to identify the LTM DU configuration(s) 1, . . . , N, respectively, the CU associates the LTM ID(s) 1, . . . , N with the cell ID(s) 1, . . . , N, respectively. Thus, the CU determines the LTM ID(s) 1, . . . , P, based on the cell ID(s) 1, . . . , P and the associations.

In some implementations, the CU at block 904A includes the cell ID(s) 1, . . . , Nin a first list (e.g., SpCell to be setup list) and includes the first list in the first CU-to-DU message. The CU can include, in the first CU-to-DU message, cell index(es) 1, . . . , N indexing the cell(s) 1, . . . , N, respectively. The first DU generates the LTM DU configuration(s) 1, . . . , N to prepare the cell(s) 1, . . . , N for LTM for the UE in response to receiving the first list.

In some implementations, the first DU-to-CU message includes a reference LTM DU configuration. In some implementations, the CU stores the LTM DU configuration(s) 1, . . . , N.

In some implementations, the CU at block 916A includes the cell ID(s) 1, . . . , P in a second list (e.g., SpCell to be removed list) and includes the second list in the second CU-to-DU message. The first DU releases the LTM DU configuration(s) 1, . . . , P in response to receiving the second list. In some implementations, the first DU transmits a second DU-to-CU message to the CU.

In some implementations, the first CU-to-DU message and the first DU-to-CU message are a UE Context Setup Request message and a UE Context Setup Response message. In other implementations, the first CU-to-DU message and the first DU-to-CU message are a UE Context Modification Request message and a UE Context Modification Response message. In other implementations, the second CU-to-DU is a UE Context Modification Request message and the CU receive a UE Context Modification Response message from the first DU in response to the UE Context Modification Request message.

In some implementations, the first serving DU and the second serving DU are the same DU. In other implementations, the first serving DU and the second serving DU are different DUs. In some implementations, the first RAN node and the second RAN node are the same RAN node. In other implementations, the first RAN node and the second RAN node are different RAN nodes. In some implementations, the first DU is the first serving DU or the second serving DU. In other implementations, the first DU is neither the first serving DU nor the second serving DU.

In some implementations, the CU generates one or more LTM CU configurations associated with some or all of the LTM DU configuration(s). For example, the CU generates LTM CU configuration(s) 1, . . . , P associated with the LTM DU configuration(s) 1, . . . , P, respectively. The CU releases the LTM CU configuration(s) 1, . . . , P, after (e.g., in response to) determining releasing the prepared cell(s) 1, . . . , P, transmitting the second CU-to-DU message or receiving the second DU-to-CU message.

In some implementations, the CU releases the LTM configuration(s) 1, . . . , P, after (e.g., in response to) determining releasing the prepared cell(s) 1, . . . , P, transmitting the second CU-to-DU message or receiving the second DU-to-CU message.

Blocks 902, 904A, 906, 908 and 910 are grouped as block 950A.

FIG. 9B is a flow diagram of an example method 900B similar to the method 900A, except that the method 900B includes block 909, and 916B instead of block 916A. At block 909, the CU transmits an additional CU-to-DU message including the LTM ID(s) 1, . . . , N to the first DU (e.g., events 312, 392, 380, 412, 492, 480, 580, 592, 581, 582, 680, 692, 681, 682, 780, 792, 781, 782, 880, 892, 881, 882). In some implementations, the CU includes the LTM ID(s) 1, . . . , N in the first CU-to-DU message instead of transmitting the additional CU-to-DU message. In such cases, block 909 is omitted.

At block 916B, the CU transmits a second CU-to-DU message including the LTM ID(s) 1, . . . , P to the first DU to indicate releasing the prepared cell(s) 1, . . . , P for the UE, where P is a positive integer and 0<P≤N, and the LTM ID(s) 1, . . . , P identify the LTM DU configuration(s) 1, . . . , P, respectively. Blocks 902, 904A, 906, 908, 909 and 910 are grouped as block 950B.

FIG. 9C is a flow diagram of an example method 900C similar to the method 900A, except that the method 900C includes block 904C and 916C instead of blocks 904A and 916A. At block 904C, the CU transmits a first CU-to-DU message including cell ID(s) 1, . . . , N and cell index(es) 1, . . . , N to a first DU to request preparing cell(s) 1, . . . , N for LTM for the UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 916C, the CU transmits a second CU-to-DU message including the cell index(es) 1, . . . , P to the first DU to indicate releasing the prepared cell(s) 1, . . . , P for the UE, where P is a positive integer and 0<P≤N, and the cell index(es) 1, . . . , P index the cell(s) 1, . . . , P, respectively. Blocks 902, 904C, 906, 908, 909 and 910 are grouped as block 950B.

FIG. 9D is a flow diagram of an example method 900D similar to the method 900A, except that the method 900D includes block 916D instead of block 916A. At block 916D, the CU receives a second DU-to-CU message including the cell ID(s) 1, . . . , P from the first DU to indicate releasing the prepared cell(s) 1, . . . , P for the UE, where P is a positive integer and 0<P≤N, and the cell ID(s) 1, . . . , P identify the cell(s) 1, . . . , P, respectively. In some implementations, the second DU-to-CU message is a UE Context Modification Required message. In other implementations, the second DU-to-CU message is a UE Context Release Command message.

FIG. 9E is a flow diagram of an example method 900E similar to the method 900B, except that the method 900E includes block 916E instead of block 916B. At block 916E, the CU receives a second DU-to-CU message including the LTM ID(s) 1, . . . , P from the first DU to indicate releasing the prepared cell(s) 1, . . . , P for the UE, where P is a positive integer and 0<P≤N, and the LTM ID(s) 1, . . . , P identify the LTM DU configuration(s) 1, . . . , P, respectively.

FIG. 9G is a flow diagram of an example method 900G similar to the methods 900A-900C, except that the method 900G includes blocks 916G and 919 instead of block 916A, 916C and 918. At block 916G, the CU transmits a UE Context Release Command message to the first DU. At block 919, the CU includes the LTM ID(s) 1, . . . , N in a release list, where the LTM ID(s) 1, . . . , N identify the LTM DU configuration(s) 1, . . . , N, respectively. In some implementations, the CU determines to release the prepared cell(s) 1, . . . , N for the UE, e.g., based on the measurement result(s). For example, the CU might determine signal strength and/or quality of some or all of the cell(s) 1, . . . , N is worse than a threshold, based on the measurement result(s). The CU then determine to transmit the UE Context Release Command message in response to that signal strength and/or quality of some or all of the cell(s) 1, . . . , N is worse than a threshold. The CU might preconfigure or predetermine the threshold.

FIG. 9H is a flow diagram of an example method 900H similar to the methods 900A-900C, except that the method 900H includes blocks 913, 915, 917 and 919 instead of blocks 912, 914, 916A, 916C, 918. At block 913, the CU receives a CN-to-BS message from a CN. At block 915, the CU determines to release the prepared cell(s) 1, . . . , N for the UE in response to receiving the CN-to-BS message. At block 917, the flow proceeds to 916A, 916B and 916C with P=N, or proceeds to 916D. At block 919, the CU includes the LTM ID(s) 1, . . . , N in a release list, where the LTM ID(s) 1, . . . , N identify the LTM DU configuration(s) 1, . . . , N, respectively.

In some implementations, the CN-to-BS message is a PDU Session Resource Modify Request message. In other implementations, the CN-to-BS message is a PDU Session Resource Release Command message.

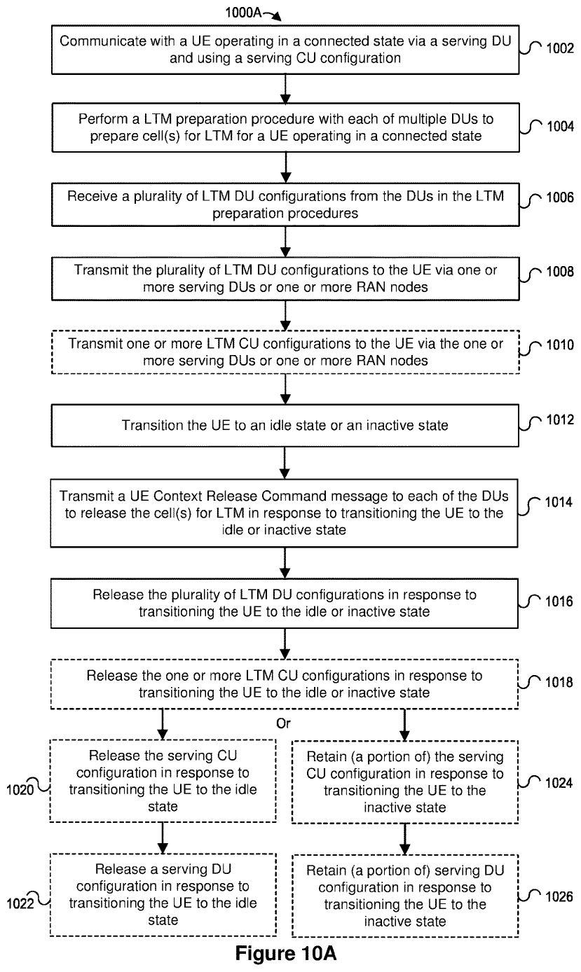

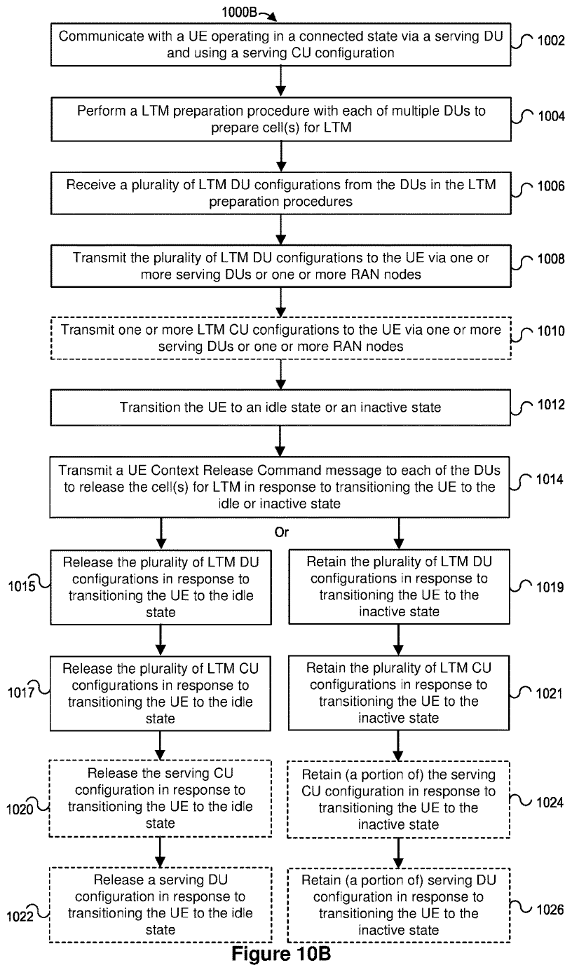

FIG. 10A illustrates an example method 1000A, which can be implemented by a CU (e.g., the CU 172 of the base station 104 or 106), for managing LTM configurations for a UE (e.g., the UE 102).

The method 1000A begins at block 1002, where the CU communicates with a UE operating in a connected state via a serving DU and using a serving CU configuration (e.g., events 302, 402, 502, 602, 702, 802, 380, 480, 580, 680, 780, 880, 581, 582, 681, 682, 781, 782, 881, 882). For example, the connected state is a RRC_CONNECTED state. At block 1004, the CU performs a LTM preparation procedure with each of multiple DUs to prepare cell(s) for LTM for the UE (e.g., events 308, 310, 390, 380, 490, 480, 580, 590, 581, 582, 680, 690, 681, 682, 780, 790, 781, 782, 880, 890, 881, 882). At block 1006, the CU receives a plurality of LTM DU configurations from the DUs in the LTM preparation procedures (e.g., events 310, 390, 380, 490, 480, 580, 590, 581, 582, 680, 690, 681, 682, 780, 790, 781, 782, 880, 890, 881, 882). At block 1008, the CU transmits the plurality of LTM DU configurations to the UE via one or more serving DUs or one or more RAN nodes (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 1010, the CU transmits one or more LTM CU configurations to the UE via the one or more serving DUs or one or more RAN nodes (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882). The one or more serving DUs might or might include the serving DU of block 1002.

At block 1012, the CU transitions the UE to an idle state or an inactive state. For example, the CU transmits a RRC release message to the UE to transition the UE to the idle state or inactive state. The UE transitions to the idle state or inactive state in response to receiving the RRC release message. In some implementations, the CU does include a release list in the RRC release message to indicate the UE to release the plurality of LTM DU configurations. In some implementations, the CU includes a suspend configuration (e.g., SuspendConfig IE) in the RRC release message to order the UE transition to the inactive state. The UE transitions to the idle state in response to the suspend configuration. In other implementations, the CU might exclude a suspend configuration in the RRC release message to order the UE to transition to the idle state. The UE transitions to the idle state in response to the RRC release message excluding a suspend configuration.

At block 1014, the CU transmits a UE Context Release Command message to each of the DUs to release the cell(s) for LTM in response to (determining) transitioning the UE to the idle or inactive state. In some implementations, the each of the DUs releases particular LTM DU configuration(s) in the plurality of LTM DU configurations in response to the UE Context Release Command. The CU might receive a UE Context Release Complete message from each of the DUs in response to the respective UE Context Release Command message. At block 1016, the CU releases the plurality of LTM DU configurations in response to transitioning the UE to the idle or inactive state. At block 1018, the CU releases the one or more LTM CU configurations in response to (determining) transitioning the UE to the idle or inactive state. The flow proceeds to block 1020 or 1024 from block 1018. At block 1020, the CU releases the serving CU configuration in response to (determining) transitioning the UE to the idle state. At block 1022, the CU releases a serving DU configuration in response to transitioning the UE to the idle state. At block 1024, the CU retains the serving CU configuration or a portion of the serving CU configuration in response to (determining) transitioning the UE to the inactive state. At block 1026, the CU retains the serving DU configuration or a portion of serving DU configuration in response to (determining) transitioning the UE to the inactive state.

FIG. 10B is a flow diagram of an example method 1000B similar to the method 1000A, except that method 1000B includes blocks 1015, 1017, 1019 and 1021 instead of blocks 1016, 1018. At block 1015, the CU releases the plurality of LTM DU configurations in response to (determining) transitioning the UE to the idle state. At block 1017, the CU releases the plurality of LTM CU configurations in response to (determining) transitioning the UE to the idle state. At block 1019, the CU retains the plurality of LTM DU configurations in response to (determining) transitioning the UE to the inactive state. At block 1021, the CU retains the plurality of LTM CU configurations in response to (determining) transitioning the UE to the inactive state.

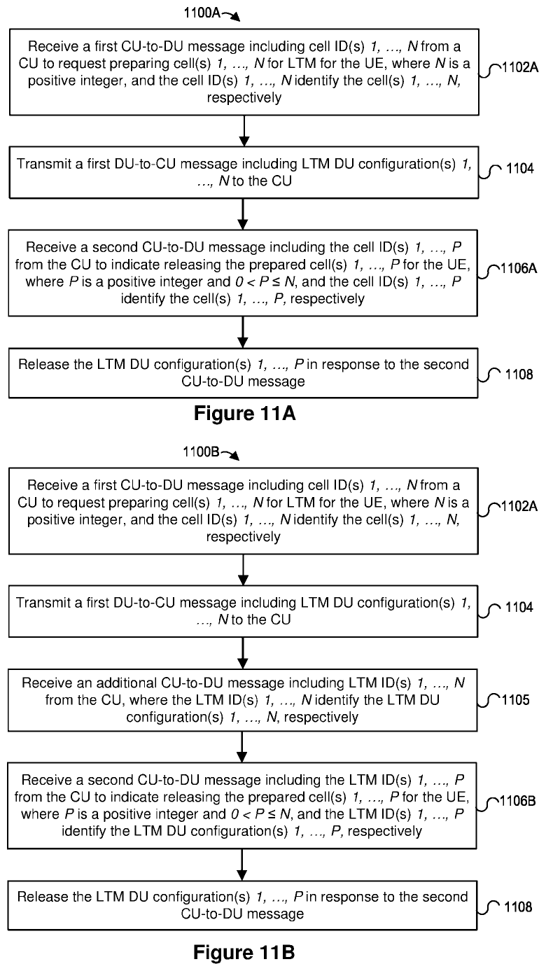

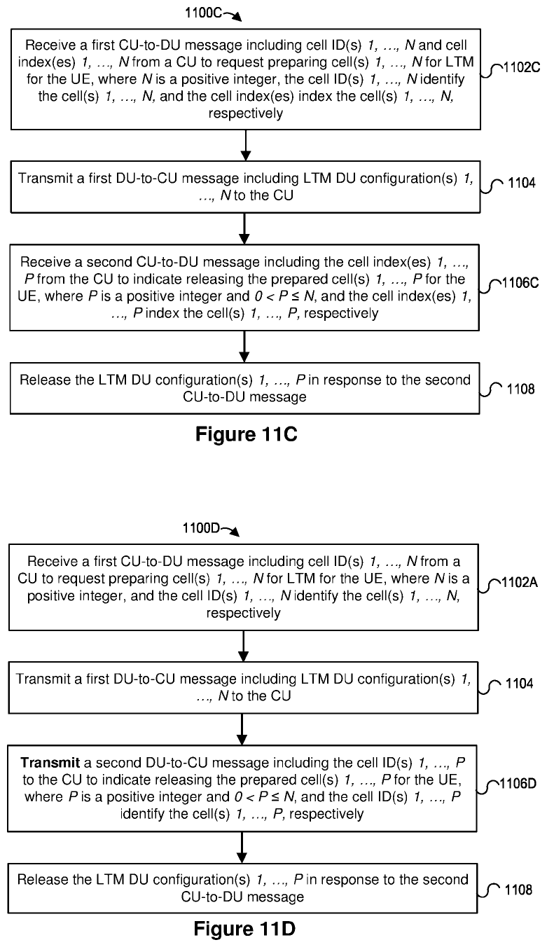

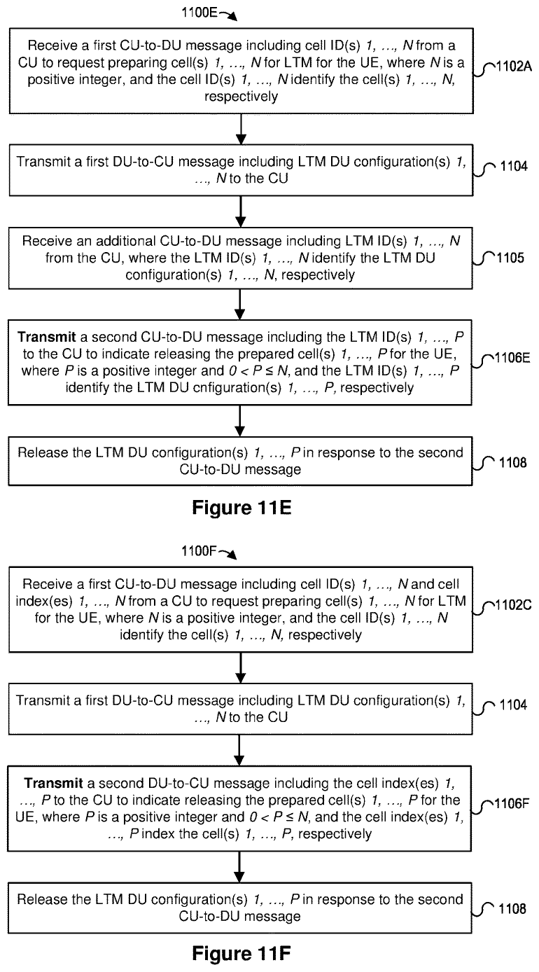

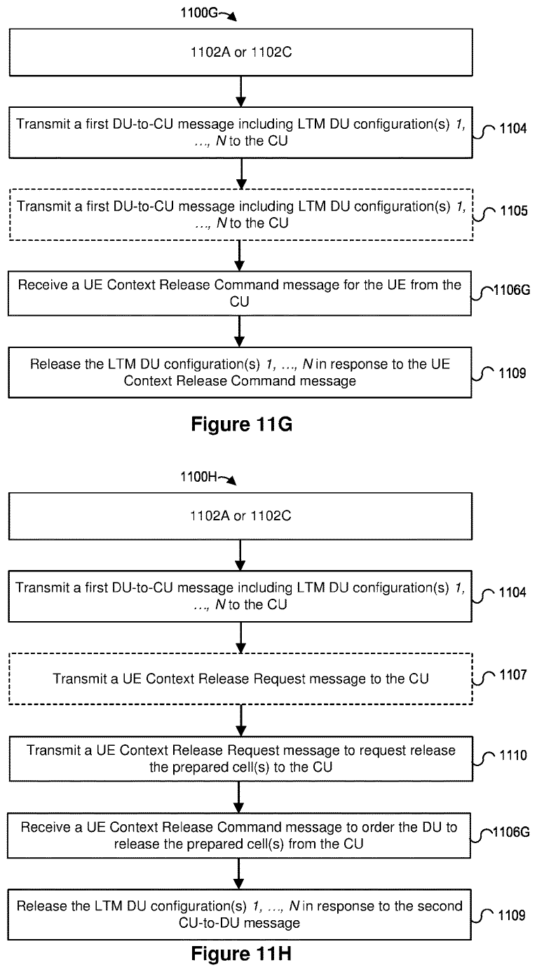

Next, FIGS. 11A-11H illustrates example methods for a DU, which can be a DU described in FIGS. 9A-9G or a DU described in FIGS. 3-8B. The descriptions for FIGS. 9A-9G can apply to FIGS. 11A-11G.

FIG. 11A illustrates an example method 1100A, which can be implemented by a DU (e.g., the DU 174 of the base station 104 or 106), for managing LTM configurations for a UE (e.g., the UE 102).

The method 1100A begins at block 1102A, where the DU receives a first CU-to-DU message including cell ID(s) 1, . . . , N from a CU to request preparing cell(s) 1, . . . , N for LTM for the UE, where N is a positive integer, and the cell ID(s) 1, . . . , N identify the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1104, the DU transmits a first DU-to-CU message including LTM DU configuration(s) 1, . . . , N to the CU (e.g., events 310, 390, 380, 490, 480, 580, 590, 581, 582, 680, 690, 681, 682, 780, 790, 781, 782, 880, 890, 881, 882). At block 1106A, the DU receives a second CU-to-DU message including the cell ID(s) 1, . . . , P from the CU to indicate releasing the prepared cell(s) 1, . . . , P for the UE, where P is a positive integer and 0<P≤N, and the cell ID(s) 1, . . . , P identify the cell(s) 1, P, respectively. At block 1108, the DU releases the LTM DU configuration(s) 1, . . . , P in response to the second CU-to-DU message.

In some implementations, when the DU generates a LTM DU configuration (e.g., non-reference LTM DU configuration) configuring a cell for LTM for the UE, the DU associates the LTM DU configuration with a cell ID of the cell. For such an association, the DU can use a mapping table to store the association of the LTM DU configuration and the cell ID. For example, the DU associates the LTM DU configuration(s) 1, . . . , N with the cell ID(s) 1, . . . , N, respectively. Thus, the DU determines the LTM DU configuration(s) 1, . . . , P, based on the cell ID(s) 1, . . . , P and the associations.

FIG. 11B is a flow diagram of an example method 1100B similar to the method 1100A, except that method 1100B includes blocks 1105 and 1106B instead of block 1106A. At block 1105, the DU receives an additional CU-to-DU message including LTM ID(s) 1, . . . , N from the CU, where the LTM ID(s) 1, . . . , N identify the LTM DU configuration(s) 1, . . . , N, respectively. At block 1106B, the DU receives a second CU-to-DU message including the LTM ID(s) 1, . . . , P from the CU to indicate releasing the prepared cell(s) 1, . . . , P for the UE, where P is a positive integer and 0<P≤N, and the LTM ID(s) 1, . . . , P identify the LTM DU configuration(s) 1, . . . , P, respectively.

In some alternative implementations, the DU receives the LTM ID(s) 1, . . . , N in the first CU-to-DU message instead of the additional CU-to-DU message. Thus, block 1105 can be omitted.

In some implementations, when the DU receives the LTM ID(s) 1, . . . , N in the additional CU-to-DU message or the first CU-to-DU message, the DU associates the LTM DU configuration(s) 1, . . . , N with the LTM ID(s) 1, . . . , N, respectively. For such these associations, the DU can use a mapping table to store the respective associations of the LTM DU configuration(s) 1, . . . , N and the LTM ID(s) 1, . . . , N. Thus, the DU determines the LTM DU configuration(s) 1, . . . , P, based on the LTM ID(s) 1, . . . , P and the associations.

FIG. 11C is a flow diagram of an example method 1100C similar to the method 1100A, except that method 1100C includes blocks 1102C and 1106C instead of blocks 1102A and 1106A. At block 1102C, the DU receives a first CU-to-DU message including cell ID(s) 1, . . . , N and cell index(es) 1, . . . , N from a CU to request preparing cell(s) 1, . . . , N for LTM for the UE, where N is a positive integer, the cell ID(s) 1, . . . , N identify the cell(s) 1, . . . , N, and the cell index(es) index the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1106C, the DU receives a second CU-to-DU message including the cell index(es) 1, . . . , P from the CU to indicate releasing the prepared cell(s) 1, . . . , P for the UE, where P is a positive integer and 0<P≤N, and the cell index(es) 1, . . . , P index the cell(s) 1, . . . , P, respectively.

In some implementations, when the DU generates a LTM DU configuration (e.g., non-reference LTM DU configuration) configuring a cell for LTM for the UE, the DU associates the LTM DU configuration with a cell index of the cell. For such an association, the DU can use a mapping table to store the association of the LTM DU configuration and the cell index. For example, the DU associates the LTM DU configuration(s) 1, . . . , N with the cell index(es) 1, . . . , N, respectively. Thus, the DU determines the LTM DU configuration(s) 1, . . . , P, based on the cell index(es) 1, . . . , P and the associations.

FIG. 11D is a flow diagram of an example method 1100D similar to the method 1100A, except that method 1100D includes block 1106D instead of block 1106A. At block 1106D, the DU transmits a second DU-to-CU message including the cell ID(s) 1, . . . , P to the CU to indicate releasing the prepared cell(s) 1, . . . , P for the UE, where P is a positive integer and 0<P≤N, and the cell ID(s) 1, . . . , P identify the cell(s) 1, . . . , P, respectively.

In some implementations, the DU determines to release the prepared cell(s) 1, . . . , P based on one or more measurement results received from the UE. In other implementations, the DU determines to release the prepared cell(s) 1, . . . , P because the DU does not have enough resources to serve the UE or other UEs.

FIG. 11E is a flow diagram of an example method 1100E similar to the methods 1100A and 1100B, except that method 1100E includes blocks 1102E and 1106E instead of blocks 1102A and 1106A. At block 1102E, the DU receives a first CU-to-DU message including cell ID(s) 1, . . . , N from a CU to request preparing cell(s) 1, . . . , N for LTM for the UE, where N is a positive integer, and the cell ID(s) 1, . . . , N identify the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1106E, the DU transmits a second CU-to-DU message including the LTM ID(s) 1, . . . , P to the CU to indicate releasing the prepared cell(s) 1, . . . , P for the UE, where P is a positive integer and 0<P≤N, and the LTM ID(s) 1, . . . , P identify the LTM DU configuration(s) 1, . . . , P, respectively.

FIG. 11F is a flow diagram of an example method 1100F similar to the methods 1100A and 1100C, except that method 1100F includes block 1106F instead of block 1106A. At block 1106F, the DU transmits a second DU-to-CU message including the cell index(es) 1, . . . , P to the CU to indicate releasing the prepared cell(s) 1, . . . , P for the UE, where P is a positive integer and 0<P≤N, and the cell index(es) 1, . . . , P index the cell(s) 1, . . . , P, respectively.

FIG. 11G is a flow diagram of an example method 1100G similar to the methods 1100A and 1100C, except that method 1100G includes blocks 1106G and 1109 instead of blocks 1106A, 1106B and 1108. At block 1106G, the DU receives a UE Context Release Command message for the UE from the CU. At block 1109, the DU releases the LTM DU configuration(s) 1, . . . , N in response to the UE Context Release Command message. In some implementations, the DU transmits a UE Context Release Complete message to the CU in response to the UE Context Release Command message.

FIG. 11H is a flow diagram of an example method 1100H similar to the methods 1100A, 1100B, 1100C and 1100G, except that the DU transmits a UE Context Release Request message to the CU at block 1107. In some implementations, if the DU does have enough resources to serve other UEs, the DU might transmit the UE Context Release Request message to the CU. In other implementations, the DU transmits the UE Context Release Request message based on one or more measurement results received from the UE. For example, the DU might determine signal strength and/or quality of some or all of the cell(s) 1, . . . , N is worse than a threshold, based on the measurement result(s). The DU then determine to transmit the UE Context Release Request message in response to that signal strength and/or quality of some or all of the cell(s) 1, . . . , N is worse than a threshold. The DU might preconfigure or predetermine the threshold. In yet other implementations, the DU can start a timer when or after transmitting the LTM DU configuration(s) 1, . . . , N to the CU or the UE. If the timer expires, the DU determines to transmit or transmits the UE Context Release Request message to the CU. If the DU detects the UE access a cell configured in one of the LTM DU configuration(s)) 1, . . . , N before the timer expires, the DU may restart the timer.

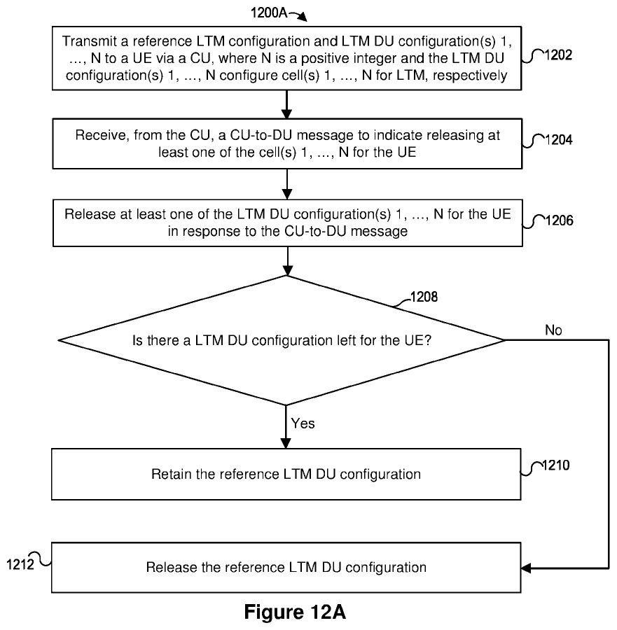

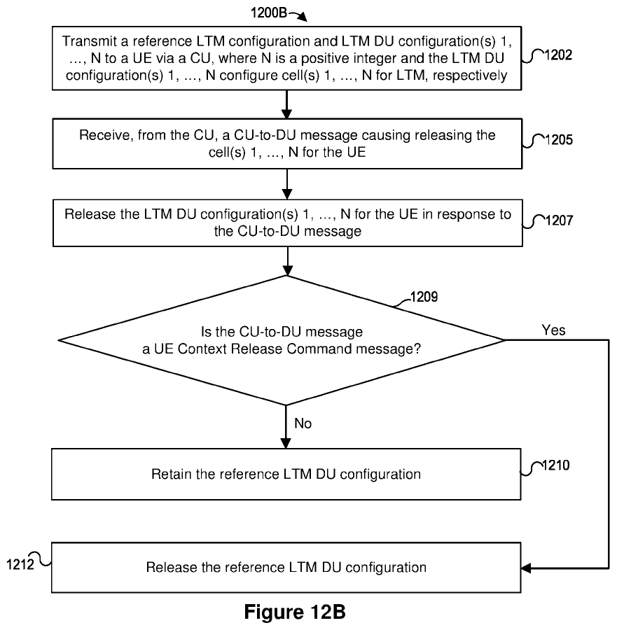

FIG. 12A illustrates an example method 1200A, which can be implemented by a DU (e.g., the DU 174 of the base station 104 or 106), for managing LTM configurations for a UE (e.g., the UE 102).

The method 1200A begins at block 1202, where the DU transmits a reference LTM configuration and LTM DU configuration(s) 1, . . . , N to a UE via a CU, where N is a positive integer and the LTM DU configuration(s) 1, . . . , N configure cell(s) 1, . . . , N for LTM, respectively (e.g., events 308, 310, 390, 316, 318, 394, 380, 490, 494, 480, 580, 590, 594, 517, 519, 581, 582, 680, 690, 694, 617, 619, 681, 682, 780, 790, 794, 717, 719, 781, 782, 880, 890, 894, 817, 819, 881, 882). At block 1204, the DU receives, from the CU, a CU-to-DU message to indicate releasing at least one of the cell(s) 1, . . . , N for the UE. For example, the CU-to-DU message is a UE Context Modification Request message and the DU transmits a UE Context Modification Response message to the CU in response to the UE Context Modification Request message.

At block 1206, the DU releases at least one of the LTM DU configuration(s) 1, . . . , N for the UE in response to the CU-to-DU message. At block 1208, the DU determines whether there is any LTM DU configuration left for the UE. If the DU determines that there is a LTM DU configuration left (e.g., configured) for the UE at block 1208, the flow proceeds to blocks 1210. At block 1210, the DU retains the reference LTM DU configuration. Otherwise, if the DU determines that there is no LTM DU configuration left for the UE at block 1208, the flow proceeds to blocks 1212. At block 1212, the DU releases the reference LTM DU configuration.

FIG. 12B is a flow diagram of an example method 1200B similar to the method 1200A, except that method 1200B includes blocks 1205, 1207 and 1209 instead of blocks 1204, 1206 and 1208. At block 1205, the DU receives, from the CU, a CU-to-DU message causing releasing the cell(s) 1, . . . , N for the UE. At block 1207, the DU releases the LTM DU configuration(s) 1, . . . , N for the UE in response to the CU-to-DU message. At block 1209, the DU determines whether the CU-to-DU message is a UE Context Release Command message. If the DU determines that the CU-to-DU message is not a UE Context Release Command message at block 1209, the flow proceeds to blocks 1210. For example, the CU-to-DU message is a UE Context Modification Request message as described above. Otherwise, if the DU determines that the CU-to-DU message is a UE Context Release Command message at block 1209, the flow proceeds to blocks 1212.

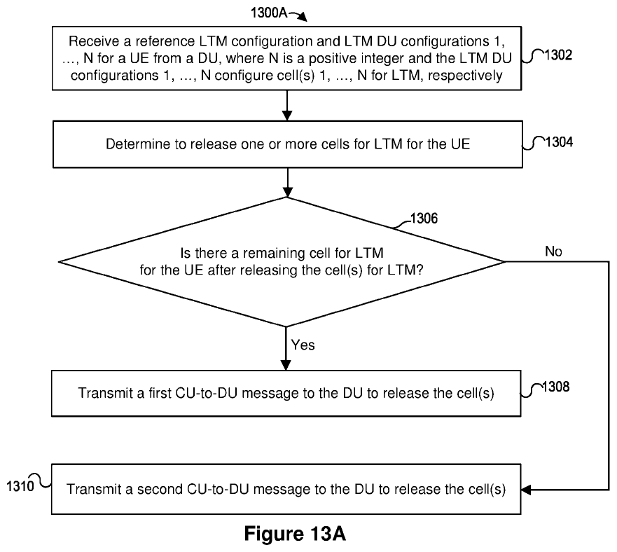

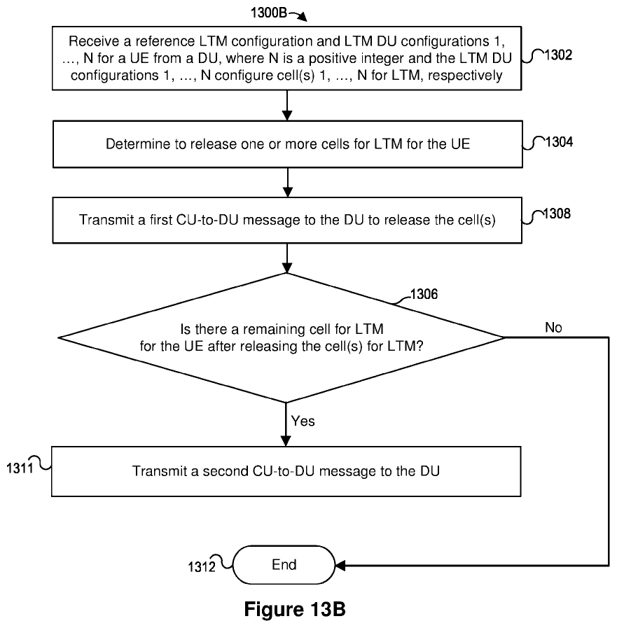

FIG. 13A illustrates an example method 1300A, which can be implemented by a CU (e.g., the CU 172 of the base station 104 or 106), for managing LTM configurations for a UE (e.g., the UE 102).

The method 1300A begins at block 1302A, where the CU receives a reference LTM configuration and LTM DU configurations 1, . . . , N for a UE from a DU, where N is a positive integer and the LTM DU configurations 1, . . . , N configure cell(s) 1, . . . , N for LTM, respectively (e.g., events 310, 390, 380, 490, 480, 580, 590, 581, 582, 680, 690, 681, 682, 780, 790, 781, 782, 880, 890, 881, 882). At block 1304, the CU determines to release one or more cells for LTM for the UE. At block 1306, the CU determines whether there is any remaining cell for LTM for the UE after releasing the cell(s) for LTM. If the CU determines that there is a remaining cell for LTM for the UE after releasing the cell(s) for LTM at block 1306, the flow proceeds to blocks 1308. At block 1308, the CU transmits a first CU-to-DU message to the DU to release the cell(s). For example, the first CU-to-DU message is a UE Context Modification Request message and the DU transmits a UE Context Modification Response message to the CU in response to the UE Context Modification Request message. Otherwise, if the CU determines that there is no remaining cell for LTM for the UE after releasing the cell(s) for LTM at block 1306, the flow proceeds to blocks 1310. At block 1310, the CU transmits a second CU-to-DU message to the DU to release the cell(s). For example, the second CU-to-DU message is a UE Context Release Command message and the DU transmits a UE Context Release Complete message to the CU in response to the UE Context Release Command message.

FIG. 13B is a flow diagram of an example method 1300B similar to the method 1300A, except that method 1300B includes blocks 1311 and 1312 instead of blocks 1308 and 1310. The flow proceeds to 1306 from 1308. If the CU determines that there is a remaining cell for LTM for the UE after releasing the cell(s) for LTM at block 1306, the flow proceeds to blocks 1311. At block 1311, the CU transmits a second CU-to-DU message to the DU. Otherwise, if the CU determines that there is no remaining cell for LTM for the UE after releasing the cell(s) for LTM at block 1306, the flow proceeds to blocks 1312, where the flow ends.

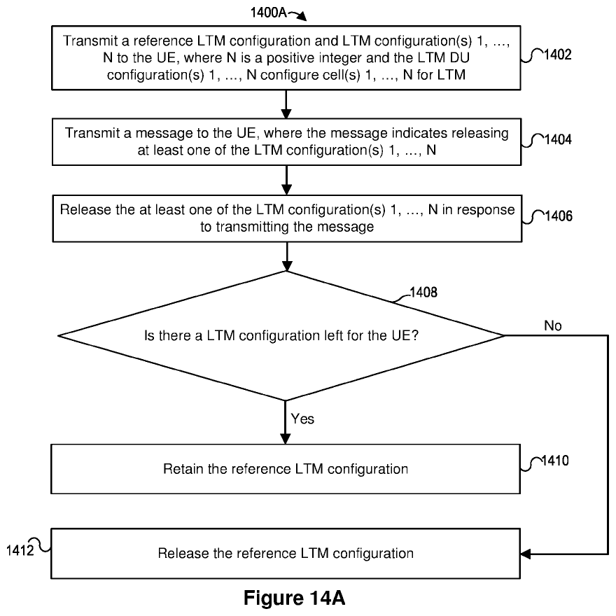

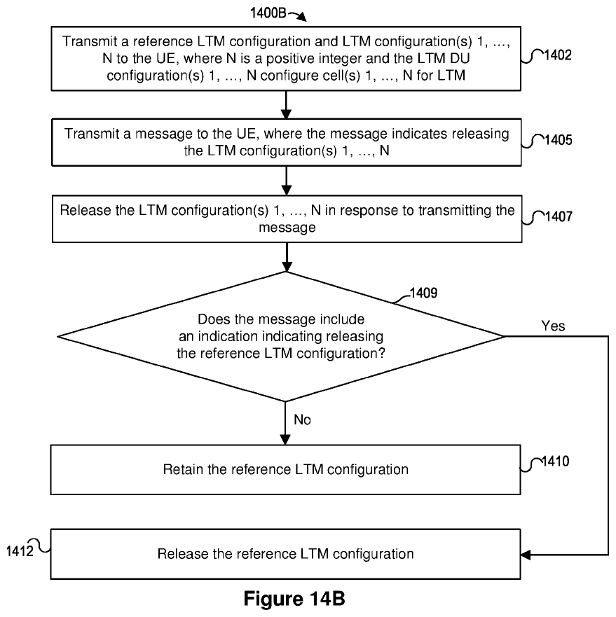

FIG. 14A illustrates an example method 1400A, which can be implemented by a RAN node (e.g., the base station 104 or 106, the CU 172 of the base station 104 or 106, or the DU 174 of the base station 104 or 106), for managing LTM configurations for a UE (e.g., the UE 102).

The method 1400A begins at block 1402A, where the RAN node transmits a reference LTM configuration and LTM configuration(s) 1, . . . , N to the UE, where N is a positive integer and the LTM DU configuration(s) 1, . . . , N configure cell(s) 1, . . . , N for LTM (e.g., events 308, 310, 390, 316, 318, 394, 380, 490, 494, 480, 580, 590, 594, 517, 519, 581, 582, 680, 690, 694, 617, 619, 681, 682, 780, 790, 794, 717, 719, 781, 782, 880, 890, 894, 817, 819, 881, 882). At block 1404, the RAN node transmits a message to the UE, where the message indicates releasing at least one of the LTM configuration(s) 1, . . . , N. For example, the message is a RRC reconfiguration message. At block 1406, the RAN node releases the at least one of the LTM configuration(s) 1, . . . , N in response to transmitting the message. At block 1408, the RAN node determines whether there is a LTM configuration left for the UE. If the RAN node determines that there is a LTM configuration left for the UE at block 1408, the flow proceeds to block 1410. At block 1410, the RAN node retains the reference LTM configuration. Otherwise, if the RAN node determines that there is not any LTM configuration left for the UE at block 1408, the flow proceeds to block 1412. At block 1412, the RAN node releases the reference LTM configuration.

FIG. 14B is a flow diagram of an example method 1400B similar to the method 1400A, except that method 1400B includes blocks 1405, 1407 and 1409 instead of blocks 1404, 1406, and 1408. At block 1405, the RAN node transmits a message to the UE, where the message indicates releasing the LTM configuration(s) 1, . . . , N. For example, the message is a RRC reconfiguration message. At block 1407, the RAN node releases the LTM configuration(s) 1, . . . , N in response to transmitting the message. At block 1409, the RAN node determine whether the message includes an indication indicating releasing the reference LTM configuration. If the RAN node determines that the message does not include an indication indicating releasing the reference LTM configuration at block 1409, the flow proceeds to block 1410. Otherwise, if the RAN node determines that the message includes an indication indicating releasing the reference LTM configuration at block 1409, the flow proceeds to block 1412.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “LTM command” can be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” can be replaced by “cell group configuration”. In some implementations, the “cell index” can be replaced with “serving cell index”, “LTM cell index”, “special cell (SpCell) index”, “PCell index” or “PSCell index”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The term “or” as used herein is to be interpreted as an inclusive or meaning any one or any combination, unless expressly indicated otherwise, mutually exclusive, or indicated otherwise by context. Therefore, herein, the expression “A or B” means “A, B, or both A and B.”

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a central unit (CU) of a distributed base station, the method comprising:
transmitting, to a distributed unit (DU) of the distributed base station, a CU-to-DU message related to a lower layer triggered mobility (LTM) of a user equipment (UE) connected to the distributed base station, the CU-to-DU message including a plurality of cell identifiers (IDs) of respective candidate cells;
receiving, from the DU in response to the CU-to-DU message, a DU-to-CU message including a plurality of LTM DU configurations for the respective candidate cells; and
transmitting, to the UE, an addition and/or modification list of the LTM DU configurations.

2. The method of claim 1, wherein:
the addition and/or modification list includes LTM identifiers (IDs) corresponding to the respective LTM DU configurations.

3. The method of claim 2, further comprising:
including the LTM IDs in the CU-to-DU message.

4. The method of claim 1 further comprising:
determining to release one or more of the candidate cells; and
transmitting, to the UE, a release list identifying one or more LTM DU configurations corresponding to the one ore more candidate cells to be released.

5. The method of claim 4, wherein:
the CU-to-DU message is a first CU-to-DU message;
the release is a first list;
the method further comprising:
transmitting, to the DU, a second CU-to-DU message including a second list identifying one or more LTM DU configurations corresponding to the one ore more candidate cells to be released.

6. The method of claim of claim 5, wherein:
the second CU-to-DU message includes a UE Context Release Command message.

7. The method of claim 4, wherein:
the determining to release one or more of the candidate cells is in response to receiving one or more measurement results from the UE.

8. The method of claim 1, wherein the candidate cells are associated with the DU.

9. The method of claim 8, wherein:
the CU-to-DU message includes a UE Context Modification Request message; and
the DU-to-CU message includes a UE Context Modification Response message.

10. The method of claim 1, wherein:
the DU is a first DU, and
the candidate cells are associated with a second DU of the distributed base station.

11. The method of claim 10, wherein:
the CU-to-DU message includes a UE Context Setup Request message; and
the DU-to-CU message includes a UE Context Setup Response message.

12. The method of claim 1, wherein:
an addition and/or modification list is included in a Radio Resource Control (RRC) reconfiguration command.

13. The method of claim 1, wherein:
the plurality of LTM DU configurations for the respective candidate cells are included in a CellGroupConfig information element (IE), in the DU-to-CU message.

14. The method of claim 1, further comprising:
transmitting, to the UE, a reference LTM DU configuration.

15. A central unit (CU) of a distributed base station, the CU comprising processing hardware and configured to:
transmit, to a distributed unit (DU) of the distributed base station, a CU-to-DU message related to a lower layer triggered mobility (LTM) of a user equipment (UE) connected to the distributed base station, the CU-to-DU message including a plurality of cell identifiers (IDs) of respective candidate cells;
receive, from the DU in response to the CU-to-DU message, a DU-to-CU message including a plurality of LTM DU configurations for the respective candidate cells; and
transmit, to the UE, an addition and/or modification list of the LTM DU configurations.

16. The CU of claim 15, wherein:
the addition and/or modification list includes LTM identifiers (IDs) corresponding to the respective LTM DU configurations.

17. The CU of claim 16, further configured to:
include the LTM IDs in the CU-to-DU message.

18. The CU of claim 15, further configured to:
determine to release one or more of the candidate cells; and
transmit, to the UE, a release list identifying one or more LTM DU configurations corresponding to the one ore more candidate cells to be released.

19. The CU of claim 18, wherein:
the CU-to-DU message is a first CU-to-DU message;
the release is a first list;
the CU further configured to:
transmit, to the DU, a second CU-to-DU message including a second list identifying one or more LTM DU configurations corresponding to the one ore more candidate cells to be released.

20. The CU of claim 19, wherein:
the second CU-to-DU message includes a UE Context Release Command message.
